(19) United States
(12) Patent Application Publication
(10) Pub. No.: US 2025/0276726 A1
(43) Pub. Date: Sep. 4, 2025

(54) MODULAR WAGON

(71) Applicant: Veer Gear, LLC, Milton, GA (US)

(72) Inventors: Brady SCHROEDER, Milton, GA (US); Andrew BOWMAN, Milton, GA (US); Thomas PERRIN, Milton, GA (US)

(21) Appl. No.: 19/066,678

(22) Filed: Feb. 28, 2025

Related U.S. Application Data
(60) Provisional application No. 63/718,840, filed on Nov. 11, 2024.
(60) Provisional application No. 63/559,789, filed on Feb. 29, 2024.

(51) Int. Cl. B62B 3/02

(52) U.S. Cl. CPC B62B 3/02; B62B 2205/20

(57) ABSTRACT

A wagon assembly includes a wagon chassis having a frame with a first end, a second, a left side, and a right side, a handle coupled to the frame, a deck coupled to the frame, the deck having a population of openings arranged in a plurality of rows and columns, and a first pair of wheels coupled to the frame. The wagon chassis may also include a second pair of wheels coupled to the frame. At least one opening of the population of openings in the deck is configured to receive a peg of an additional component to couple the additional component to the wagon chassis. The wagon chassis may include first and second chassis portions rotatably connected to one another, wherein the wagon chassis is configured to fold and unfold along a fold axis extending from the left side to the right side of the wagon chassis.

### CROSS-REFERENCES TO RELATED APPLICATIONS

This application claims priority under 35 U.S.C. § 119 (e) to U.S. Provisional Patent Application Ser. No. 63/559,789, filed on Feb. 29, 2024 and U.S. Provisional Patent Application Ser. No. 63/718,840, filed on Nov. 11, 2024, the entire contents of each of which are incorporated herein by reference.

This application is related to commonly owned U.S. application Ser. No. 17/456,072, filed Nov. 22, 2021, U.S. application Ser. No. 16/686,454, filed Nov. 18, 2019, U.S. application Ser. No. 15/453,329, filed Mar. 8, 2017, U.S. Provisional Patent Application Ser. No. 63/718,840, filed on Nov. 11, 2024, U.S. Provisional Patent Application Ser. No. 63/559,789, filed Feb. 29, 2024, U.S. Provisional Patent Application Ser. No. 62/307,726, filed Mar. 14, 2016, and U.S. Provisional Patent Application Ser. No. 62/305,017, filed Mar. 8, 2016, the entire contents of each of which are incorporated herein by reference.

This application is related to commonly owned U.S. application Ser. No. 14/444,380, filed Jul. 28, 2014, U.S. application Ser. No. 14/811,340, filed Jul. 28, 2015, and U.S. application Ser. No. 14/992,899 filed Jan. 11, 2016, the entire contents of each of which are incorporated herein by reference.

### FIELD

The present invention relates generally to consumer-use wagons, and particularly to pull-handle and push handle wagons for multi-purpose use including carrying seated children and/or cargo.

### BACKGROUND

The statements in this section merely provide background information related to the present disclosure and may not constitute prior art.

Conventional consumer-use wagons are commonly used for holding and carrying cargo such as children. Such wagons typically include a generally rectangular base and four generally rectangular upright walls forming an open-topped container, with a pull handle pivotally coupled to the base front, and with four wheels rotationally mounted to the base bottom. A traditional and well-known wagon of this type is the classic RADIO FLYER wagon.

While these wagons have their advantages, they also have some drawbacks. Accordingly, needs exist for improved features for consumer-use wagons for multi-purpose use. It is to the provision of solutions to these and other problems that the present invention is primarily directed.

### SUMMARY

This section provides a general summary of the disclosure, and is not a comprehensive disclosure of its full scope or all of its features.

Generally described, the present invention relates to consumer-use wagons for multi-purpose use including carrying seated children and/or cargo, including but not limited to coolers, chairs, fishing equipment (e.g., rods or spears), skis, paddleboards, crates for pets, yard waste bins, smaller containers for storage or temperature control or the like, etc. In some embodiments, the wagons may be modular wagons that may comprise one or more modular wagon elements that together may be combined to define a wagon having a particular shape, a particular combination of containers, or other features. In some embodiments, the wagons may have a footwell for children carried in the wagon to place/rest their feet, and the footwell is repositionable between an extended/use position lowered relative to the wagon base and a collapsed/storage position closer to the wagon base. And in some embodiments, the wagons have a handle that can be moved between different positions and that is lockable in multiple of the different positions to allow the wagon to be easily pushed or pulled.

According to one exemplary embodiment, a wagon assembly includes a modular wagon bed including at least one sidewall positionable in a use position and a stored position. The modular wagon bed may include a footwell feature positionable in an extended position and a storage position. The wagon assembly includes a wagon chassis including a pivotable handle, a plurality of wheels, and a deck, wherein the modular wagon bed is removably coupled to the wagon chassis.

The wagon assembly may include various optional embodiments. The deck may include a movable surface for accommodating the footwell feature of the modular wagon bed when the modular wagon bed is coupled to the wagon chassis. The wagon assembly may include one or more adapters configured to removably couple to the wagon chassis and configured to removably couple to an accessory. The wagon assembly may further include one or more adapters configured to removably couple to the modular wagon bed and configured to removably couple to an accessory. The footwell feature may further include a footrest coupled to at least one footwell sidewall and, in a storage position, the footrest may be positioned more proximate to at least one seating surface of the wagon assembly than the footrest when the footwell feature is in an extended position. The handle may be configured to transition from a first use position and a stowed position, and the handle may include a pivotable coupling for pivoting the handle between the first use position and the stowed position. The handle may be positionable in a second use position via the pivotable coupling for pivoting the handle between the first use position and the second use position. The handle may be couplable to each endwall of the wagon chassis.

According to another exemplary embodiment, a wagon assembly includes a wagon chassis including a pivotable handle, a plurality of wheels, and a deck coupled to the plurality of wheels and the pivotable handle. The deck includes a footwell feature positionable in an extended position and a storage position.

The wagon assembly may include various optional embodiments. The wagon assembly may further include one or more adapters configured to removably couple to the wagon chassis and configured to removably couple to an accessory. The accessory may be a child seat. The accessory may be a cooler.

According to yet another exemplary embodiment, a wagon assembly includes a wagon chassis including a pivotable handle, a plurality of wheels, a center support coupled to the pivotable handle, and a deck. Each of the plurality of wheels is coupled to the center support.

The wagon assembly may include various optional embodiments. The wagon assembly may further include one or more adapters configured to removably couple to the deck and configured to removably couple to an accessory. The wagon assembly may further include at least two adapters configured to removably couple to the deck for mounting at least two child seats to the deck.

In some exemplary embodiments, a foldable wagon assembly is provided that includes a wagon chassis. The wagon chassis includes a first chassis portion, having a first frame portion and a first deck panel, a handle coupled to the first chassis portion, and a first pair of wheels coupled to the first chassis portion. The wagon chassis further includes a second chassis portion, having a second frame portion and a second deck panel, the second chassis portion connected to the first chassis portion by a first hinge and a second hinge, the first hinge and the second hinge configured to permit the first chassis portion and the second chassis portion to rotate with respect to one another between a first position and a second position. The wagon chassis further includes a second pair of wheels coupled to the second chassis portion.

According to yet another exemplary embodiment, a wagon assembly, includes a wagon chassis, the wagon chassis including a frame having a first end, a second end opposite the first end, a left side, and a right side; a handle coupled to the frame; a deck coupled to the frame, the deck having a population of openings; and a first pair of wheels coupled to the frame.

Further areas of applicability and advantages will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIGS. 1A-1G show a wagon having a wagon chassis, in accordance with embodiments of the present disclosure;

FIGS. 1H-1J show the wagon with the wagon chassis and a modular wagon bed with a collapsible footwell feature, in accordance with embodiments of the present disclosure.

FIGS. 2A-2F show a wagon chassis having a modular wagon bed removed, in accordance with embodiments of the present disclosure.

FIGS. 3A-3C show a wagon chassis with a collapsible footwell feature, in accordance with embodiments of the present disclosure.

FIGS. 4A-4B show a wagon chassis with a collapsible footwell feature, in accordance with embodiments of the present disclosure.

FIGS. 5A-5D show an optional accessory, the optional accessory being one or more removable pads, that may be used with the wagon, in accordance with embodiments of the present disclosure.

FIGS. 6A-6C show an optional accessory, the optional accessory being a bag, that may be used with the wagon, in accordance with embodiments of the present disclosure.

FIGS. 7A-7C show exemplary optional additional components that may be used with the wagon chassis, including exemplary adapters for use with the wagon chassis to couple child seats to the wagon chassis, in accordance with embodiments of the present disclosure.

FIGS. 8A-8E show a wagon chassis with an alternative pivotable handle, in accordance with embodiments of the present disclosure.

FIG. 9 show a wagon chassis, in accordance with embodiments of the present disclosure.

FIGS. 10A-10C show a retractable cargo deck, in accordance with embodiments of the present disclosure.

FIGS. 11A-11B show an exemplary adapter, in accordance with embodiments of the present disclosure.

FIGS. 12A-12B show an exemplary adapter, in accordance with embodiments of the present disclosure.

FIGS. 13A-13B show an exemplary adapter, in accordance with embodiments of the present disclosure.

FIGS. 14A-14B show an exemplary adapter, in accordance with embodiments of the present disclosure.

FIGS. 15A-15D show an exemplary adapter, in accordance with embodiments of the present disclosure.

FIG. 16 shows wheels of the wagon chassis, in accordance with embodiments of the present disclosure.

FIGS. 17A-17B show wheels of the wagon chassis, in accordance with embodiments of the present disclosure.

FIGS. 18A-18D show a wagon chassis, in accordance with embodiments of the present disclosure.

FIGS. 19A-19C show an optional accessory, the optional accessory being one or more storage devices, that may be used with the wagon, in accordance with embodiments of the present disclosure.

FIGS. 20A-20C show a wagon chassis, in accordance with embodiments of the present disclosure.

FIG. 21 shows a wagon chassis, in accordance with embodiments of the present disclosure.

FIGS. 22A-22C show a wagon chassis, in accordance with embodiments of the present disclosure.

FIGS. 23A-23E show an exemplary adapter, in accordance with embodiments of the present disclosure.

FIGS. 24A-24B show an exemplary adapter, in accordance with embodiments of the present disclosure.

FIGS. 25A-25C show an exemplary adapter, in accordance with embodiments of the present disclosure.

FIGS. 26A-26B show an exemplary adapter, in accordance with embodiments of the present disclosure.

FIGS. 27A-27D show exemplary pegs, in accordance with embodiments of the present disclosure.

FIG. 28 shows an optional accessory, the optional accessory being an open top bin, that may be used with the wagon, in accordance with embodiments of the present disclosure.

FIGS. 29A-29B show the wagon chassis configured as a trailer, in accordance with embodiments of the present disclosure.

FIGS. 30A-30B show the wagon chassis configured as a trailer, in accordance with embodiments of the present disclosure.

FIG. 31 shows the wagon chassis configured as a trailer, in accordance with embodiments of the present disclosure.

FIGS. 32A-32B show the wagon chassis configured as a trailer, in accordance with embodiments of the present disclosure.

FIGS. 33A-33D show exemplary locking hinges of the wagon chassis, in accordance with embodiments of the present disclosure.

FIGS. 34A-34B show exemplary locking hinges of the wagon chassis, in accordance with embodiments of the present disclosure.

FIGS. 35A-35D show exemplary locking hinges of the wagon chassis, in accordance with embodiments of the present disclosure.

FIGS. 36A-36C show exemplary adjustable ports and exemplary accessories of the wagon chassis, in accordance with embodiments of the present disclosure.

Corresponding reference numerals indicate corresponding parts throughout the several views of the drawings.

### DETAILED DESCRIPTION

The following description is merely exemplary in nature and is not intended to limit the present disclosure, application, or uses.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “front,” “rear,” “left,” “right,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

### Wagon

Generally described, the present invention relates to a consumer-use wagon that includes a base and a peripheral wall arrangement that together form a container, and that additionally includes a collapsible footwell, a position-locking handle, or both. It will be understood that the specific dimensions and proportions identified herein are representative for illustration purposes only and are not limiting of the invention; in fact, the invention expressly contemplates and covers many other embodiments with different dimensions, proportions, assembly methods, and overall designs. Additionally, although various embodiments of the wagon are described herein as “modular wagon,” “wagon,” or a “wagon assembly,” the embodiments may also be referred to as a “wheeled conveyance device.”

Various embodiments of the wagon or wagon chassis described herein may be modular such that one or more wagon elements or features may be assembled together to define a wagon having a particular shape or particular receptacle feature (e.g., for receiving one or more beach chairs, surfboards, paddle boards, paddles, fishing rods, coolers, yard waste bins, fishing equipment, skis, etc.). The modular wagon may be assembled to provide a shape and design (e.g., particular containers, features, etc.) designed to carry a variety of items that may connect either directly to the wagon chassis or indirectly (e.g., using an adapter) or which may be retained in place via walls or other features of the wagon (including walls or other features of a modular container couplable to the wagon).

In some embodiments, the wagon chassis couples to a modular wagon. The modular wagon or the wagon chassis may include a collapsible footwell feature according to some embodiments. Embodiments of the present disclosure provide that the walls of the modular wagon and/or the collapsible footwell feature may be removed from the wagon chassis or the walls and/or footwell may remain on the wagon chassis and be folded down. The wagon chassis described herein may couple to a modular wagon including a footwell that may be removable from the modular wagon. In some embodiments, the wagon chassis may include a removable or slidable panel that can be closed or opened depending on whether the footwell is desired. Various adapters or modular elements may be removably coupled to the wagon chassis for mounting one or more child seats, benches, or stroller seats when the walls are folded or otherwise removed. At least some of the embodiments of the present disclosure provide for extending the length of the wagon, via expanding the length of the wagon chassis, for accommodating larger loads such as longer seats or larger coolers. Additional modular elements or accessory attachments (referred to interchangeably herein as adapters) may be provided for coupling directly or indirectly to, or may provide for a container for receiving, a variety of commonly carried items such as coolers, chairs, fishing equipment (e.g., rods or spears), skis, paddleboards, crates for pets, yard waste bins, smaller containers for storage or temperature control or the like, etc. At least some of the adapters may be configured to couple accessories to one another to increased space efficiency and securement. The accessories and adapters described herein are optional and the accessories and adapters may collectively be referred to as optional additional components. The optional additional components may be used according to the needs and desires of the user of the modular wagon 100.

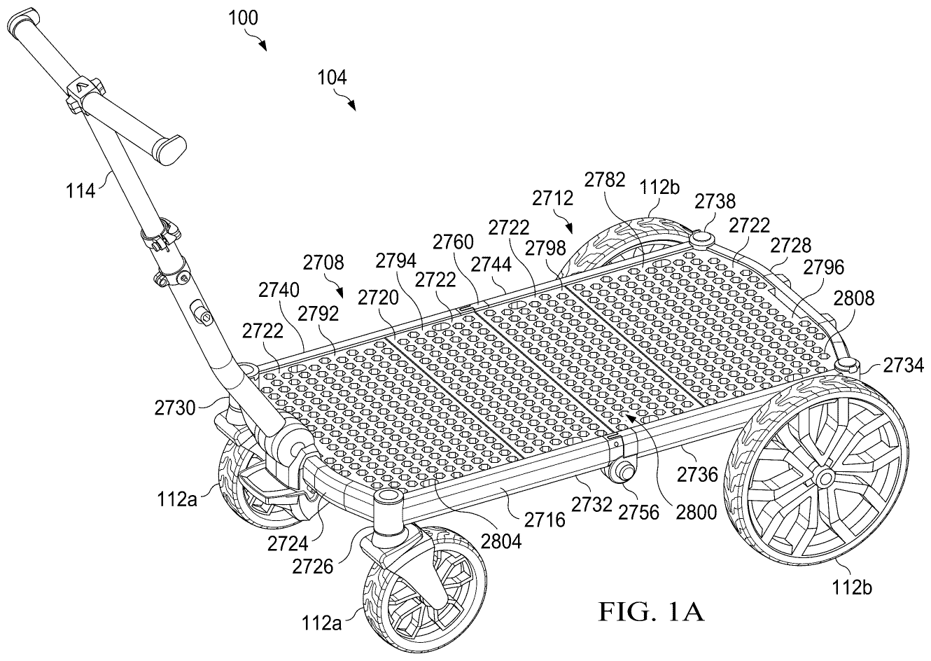

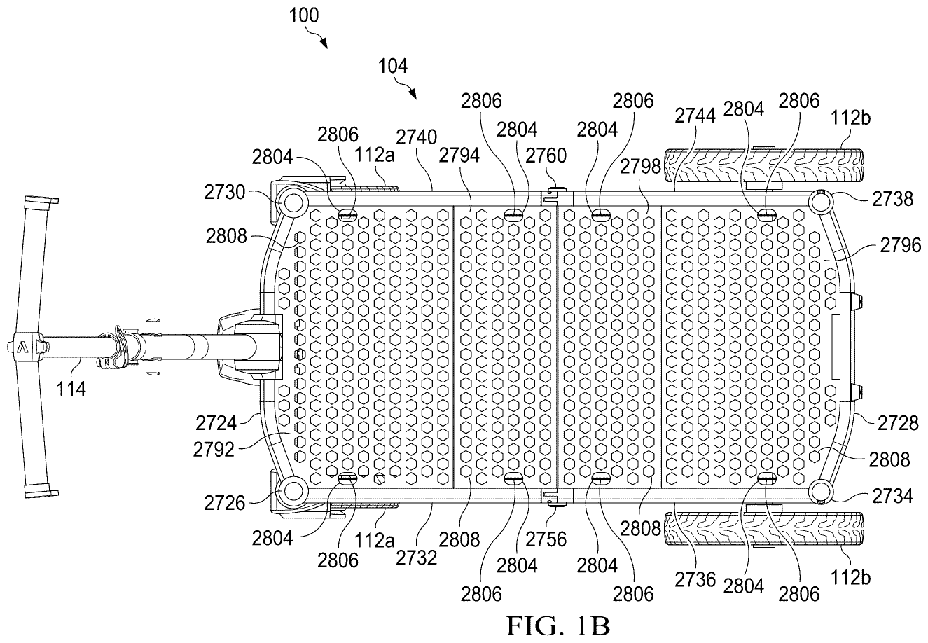

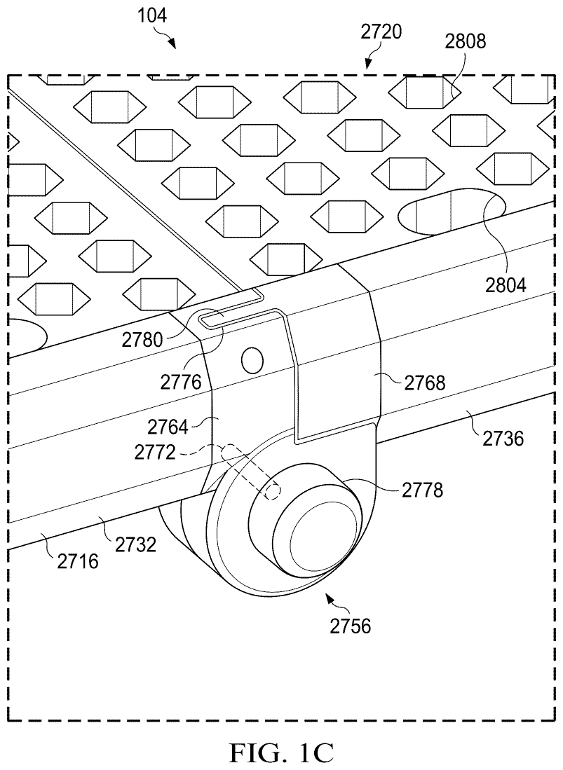

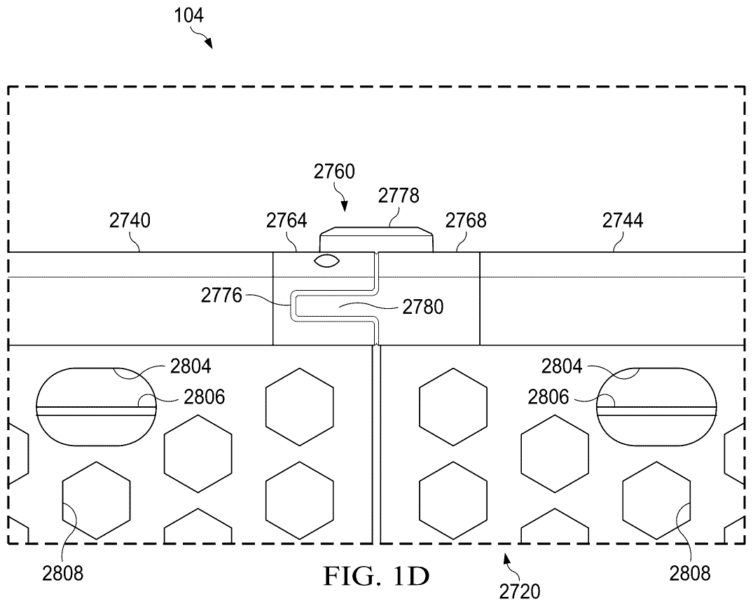

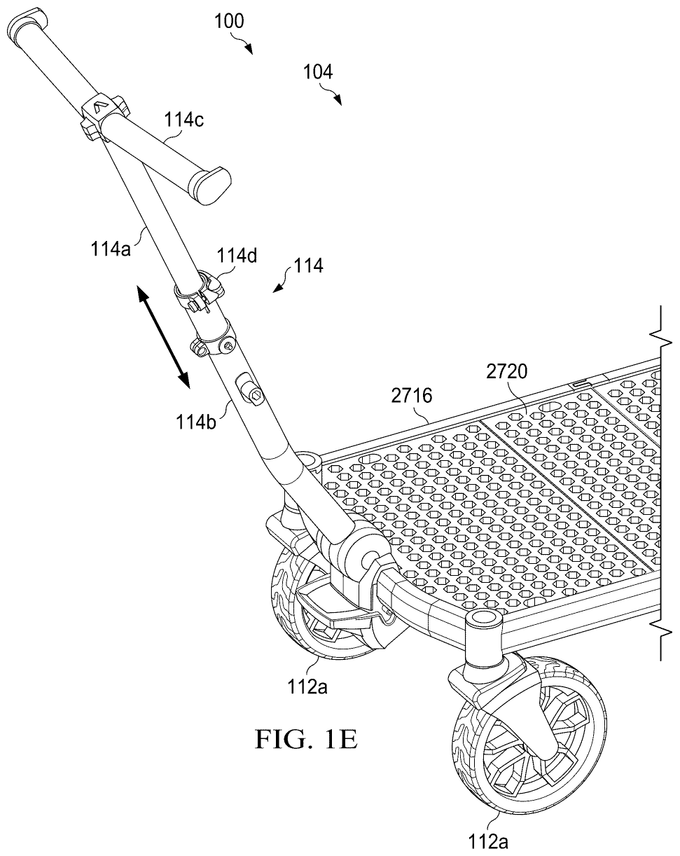

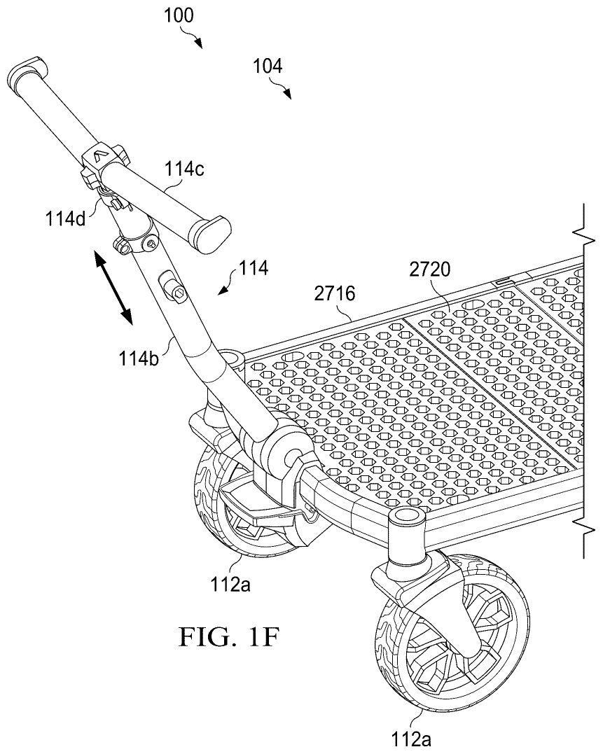

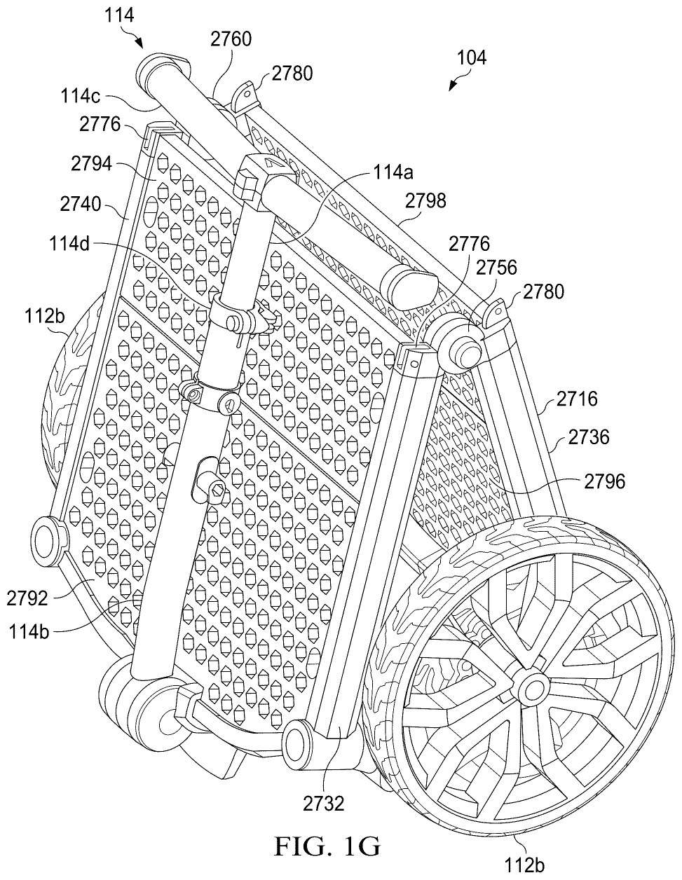

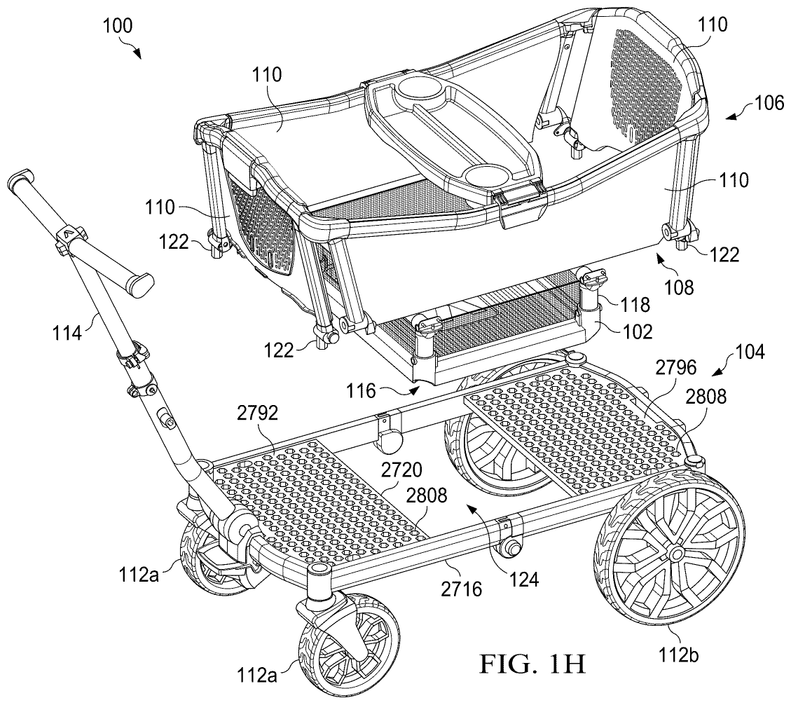

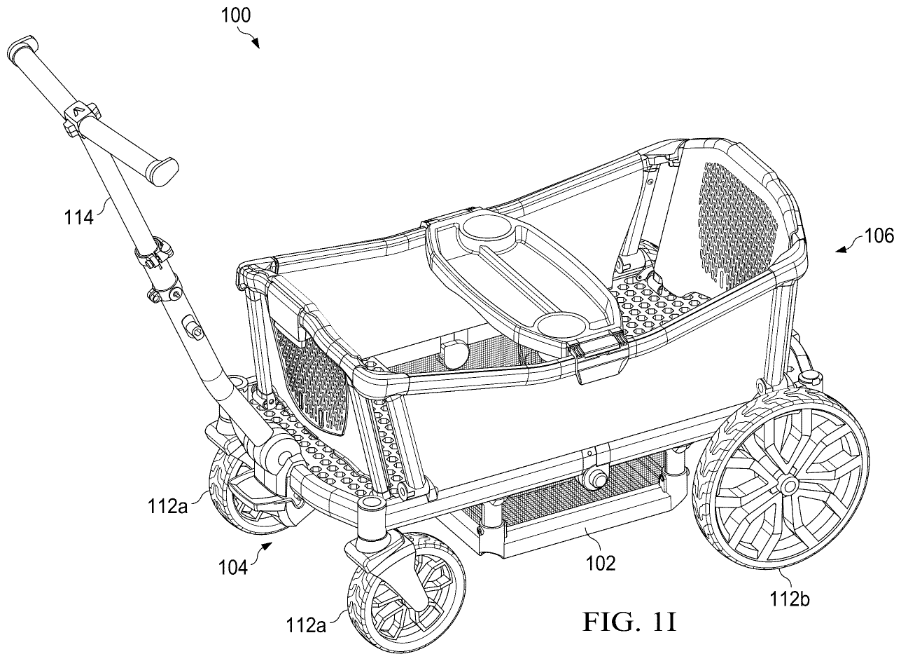

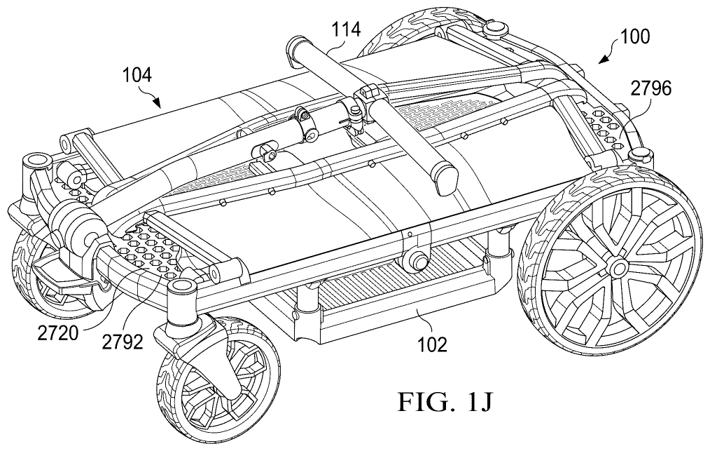

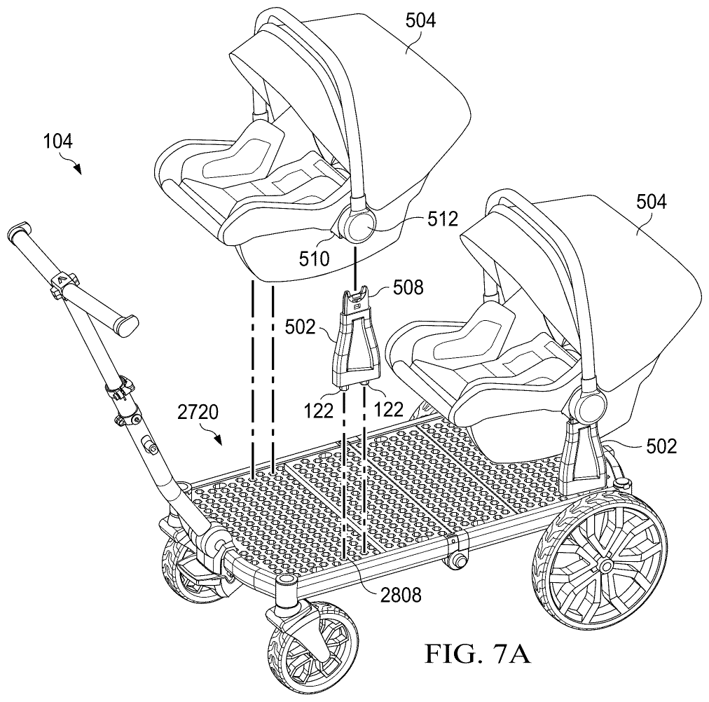

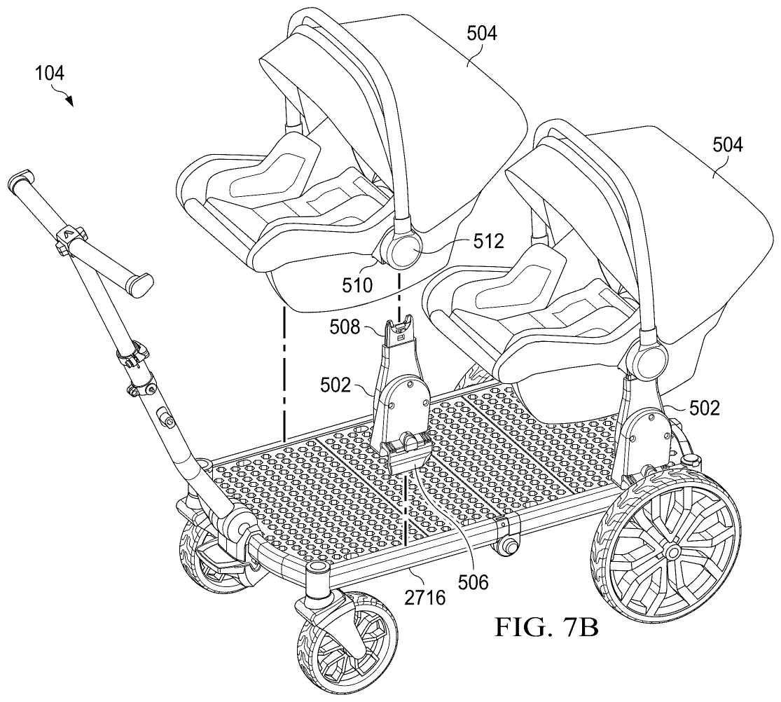

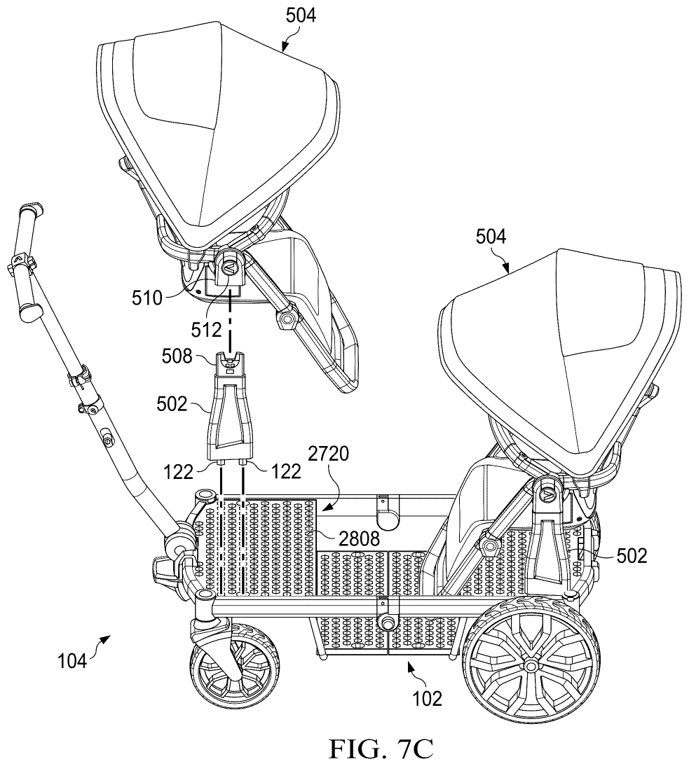

FIGS. 1A-1J illustrate an exemplary embodiment of a wagon 100. The wagon 100 includes a wagon chassis 104 and one or more optional accessories, such as for example a modular wagon bed 106 (see FIGS. 1H and 1I) or adapters (see FIGS. 7A-7C, 11A-11B, 12A-12B, 13A-13B, 14A-14B, 15A-15D), that can be removably coupled to the wagon chassis 104. The wagon chassis 104 and the optional additional components describe herein may collectively be referred to as a “modular wagon,” “wagon,” or a “wagon assembly” according to various embodiments of the present disclosure. Additionally, it will be understood that the wagon chassis 104 alone may be referred to as a “modular wagon,” “wagon,” or a “wagon assembly” according various embodiments of the present disclosure. As shown herein, in many embodiments, the wagon chassis 104 is a foldable wagon chassis 100. However, in other embodiments the modular wagon 100 is not foldable.

The wagon chassis 104 includes a frame 2716, a deck 2720, wheels 112a, 112b, and a handle 114. The deck 2720 is coupled to the frame 2716 and forms a support surface for the optional accessories. In some embodiments, the deck 2720 may include one or more deck panels 2722 that are removably coupled to the frame 2716. The wheels include a first pair of wheels 112a coupled to the frame 2716 and a second pair of wheels 112b coupled to the frame 2716. In some embodiments, the first pair of wheels 112a are coupled proximate to or at a first end of the frame 2716, such as a front end of the frame 2716, on opposite sides of the frame 2716. In some embodiments, the first pair of wheels 112a swivel with respect to the wagon chassis 104. The first pair of wheels 112a may be referred to as swivel wheels 112a. In some embodiments, the second pair of wheels 112b are coupled proximate to or at a second end of the frame 2716, such as a rear end of the frame 2716, on opposite side of the frame 2716. In some embodiments, the second pair of wheels 112b do not swivel with respect to the wagon chassis 104. In some embodiments, the second pair of wheels 112b have a larger diameter than the first pair of wheels 112a.

The wheels 112a, 112b may be displaceable from their use position, for example by being removable from the frame 2716, foldable flat to adjacent the deck 2720, etc. It will be understood that different sizes of wheels 112a, 112b may be used at a front (e.g., proximate the handle 114) compared to the back (e.g., opposite the handle 114) for example, for providing increasing off road capabilities and the ability for the wagon chassis 104 to be transported across varying terrains such as beaches, hiking trails, snow, or the like. Thinner or thicker wheels 112a, 112b may be used to further accommodate various terrains. Accordingly, any combination of size (e.g., diameter and/or width) of wheel 112a, 112b may be used with the wagon chassis 104 as described throughout the present disclosure.

The handle 114 is coupled to the frame 2716. The handle 114 may pivot with respect to the frame 2716 and may fold down toward the deck 2720. In some embodiments, the handle 114 is removably coupled to the frame 2716 and may alternatively be coupled to the first end of the frame 2716 and the second end of the frame 2716.

### Wagon Chassis

In some embodiments, the wagon chassis 104 has a first chassis portion 2708 and a second chassis portion 2712 that are configured to fold relative to one another. Coupled to the first chassis portion 2708 are the first pair of wheels 112a and the handle 114, and coupled to the second chassis portion 2712 are the second pair of wheels 112b. Throughout this specification, the wagon chassis 104 may be referred to as having a front, a rear, a left side, and a right side; however, it should be understood that these terms are used herein for ease of description to describe one element or feature's relationship to another element(s) or feature(s) as illustrated in the figures, and that what may be considered the front, rear, left, and right of the wagon chassis 104 may be swapped depending on, for example, if the locations of the wheels 112a, 112b are swapped and/or if the location of the handle 114 is swapped, as described herein.

In some example embodiments, the wagon chassis 104 is configured to be selectively positioned in a first position or a second position. The first position is considered the unfolded or use position, and the second position is considered the folded or storage position. The first chassis portion 2708 and the second chassis portion 2712 are positionable between the first position and the second position, such that the first chassis portion 2708 and the second chassis portion 2712 are rotatable relative to one another between the first position and the second position. The foldable wagon chassis 104 is therefore able to be folded down to a smaller size for storage and or transport. In some embodiments, the frame 2716 of the wagon chassis 104 is not foldable.

### Frame

In some embodiments, the frame 2716 of the wagon chassis 104 includes one or more frame members, one or more swivel wheel housings, and one or more hinges. For example, the frame 2716 includes a first frame member 2724, a second frame member 2728, a third frame member 2732, a fourth frame member 2736, a fifth frame member 2740, and a sixth frame member 2744. The first frame member 2724 may be considered a front frame member. The second frame member 2728 may be considered a rear frame member. The third frame member 2732 and fourth frame member 2736 may be considered left side frame members. The fifth frame member 2740 and sixth frame member 2744 may be considered right side frame members. The first frame member 2724, third frame member 2732, and fifth frame member 2740 cooperate to form a first frame portion 2748 of the frame 2716. The second frame member 2728, fourth frame member 2736, and sixth frame member 2744 cooperate to form a second frame portion 2752.

The frame 2716 also includes a first swivel wheel housing 2726, a second swivel wheel housing 2730, a third swivel wheel housing 2734, and a fourth swivel wheel housing 2738. The swivel wheel housings 2726, 2730, 2734, and 2738 are located at the four corners of the wagon chassis 104. The first frame member 2724 and the third frame member 2732 are coupled to the first swivel wheel housing 2726, for example, by welds. The first frame member 2724 and the fifth frame member 2740 are coupled to the second swivel wheel housing 2730, for example, by welds. The second frame member 2728 and the fourth frame member 2736 are coupled to the third swivel wheel housing 2734, for example, by welds. The second frame member 2728 and the sixth frame member 2744 are coupled to the fourth swivel wheel housing 2738, for example, by welds. Each of the swivel wheel housings 2726, 2730, 2734, and 2738 have sockets that are configured to receive the stems of the first pair of wheels 112a. Although there are four swivel wheel housings 2726, 2730, 2734, and 2738 shown, there are typically only two swivel wheel housings used at any given time. That is, the wagon chassis 104 usually only includes one pair of swivel wheels 112a.

In some embodiments, the wagon chassis 104 further includes two hinges: a first hinge 2756, and a second hinge 2760. The first hinge 2756 couples the third frame member 2732 with the fourth frame member 2736. The second hinge 2760 couples the fifth frame member 2740 with the sixth frame member 2744. The first hinge 2756 may be considered a left side hinge and the second hinge 2760 may be considered a right side hinge. The first hinge 2756 and the second hinge 2760 allow relative rotation between the third frame member 2732 and the fourth frame member 2736 and the fifth frame member 2740 and the sixth frame member 2744, respectively. Accordingly, the first hinge 2756 and the second hinge 2760 allow folding of the first frame portion 2748 and the second frame portion 2752 with respect to one another.

The first hinge 2756 and the second hinge 2760 are shown as being located on the wagon chassis 104 halfway between the front and rear of the wagon chassis 104; however, in some embodiments, the first hinge 2756 and the second hinge 2760 may be located closer to the front of the wagon chassis 104 or closer to the rear of the wagon chassis 104 without departing from the scope of the disclosure.

As shown in FIGS. 1C and 1D, each of the first hinge 2756 and the second hinge 2760 include a first hinge element 2764 and a second hinge element 2768 that are pivotably coupled to one another by a hinge pin 2772. The first hinge element 2764 includes, for example, a groove 2776 and the second hinge element 2768 includes a tab 2780. The groove 2776 is sized and shaped to receive the tab 2780. The first hinge element 2764 and the second hinge element 2768 rotate relative to one another about the hinge pin 2772. For example, wagon chassis 104 is configured to fold and unfold along a fold axis extending from the left side to the right side of the wagon chassis 104, the fold axis extending through the hinge pins 2772 of each of the first hinge 2756 and the second hinge 2760.

In some embodiments, the first hinge 2756 and the second hinge 2760 each include a lock mechanism, such as a spring-loaded pin that is received in a corresponding hole, that prevents movement of the first hinge 2756 and the second hinge 2760 and holds the wagon chassis 104 in the first, unfolded, or use position. For example, the spring-loaded pin may be located in the groove 2776 of each first hinge element 2764 and may be received in a corresponding hole in the tab 2780 of each respective second hinge element 2768. When a user desires to fold the wagon chassis 104, the user can unlock the lock mechanism, using a fold actuator 2778 for example, to permit rotation of the first hinge 2756 and the second hinge 2760 and is then able to fold the wagon chassis 104 to the second, folded, or storage position. For example, the fold actuator 2778 may include a button that can be depressed to unlock the lock mechanism to fold the wagon chassis 104. In some embodiments, the lock mechanism may also hold the wagon chassis 104 in the second, folded, or storage position. Thus, when a user desires to unfold the wagon chassis 104, the user can unlock the lock mechanism to permit rotation of the first hinge 2756 and the second hinge 2760 and is then able to unfold the wagon chassis 104 to the first, unfolded, or use position.

### Deck

With specific reference to FIGS. 1A and 1B, the deck 2720 includes one or more deck panels 2722 that cooperate to form the deck 2720. The deck 2720 includes a top surface 2782 upon which items may be placed. For example, in some embodiments, the deck 2720 includes a first deck panel 2792, a second deck panel 2796, a third deck panel 2794, and a fourth deck panel 2798. The first deck panel 2792, the second deck panel 2796, the third deck panel 2794, and the fourth deck panel 2798 each have a respective top surface and bottom surface, wherein the respective top surfaces of the first deck panel 2792, the second deck panel 2796, the third deck panel 2794, and the fourth deck panel 2798 form the top surface 2782 of the deck 2720. It should be understood that in embodiments, where the wagon chassis 104 includes a single deck panel, that the top surface of that single deck panel forms the top surface 2782 of the deck 104.

With continued reference to FIGS. 1A and 1B, in some embodiments, the first deck panel 2792 and the third deck panel 2794 are part of the first chassis portion 2708 and the second deck panel 2796 and the fourth deck panel 2798 are part of the second chassis portion 2712. The first deck panel 2792 and the third deck panel 2794 are coupled to the first frame portion 2748 and the second deck panel 2796 and the fourth deck panel 2798 are coupled to the second frame portion 2752. As an example, the first deck panel 2792 and the third deck panel 2794 may be coupled to and bounded by the first frame member 2724, the third frame member 2732, and the fifth frame member 2740. The tops of the first deck panel 2792 and the third deck panel 2794 may be flush with the top of the first frame member 2724, the third frame member 2732, and the fifth frame member 2740. Additionally, the second deck panel 2796 and the fourth deck panel 2798 may be coupled to and bounded by the second frame member 2728, the fourth frame member 2736, and the sixth frame member 2744. The tops of the second deck panel 2796 and the fourth deck panel 2798 may be flush with the top of the second frame member 2728, the fourth frame member 2736, and the sixth frame member 2744. When the wagon chassis 104 is in the first, unfolded, or use position, the top of the first deck panel 2792 is flush with the top of the second deck panel 2796.

In some embodiments, the first deck panel 2792, the second deck panel 2796, the third deck panel 2794, and the fourth deck panel 2798 are fixedly coupled to the frame 2716. In some embodiments, the first deck panel 2792 and the second deck panel 2796 are fixedly coupled to the frame 2716, while the third deck panel 2794 and the fourth deck panel 2798 are removably coupled to the frame 2716. In some embodiments, one, some, or all of the first deck panel 2792, the second deck panel 2796, the third deck panel 2794, and the fourth deck panel 2798 are fixedly coupled to the frame 2716. In some embodiments, one, some, or all of the first deck panel 2792, the second deck panel 2796, the third deck panel 2794, and the fourth deck panel 2798 are removably coupled to the frame 2716. In some embodiments, the first deck panel 2792 and the second deck panel 2796 are fixedly in position to the frame 2716, while the third deck panel 2794 and the fourth deck panel 2798 are moveable with respect to the frame 2716.

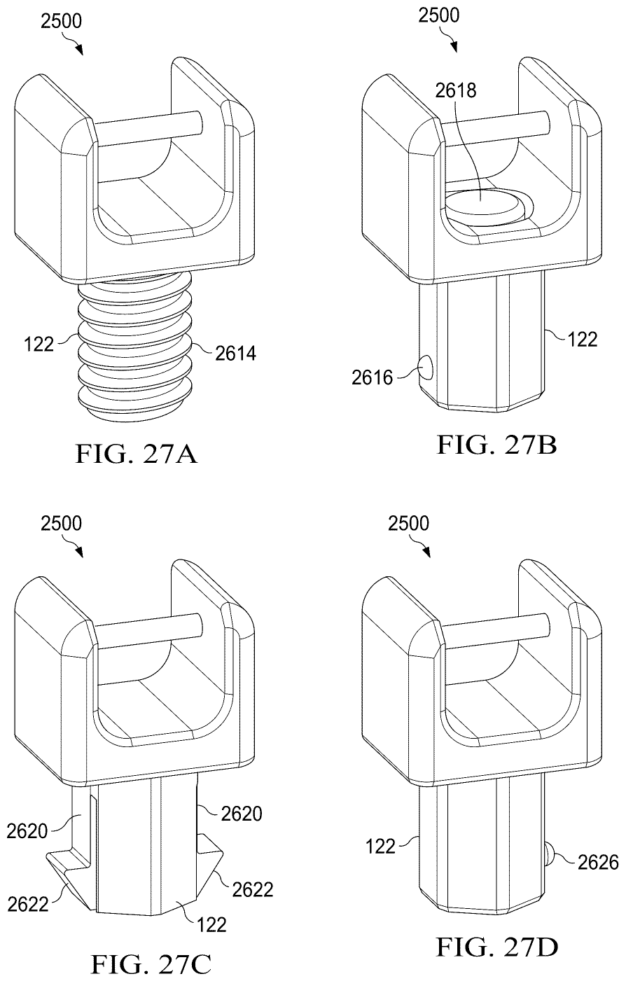

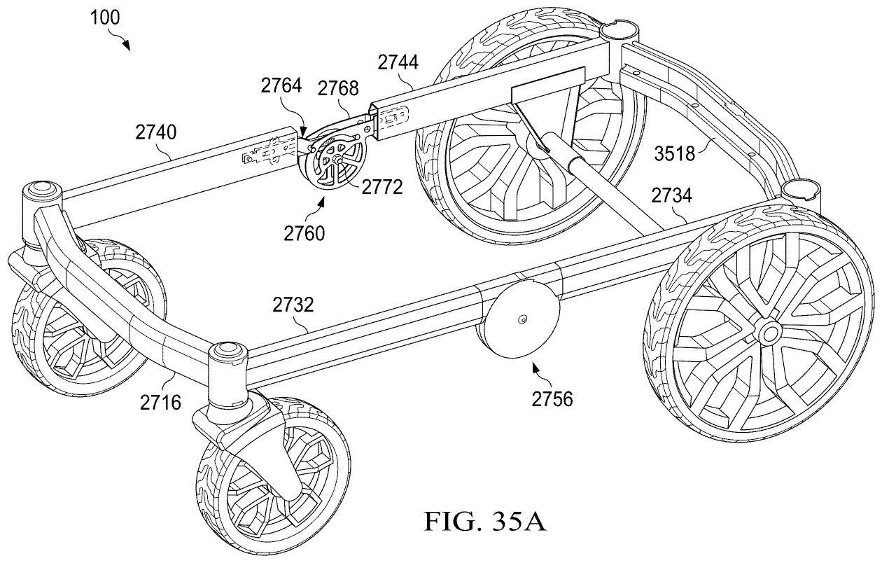

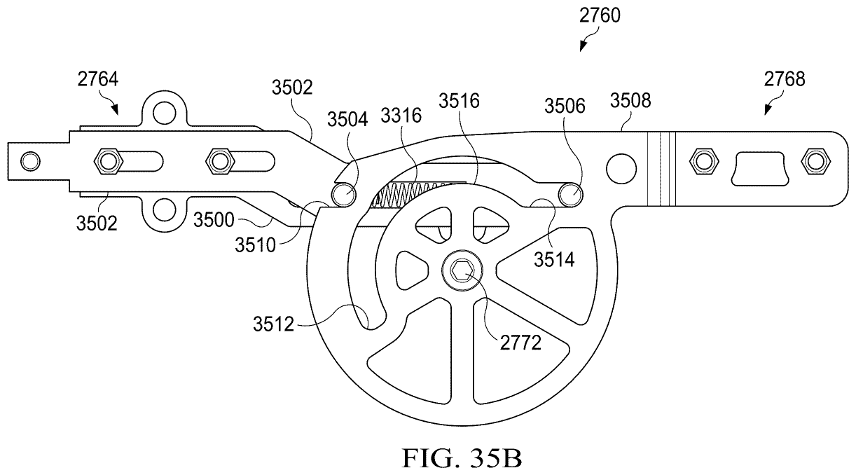

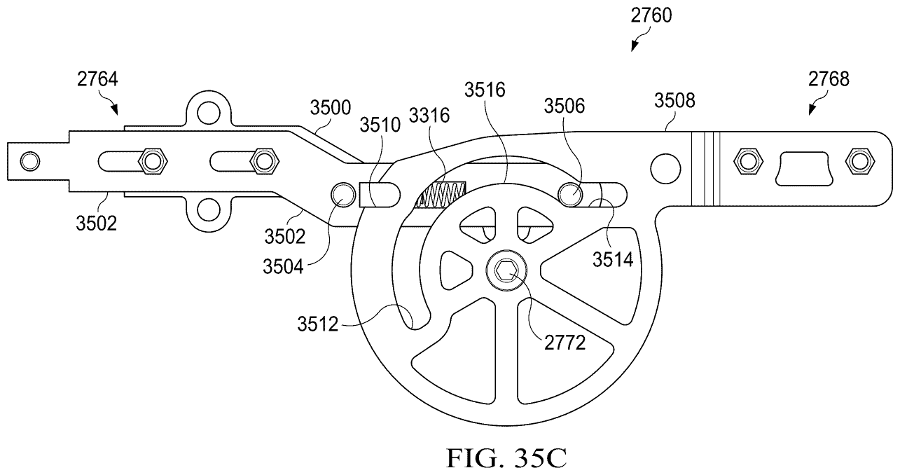

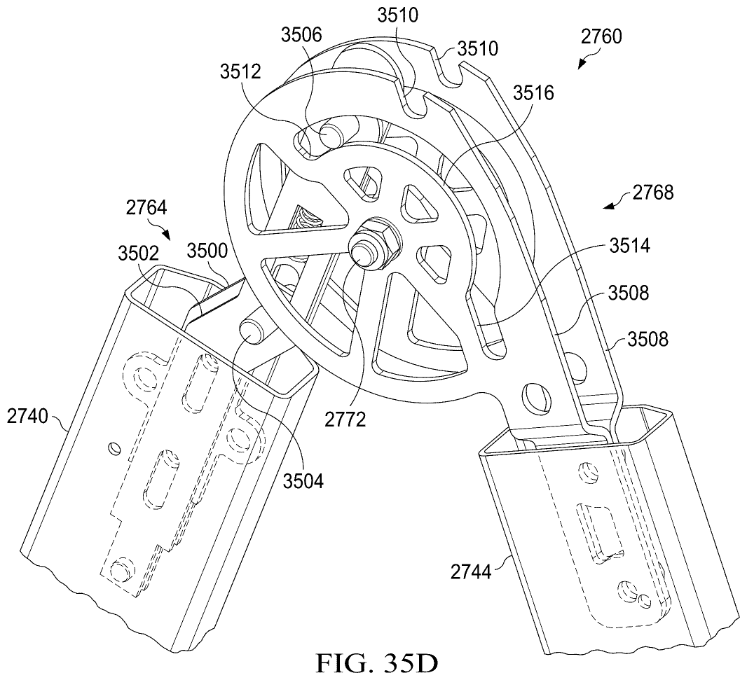

For example, in some embodiments, the deck 2720 is coupled to the wagon chassis 104 by fasteners, such as for example, screws, bolts, etc. that secure the one or more deck panels 2722 to the frame 2716. In some embodiments, one or more tools may be required to remove and reattach the fasteners to decouple and couple the one or more deck panels 2722 to the wagon chassis. In some embodiments, the one or more deck panels 2722 include spring-loaded ball locks that that are configured to be received in one or more corresponding detents in the frame 2716 of the wagon chassis 104 (an example of a ball lock is described herein with respect to FIG. 27B). In some embodiments, the one or more deck panels 2722 are clamped to the frame 2716. In some embodiments, the frame 2716 includes one or more ledges (see, e.g., ledge 3518 in FIG. 35A) around the interior perimeter of the frame 2716 on which the one or more deck panels 2722 may be supported and/or coupled to. In some embodiments, the frame 2716 includes one or more crossmembers. For example, fasteners may extend through the top surface 2782 of the deck 2720 and into corresponding threaded holes in the one or more ledges and/or the one or more crossmembers of the frame 2716. As another example, in some embodiments, the one or more deck panels 2722 may include one or more magnets which may be magnetically attracted to the frame 2716, the one or more ledges, the one or more crossmembers, and/or corresponding magnets or magnetic material (e.g., ferrous metal, a plastic magnet) in or on the frame 2716, the one or more ledges, and/or the one or more crossmembers. As such, the deck 2720 may be magnetically coupled to the wagon chassis 104.

In some embodiments the deck 2720 is non-slip. For example, the deck 2720 may be made of a rubberized non-slip material and/or coated with a rubberized non-slip material. In some embodiments, the deck 2720 may have non-slip portions, such as for example, areas of high surface roughness. In some embodiments, the deck 2720 may include grooves or a tread pattern that provide a non-slip surface.

### Attachment Features

In the exemplary embodiment shown in FIGS. 1A and 1B, the deck 2720 includes a population of attachment features 2802 that are configured to permit the optional additional components, such as accessories and/or adapters, to be attached to the wagon chassis 104. For example, each of the first deck panel 2792, the second deck panel 2796, the third deck panel 2794, and the fourth deck panel 2798 include a population of attachment features 2802 that are configured to permit accessories to be attached to the wagon chassis 104. For example, the population of attachment features 2802 includes, without limitation, one or more of: a population of tie downs 2804, and a population of openings 2808. The population of openings 2808 may be referred to as a smart grid.

The tie downs 2804 include two openings separated by a bar 2806. Alternatively, the tie downs 2804 may be considered a single opening bisected by a bar 2806. The tie downs 2804 permit, for example, bungee cords and/or cargo nets to be secured to the wagon chassis 104. The tie downs 2804 are shown proximate to the peripheral edges of the first deck panel 2792 and the second deck panel 2796. As shown, the tie downs 2804 are open from the top sides to the bottom sides of the first deck panel 2792, the second deck panel 2796, the third deck panel 2794, and the fourth deck panel 2798.

Each of the first deck panel 2792, the second deck panel 2796, the third deck panel 2794, and the fourth deck panel 2798 are shown as including two tie downs 2804. The tie downs 2804 in each of the first deck panel 2792, the second deck panel 2796, the third deck panel 2794, and the fourth deck panel 2798 are located near the peripheries of the respective first deck panel 2792, second deck panel 2796, third deck panel 2794, and fourth deck panel 2798 proximate to the frame 2716.

Although, the first deck panel 2792, the second deck panel 2796, the third deck panel 2794, and the fourth deck panel 2798 are shown as each having two tie downs 2804, it will be understood that each of the first deck panel 2792, the second deck panel 2796, the third deck panel 2794, and the fourth deck panel 2798 may include less than two or greater than two tie downs 2804 without departing from the scope of the disclosure. Additionally, in some embodiments, the number of tie downs 2804 in the first deck panel 2792, the second deck panel 2796, the third deck panel 2794, and the fourth deck panel 2798 may be different. In some embodiments, tie downs 2804 are only included in the first deck panel 2792, while in other embodiments, tie downs 2804 are only included in the second deck panel 2796, while in yet other embodiments, tie downs 2804 are only included in the first deck panel 2792 and the second deck panel 2796.

With continued reference to FIGS. 1A and 1B, the deck 2720 includes a population of openings 2808, which may be referred to as a smart grid. For example, the openings 2808 are shown as arrayed in a grid pattern through the one or more deck panels 2722 of the deck 2720 (e.g., the first deck panel 2792, the second deck panel 2796, the third deck panel 2794, and the fourth deck panel 2798). As shown, the openings 2808 are open from the top sides to the bottom sides of the one or more deck panels 2722 of the deck 2720 (e.g., the first deck panel 2792, the second deck panel 2796, the third deck panel 2794, and the fourth deck panel 2798). The openings 2808 are shown as being located in the central area of each of the one or more deck panels 2722 of the deck 2720 (e.g., the first deck panel 2792, the second deck panel 2796, the third deck panel 2794, and the fourth deck panel 2798). In some embodiments, the openings 2808 are in an array lengthwise and widthwise on the one or more deck panels 2722 of the deck 2720 (e.g., the first deck panel 2792, the second deck panel 2796, the third deck panel 2794, and the fourth deck panel 2798). Stated another way, the openings 2808 may be arranged in a plurality of rows and columns extending at least across a portion of the length and width of one or more deck panels 2722 of the deck 2720 (e.g., the first deck panel 2792, the second deck panel 2796, the third deck panel 2794, and the fourth deck panel 2798). In some embodiments, openings 2808 in adjacent rows may be aligned or offset. For example, adjacent rows may be offset, as illustrated in FIGS. 1A and 1B, so that the openings 2808 are aligned in alternating rows. As described in greater detail herein, for example, pegs of the additional components are sized, shaped, and/or located to insert into one or more of the openings 2808 to couple the additional components to the wagon chassis 104 and the wagon 100 more generally. In some embodiments, the openings 2808 are arranged in non-linear patterns to receive pegs of specific additional components that are unique to that additional component. In some embodiments, the openings 2808 may be sized and/or shaped to permit rope to be extended through and/or tied to the openings 2808. Although the openings 2808 are shown as hexagonal holes, it will be understood that the openings 2808 may have a different shape (e.g., circular, square, triangular, octagonal, ovular, stadium, trapezoidal) without departing from the scope of the disclosure.

Although, the first deck panel 2792, the second deck panel 2796, the third deck panel 2794, and the fourth deck panel 2798 are shown as each having a population of openings 2808, it will be understood that the number of openings 2808 in the first deck panel 2792, the second deck panel 2796, the third deck panel 2794, and the fourth deck panel 2798 may be different. In some embodiments, openings 2808 are only included in the first deck panel 2792, while in other embodiments, openings 2808 are only included in the second deck panel 2796, while in yet other embodiments, openings 2808 are only included in the first deck panel 2792 and the second deck panel 2796.

In addition to serving as attachment features 2802, one or more of the tie downs 2804 and openings 2808 may provide ventilation and/or drainage for the wagon chassis 104.

### Foldable Wagon Chassis

From the foregoing description, it will be understood that in some embodiments, the first chassis portion 2708 of the wagon chassis 104 comprises the first frame portion 2748, the first deck panel 2792, two wheels 112a, and the handle 114, and the second chassis portion 2712 of the wagon chassis 104 comprises the second frame portion 2752, the second deck panel 2796, and two additional wheels 112b. Additionally, it will be understood that, in some embodiments, the wagon chassis 104 includes four tie downs 2804 along the left side of the wagon chassis 104 and four tie downs 2804 along the right side of the wagon chassis 104. In some embodiments, the wagon chassis 104 includes two tie downs 2804 along the front of the wagon chassis 104 and two tie downs 2804 along the rear of the wagon chassis 104. Moreover, it will be understood that, in some embodiments, the wagon chassis 104 includes a population of openings 2808 in the deck 2720 of the wagon chassis 104. Additionally, although the wagon chassis 104 is described as having a separate first frame portion 2748 and a separate first deck panel 2792 and a separate second frame portion 2752 and a separate second deck panel 2796, it will be understood that in some embodiments the first frame portion 2748 and the first deck panel 2792 may be integrally formed with one another and the second frame portion 2752 and the second deck panel 2796 may be integrally formed with one another.

As shown in FIGS. 1A, when the wagon chassis 104 is in the first, unfolded, or use position, the top of the first deck panel 2792, the top of the second deck panel 2796, the top of the third deck panel 2794, and the top of the fourth deck panel 2798 are parallel and flush with one another. Additionally, when the wagon chassis 104 is in the first, unfolded, or use position, the tops of the first deck panel 2792 and the third deck panel 2794 and the tops of the second deck panel 2796 and the fourth deck panel 2798 may have an angle of 180 degrees between them.

As shown in FIG. 1G, when the wagon chassis 104 is in the second, folded, or storage position, the tops of the first deck panel 2792 and the third deck panel 2794 and the tops of the second deck panel 2796 and the fourth deck panel 2798 face away from one another and the bottoms of the first deck panel 2792 and the third deck panel 2794 and the bottoms of the second deck panel 2796 and the fourth deck panel 2798 are proximate to and face one another. Additionally, in some embodiments, when the wagon chassis 104 is in the second, folded, or storage position, the tops of the first deck panel 2792 and the third deck panel 2794 and the tops of the second deck panel 2796 and the fourth deck panel 2798 may have an angle from 360 degrees to 300 degrees between them.

### Handle

Referring now to FIGS. 1E, 1F, and 1G, in some embodiments, the handle 114 is telescopic. For example, the handle 114 includes a first handle portion 114a and a second handle portion 114b, wherein the first handle portion 114a is configured to be received in the second handle portion 114b and is configured to slide at least partially into and out of the second handle portion 114b. The handle 114 further includes a handle bar 114c at the top of the first handle portion 114a, for example, the handle bar 114c and the first handle portion 114a forming a T-shape. The handle 114 further includes a clamp, such as for example, a quick release clamp 114d coupled to the second handle portion 114b that can be released to extend or retract the first handle portion 114a out of or into the second handle portion 114b. The handle 114 is shown in an extended position in FIG. 1E and a retracted or collapsed position in FIG. 1F. As shown in FIG. 1G, the first handle portion 114a can retract into the second handle portion 114b so that the handle 114 does not extend far beyond the top of the wagon chassis 104 when it is folded. For example, when in the fully collapsed position, the handle bar 114c may be located sufficient distance above the top of the wagon chassis 104 when the wagon chassis 104 is folded to permit a user to grab the handle bar 114c to move or lift the wagon chassis 104. In some embodiments, for example, the handle 114 may have a telescoping structure that permits it to collapse to at or vertically below the first chassis portion 2708 and the second chassis portion 2712.

According to various embodiments, the handle 114 may be removably couplable to the wagon chassis 104 for placement at either end of the wagon chassis 104. For example, the handle 114 may be placed on an end proximate to relatively larger wheels 112 for making it easier for a user to push the wagon chassis 104 or the handle 114 may be placed on an end proximate to relatively smaller wheels 112 for making it easier for a user to pull the wagon chassis 104. The handle 114 may be a position-locking handle feature. On a typical wagon the handle is free to rotate about its axis until its movement is limited by the wagon geometry or the ground. But on the wagon chassis 104 of the present invention, the handle 114 locks in one or more positions. Locking handle design options include automatic lock or only when intentioned by the user. Any embodiments of the position-locking handle 114 may be used as described at least in U.S. Pat. No. 11,198,460 which is incorporated by reference herein.

Wagon with Wagon Chassis and Modular Wagon

FIGS. 1H-1J show a wagon 100, which may be a modular wagon, with a collapsible footwell feature 102. The wagon 100 may include the wagon chassis 104 and an accessory, such as a modular wagon bed 106, which may be removably coupled to the wagon chassis 104, which collectively may be referred to as a “modular wagon,” “wagon,” or “wagon assembly” according to various embodiments of the present disclosure. The collapsible footwell feature 102 may be integrated with the either the removable modular wagon bed 106, as shown in FIG. 1H, or with the wagon chassis 104 as shown and described with respect to other figures. The modular wagon bed 106 may include a base 108 and peripheral walls 110 extending upright from the base 108. For example, the base 108 may include a peripheral frame and two opposing sidewalls and two opposing endwalls, with the sidewalls and endwalls all pivotably mounted at lower portions thereof to the base 108 from an upright or use position (as shown in FIG. 1H) to their collapsed or storage position (as shown in FIG. 1J) such that the walls are folded down adjacent (i.e., against or closer to) the base 108. The collapsible footwell feature 102 may include a footrest 116 and upright elements 118 extending between the base 108 of the modular wagon bed 106 and the footrest 116. The footwell feature 102 may include an opening in the base 108 (e.g., where there is no bottom wall mounted to the base 108), which can have the same shape (e.g., rectangular) and size as the footrest 116 and be aligned directly above the footrest 116 (e.g., generally centrally positioned in the modular wagon bed 106). In at least some embodiments, the collapsible footwell feature 102 may include at least one footwell sidewall 120. The footwell sidewall(s) 120 may, in the storage position, may be positioned more proximate to the at least one seating surface (e.g., the portions of the base 108 that are not the collapsible footwell feature 102) than the footrest 116 when the collapsible footwell feature 102 is in the extended position.

As shown in FIG. 1H, the third deck panel 2794 and the fourth deck panel 2798 may be removed or stowed to provide an opening 124 in the deck 2720 of the wagon chassis 104 through which the collapsible footwell feature 102 may pass downward through.

In various embodiments, the upright elements 118 are provided by at least two upright structural members, one forward and one rearward, which are each pivotably coupled at upper portions to the base 108 and pivotably coupled at lower portions to the footrest 116. The pivotable couplings can be of a conventional design and assembly. The at least one forward upright structural member can be provided by two tubes, wires, rods, etc. at the two respective forward corners of the footrest, by a plate, panel, lattice, etc. extending laterally across the footrest, or by other conventional structural members, and the same applies to the at least one rearward upright structural member. In this way, the footwell can be collapsed from the extended/use position to the collapsed/storage position by swinging/pivoting the footrest 116 forward or rearward, respectively. Also, a footwell peripheral sidewall 120 of soft goods (e.g., fabric) can be provided surrounding the footrest 116 and defining the footwell interior.

The collapsible footwell includes a footrest that is positionable between an extended/use position lowered relative to the base and a collapsed/storage position closer to the base to provide a compact profile/arrangement to reduce the occupied footwell volume for storage and/or transport purposes. In the collapsed/storage position, the vacated space where the footwell was in the extended/use position effectively reduces the height dimension of the wagon with the wheels displaced (e.g., removed or folded to adjacent the base) to provide a smaller size for transportation and storage, for example during shipping from the manufacturer and/or the retailer, during storage in a user's garage, and/or during transport in a user's personal vehicle. The overall height of the wagon, with the wheels displaced and the upright walls folded down, is thus significantly reduced, thereby significantly reducing its package size for shipment from the manufacturer and/or retailer, and thereby significantly reducing shipping costs.

In other embodiments not depicted herein but contemplated by the invention, other conventional linkage systems can be implemented extending between and interconnecting the wagon base and the footrest to permit the footrest to compress, fold, slide, screw, or otherwise collapse from its extended/use position to its/storage position closer to the wagon base.

As further shown in FIG. 1H, in some embodiments, the modular wagon bed 106 includes one or more pegs 122 extending downward from the base 108 away from the peripheral walls 110. For example, the modular wagon bed 106 includes four pegs 122 at the corners of the base 108. The pegs 122 are configured to insert into openings 2808 in the deck 2720 of the wagon chassis 104 to secure the modular wagon bed 106 to the wagon chassis 104. The pegs 122 thus may be sized to fit within the openings 2808 in the deck 2720. In some embodiments, the pegs 122 are sized to fit within the openings 2808 in the deck 2720 and have a shape corresponding to the shape of the openings 2808. For example, where the openings 2808 are hexagonal, the pegs 122 are hexagonal and are sized to fit within the openings 2808. In some embodiments, the pegs 122 are sized to fit within the openings 2808 in the deck 2720, have a shape corresponding to the shape of the openings 2808, and are located on the accessory, such as the modular wagon bed 106, to permit inserting the pegs 122 into the openings 2808. Providing pegs 122 that have the same shape as the openings 2808 may provide for a more secure connection of the modular wagon bed 106 onto the wagon chassis 104 and may reduce or eliminate movement of the modular wagon bed 106 with respect to the wagon chassis 104. Additionally, providing two or more pegs 122 on the additional components, such as the modular wagon bed 106, can limit or prevent rotational movement of the additional components with respect to the wagon chassis 104.

The handle 114 may be configured to transition from a first use position and a stowed position according to at least some embodiment. The handle 114 may include a pivotable coupling for pivoting the handle between the first use position and the stowed position. Further, the handle 114 may be positionable in a second use position via the pivotable coupling for pivoting the handle between the first use position and the second use position. The handle 114 may be coupled to any of the frame members 2724, 2728, 2732, 2736, 2740, 2744 or any of the ends of the wagon chassis 104 described herein, to be illustrated in further detail with respect to other figures.

According to various embodiments, the portions of the base 108 (interchangeably referred to herein as a bottom surface) of the modular wagon bed 106 may be a seating surface. For example, a child may sit on the base 108 of the modular wagon that is not part of the collapsible footwell feature 102 and rest their feet within the collapsible footwell feature 102. Similarly, a bottom surface of the wagon chassis 104 (e.g., the deck 2720 described herein) may be a seating surface when a collapsible footwell feature 102 is in an extended position.

FIG. 1H illustrates a disassembled wagon 100 including the modular wagon bed 106 removed from the wagon chassis 104. According to various embodiments, it would be advantageous to be able to remove the modular wagon bed 106 and use the wagon chassis 104 to transport large or uniquely shaped objects that may not otherwise be securely transported by a modular wagon bed 106 having peripheral walls as shown in FIG. 1H. For example, a user may wish to transport coolers, chairs, fishing equipment such as rods or spears, skis, paddleboards, pets, yard waste, smaller containers, or the like. Accordingly, embodiments of the present disclosure provide a modular wagon 100 that is designed to carry a variety of items, such as those listed above, either directly to the wagon chassis 104 or indirectly via an adapter or the like, to be described in further detail below.

FIG. 1I illustrates an assembled wagon 100 having the modular wagon bed 106 removably coupled to the wagon chassis 104 and in a storage position. For example, the modular wagon bed 106 may have the upright walls 110 collapsed into a storage position and the handle 114 may be further folded from an upright or use position to the storage position as shown in FIG. 1J.

Additionally, as shown in FIG. 1J, the modular wagon bed 106 may be foldable. For example, the two opposing sidewalls are configured to be folded to enable the modular wagon bed 106 to be folded over to and onto the deck 2720. Additionally, the handle 114 can be folded down toward the deck 2720 to sandwich the modular wagon bed 106 against the deck 2720.

### Moveable and Removable Deck Panels

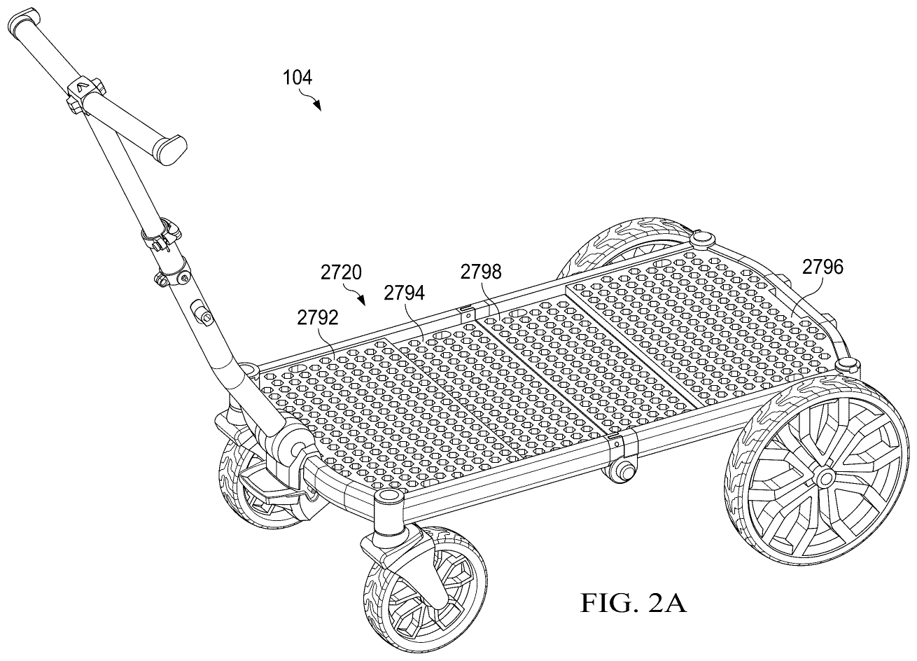

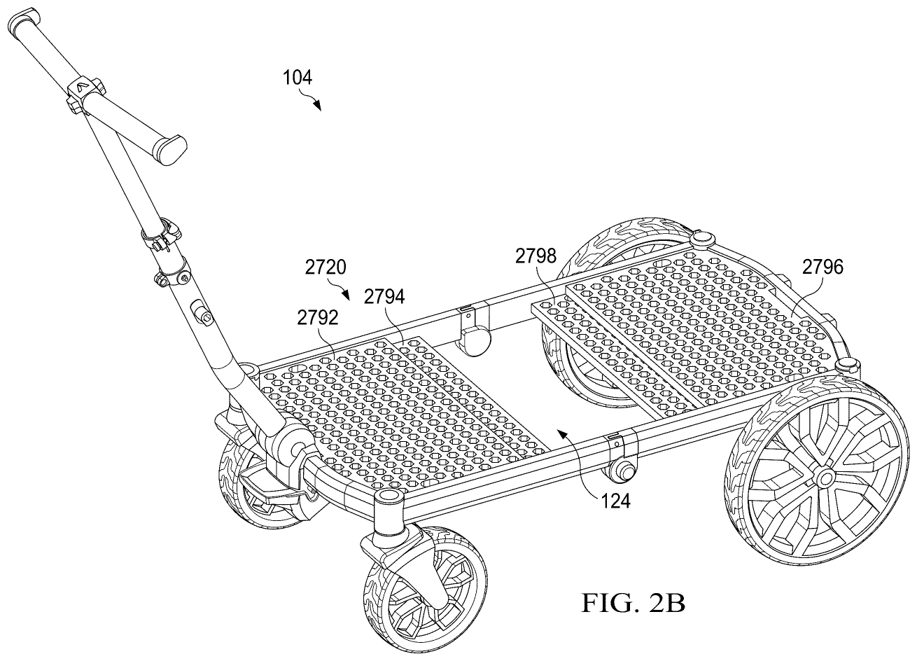

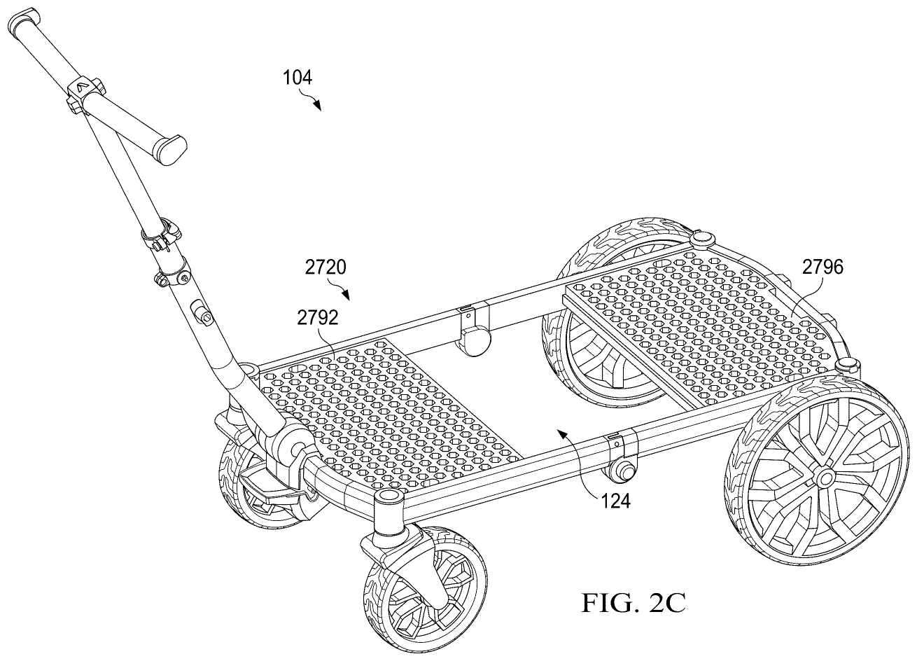

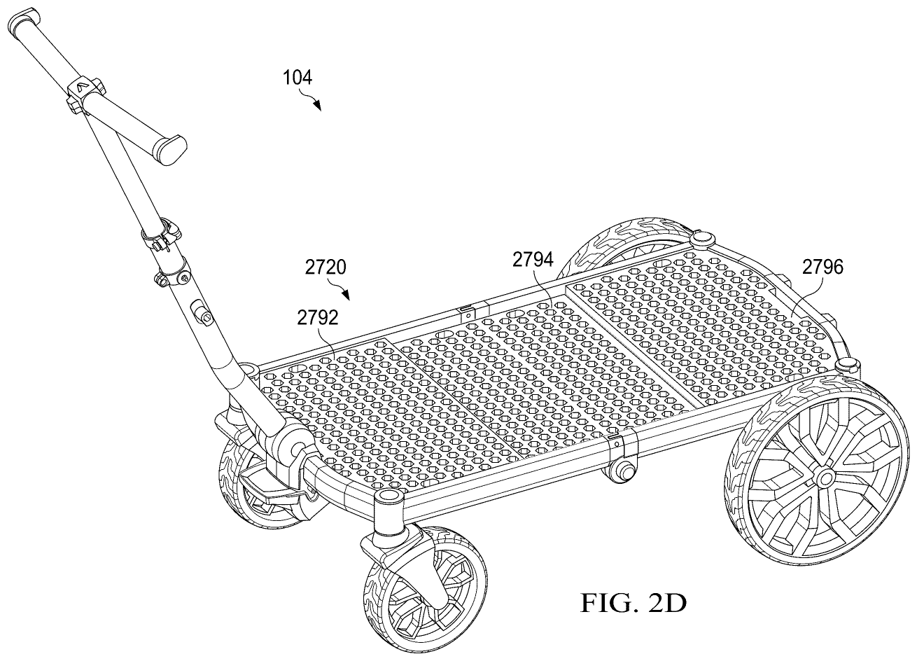

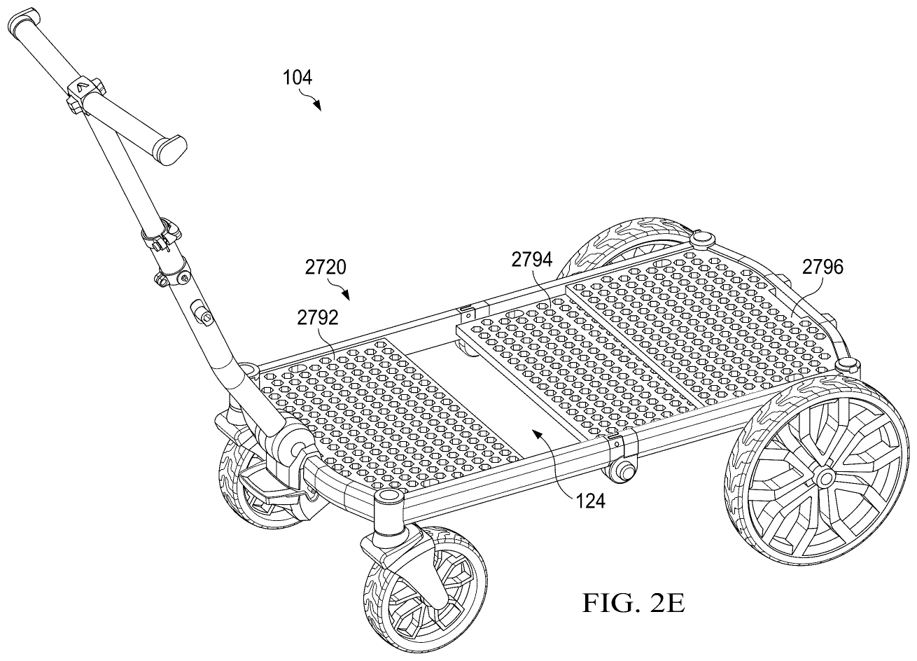

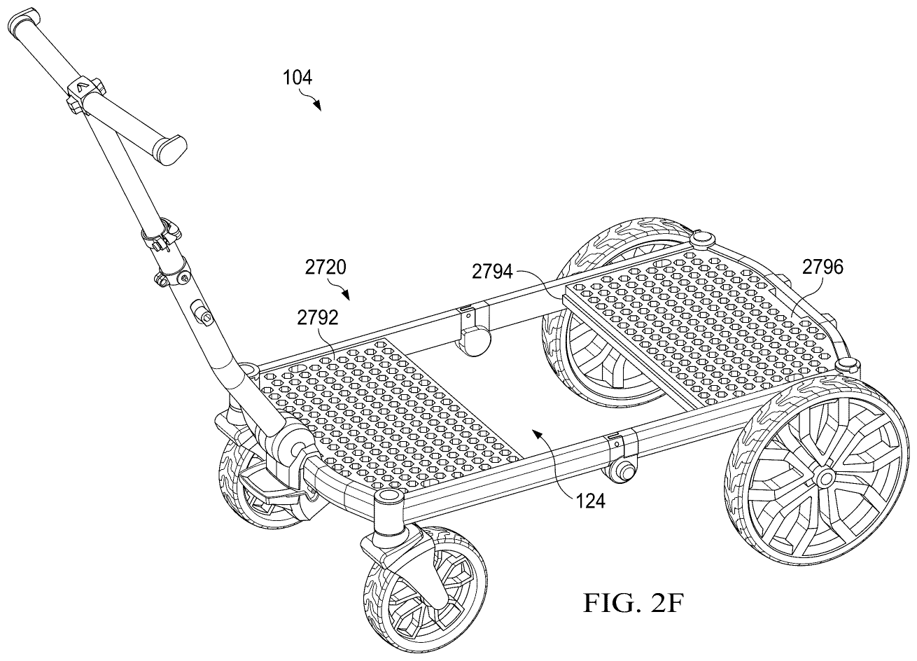

FIGS. 2A-2F shows the wagon chassis 104 with the modular wagon bed 106 removed. As shown and described with respect to FIGS. 1A-1J and 2A, embodiments of the wagon chassis 104 include the deck 2720 with first deck panel 2792, second deck panel 2796, third deck panel 2794, and fourth deck panel 2798. In FIGS. 2B and 2C, the third deck panel 2794 and the fourth deck panel 2798 may be slid away from the center of the wagon chassis 104, folded over or under and adjacent to the first deck panel 2792 and the second deck panel 2796, or otherwise removed from the wagon chassis 104 when an additional component, such as modular wagon bed 106, is coupled to the wagon chassis 104 and a collapsible footwell feature, such as collapsible footwell feature 102, is in a use position as shown in FIGS. 1H and 1I. Alternatively, the third deck panel 2794 and the fourth deck panel 2798 may remain in an extended position, as shown in FIG. 2A, when the modular wagon bed 106 is coupled to the wagon chassis 104 and the collapsible footwell feature 102 remains in a storage position (e.g., up against the modular wagon such that the footrest 116 is in the same plane as a base 108 of the modular wagon bed 106).

FIG. 2B illustrates an alternative view of the wagon chassis 104 of FIG. 2A. FIG. 2B illustrates one embodiment of the third deck panel 2794 and the fourth deck panel 2798where the third deck panel 2794 and the fourth deck panel 2798 may be at least partially or fully slid away from the center of the wagon chassis 104 to form an opening 124 in the deck 2720 to make room for, for example, the collapsible footwell feature 102 of the modular wagon bed 106. The third deck panel 2794 and the fourth deck panel 2798 may be configured to be positioned at any position between the completely closed position shown in FIG. 2A and the completely open position shown in FIG. 2C. For example, a user may only need a small opening 124 in the deck 2720 for a smaller container or adapter to be inserted therein or a user may want to completely open the deck 2720 to provide room for an extended collapsible footwell feature 102.

In some embodiments, as shown in FIGS. 2D-2F, the wagon chassis 104 includes only three deck panels: the first deck panel 2792, the second deck panel 2796, and the third deck panel 2794 wherein the third deck panel 2794 is large enough in size to span between the first deck panel 2792 and the second deck panel 2796. That is, the third deck panel 2794 may be larger than the third deck panel 2794 shown in FIG. 2C. As shown in FIGS. 2E and 2F, the third deck panel 2794 may be at least partially or fully slid away from the center of the wagon chassis 104 to form an opening 124 in the deck 2720 to make room for, for example, the collapsible footwell feature 102 of the modular wagon bed 106. The third deck panel 2794 may be configured to be positioned at any position between the completely closed position shown in FIG. 2D, the partially open position shown in FIG. 2E, and the completely open position shown in FIG. 2F. For example, a user may only need a small opening 124 in the deck 2720 for a smaller container or adapter to be inserted therein or a user may want to completely open the deck 2720 to provide room for an extended collapsible footwell feature 102.

### Collapsible Footwell

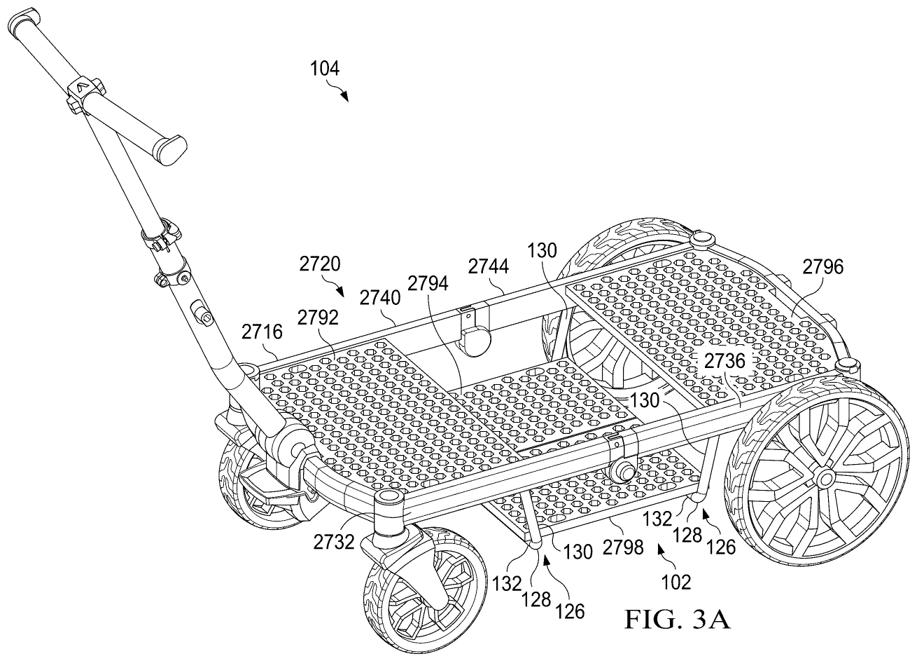

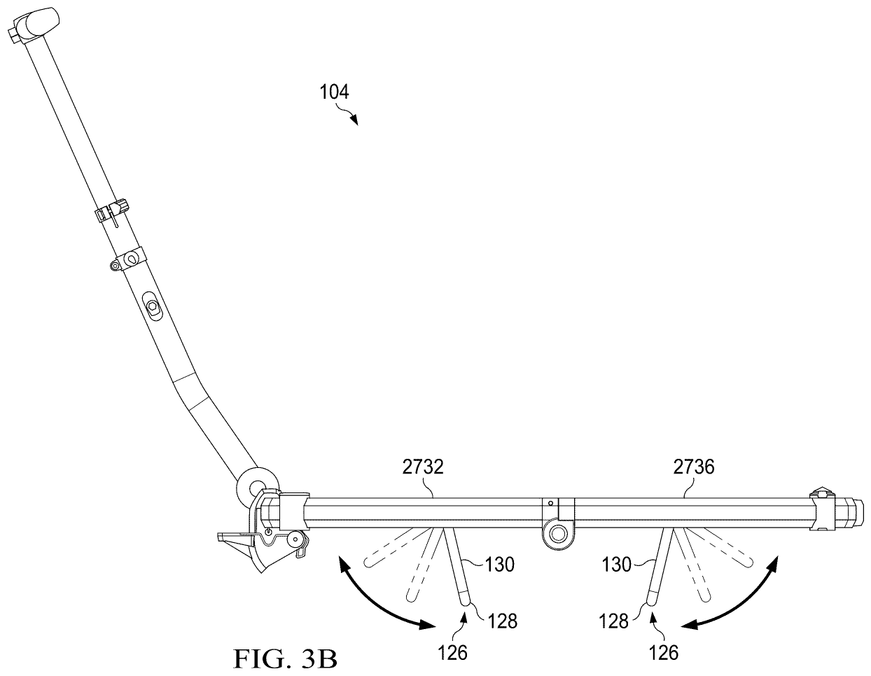

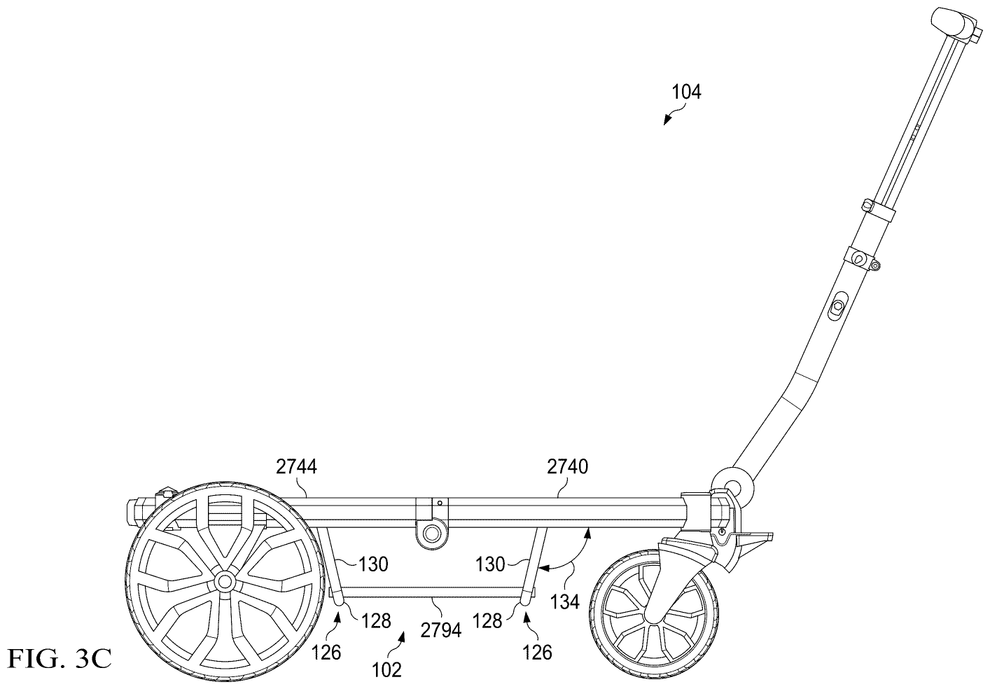

FIGS. 3A-3C show embodiments of the wagon chassis 104 in which the collapsible footwell 102 is part of the wagon chassis 104. In some embodiments, the wagon chassis 104 includes one or more support structures 126 that extend down below the frame 2716 that are then able to support one or more of the deck panels (e.g., the third deck panel 2794 and the fourth deck panel 2798) to form the bottom of the collapsible footwell upon which a person riding on the wagon chassis 104 can place their feet. For example, as shown in FIGS. 3A and 3B, the support structures 126 include a pair of U-shaped support bars 128 that are rotatably coupled to, for example, the third frame member 2732 the fourth frame member 2736 (which may be considered the left side frame members) and the fifth frame member 2740 and the sixth frame member 2744 (which may be considered right side frame members). Each of the support bars 128 includes a pair of legs 130 with a support crossbar 132 extending connected to and extending between the pair of legs 130. The support bars 128 can be located in a first, stowed position in which the legs 130 of support bars 128 are substantially parallel or parallel to the deck 2720 and in a second, deployed position in which the legs 130 of the support bars 128 are at an angle 134 with respect to the deck 2720 and the support crossbar 132 is located a distance below the deck 2720.

In the second, deployed position, the angle 134 of the legs 130 of the support bars 128 may be, for example, from about 90 degrees to about 110 degrees. As shown in FIG. 3B, the support bars 128 are shown being rotated downward from the first, stowed position to the second, deployed position. FIGS. 3A and 3C show the support bars 128 in the second, deployed position with the third deck panel 2794 and the fourth deck panel 2798 placed onto and supported by the support crossbars 132. As shown in FIG. 3A, in some embodiments, the third deck panel 2794 and the fourth deck panel 2798 may be rotated 90 degrees with respect and oriented so that the extend fore and aft with respect to the wagon chassis 104 and then placed onto the support bars 128. In this orientation, the third deck panel 2794 and the fourth deck panel 2798 can span from one support crossbar 132 to the other support crossbar 132 without falling down. In some embodiments, the third deck panel 2794 and the fourth deck panel 2798 may be releasably coupled to the support bars 128, for example, by a snap-fit connection between the third deck panel 2794 and the fourth deck panel 2798 and the support crossbars 132. As described herein, it will be understood that in some embodiments, the third deck panel 2794 and the fourth deck panel 2798 may be substituted with a single the third deck panel that is the same size and shape as the third deck panel 2794 and the fourth deck panel 2798.

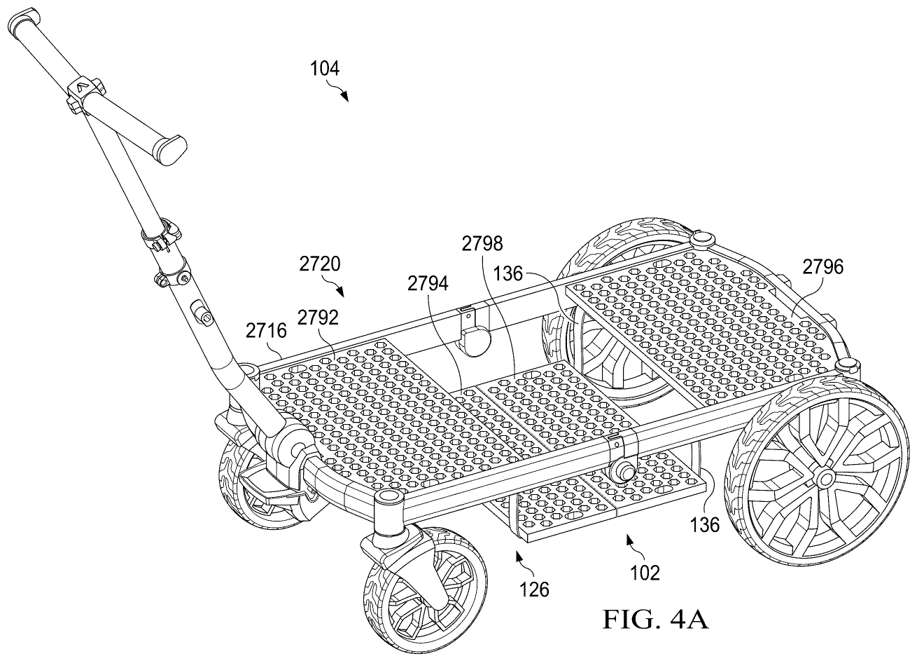

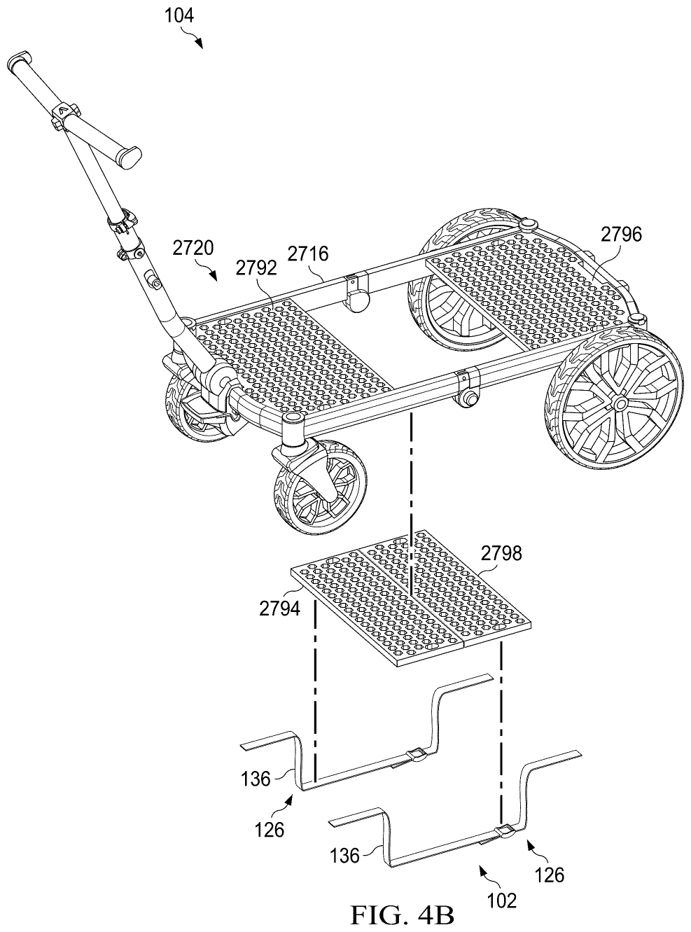

Referring now to FIGS. 4A and 4B, another embodiment of support structures 126 are shown. For example, as shown in FIGS. 4A and 4B, the support structures 126 include a pair of straps 136 that are connected to the wagon chassis 104. In some embodiments, the pair of straps 136 that are connected to the frame 2716. In some embodiments, pair of straps 136 that are connected to the underside of the first deck panel 2792 and the second deck panel 2796. In this embodiment, the third deck panel 2794 and the fourth deck panel 2798 are supported by the pair of straps 136. The third deck panel 2794 and the fourth deck panel 2798 may be fixedly or releasably coupled to the straps 136, for example, by releasable snap buttons, slots in the third deck panel 2794 and the fourth deck panel 2798 through which the straps 136 extend, rivets, screws, bolts, etc. The pair of straps 136 can be loosened in increase their length, or tightened to decrease their length. The pair of straps 136 can be located in a first, stowed position in which the straps 136 are tightened and the third deck panel 2794 and the fourth deck panel 2798 are substantially flush or flush with the top of the deck 2720, such as the first deck panel 2792 and the second deck panel 2796 and in a second, deployed position in which the straps 136 are loosened and the third deck panel 2794 and the fourth deck panel 2798 are located a distance below the deck 2720. FIGS. 4A and 4B show the straps 136 in the second, deployed position with the third deck panel 2794 and the fourth deck panel 2798 supported by the straps 136.

According to at least some embodiments, the removable deck panels, such as for example the third deck panel 2794 and the fourth deck panel 2798, are part of the collapsible footwell feature 102. In particular, the wagon chassis 104 may include the collapsible footwell feature 102 and the removable deck panels, such as for example the third deck panel 2794 and the fourth deck panel 2798, may be configured to transition from a first position, as shown in FIG. 1A, and a second position, as shown in FIGS. 3A, 3C, 4A, and 4B. In the first position, the third deck panel 2794 and the fourth deck panel 2798 are flush with the first deck panel 2792 and the second deck panel 2796. In the second position the third deck panel 2794 and the fourth deck panel 2798 are spaced a distance away from the first deck panel 2792 and the second deck panel 2796 to form the footwell 102. For example, the collapsible footwell feature 102 is extended below the deck 2720. The second position of the collapsible footwell feature 102 may be interchangeably referred to as a use position as a child sitting in a modular wagon bed 106 or on the chassis deck 2720 may extend their legs and feet into the collapsible footwell feature 102 in the user position for more comfort. In some embodiments, in the second position, the third deck panel 2794 and the fourth deck panel 2798 may be moved or slid as shown in FIG. 2C, or removed entirely from the wagon chassis 104.

### Removable Pads

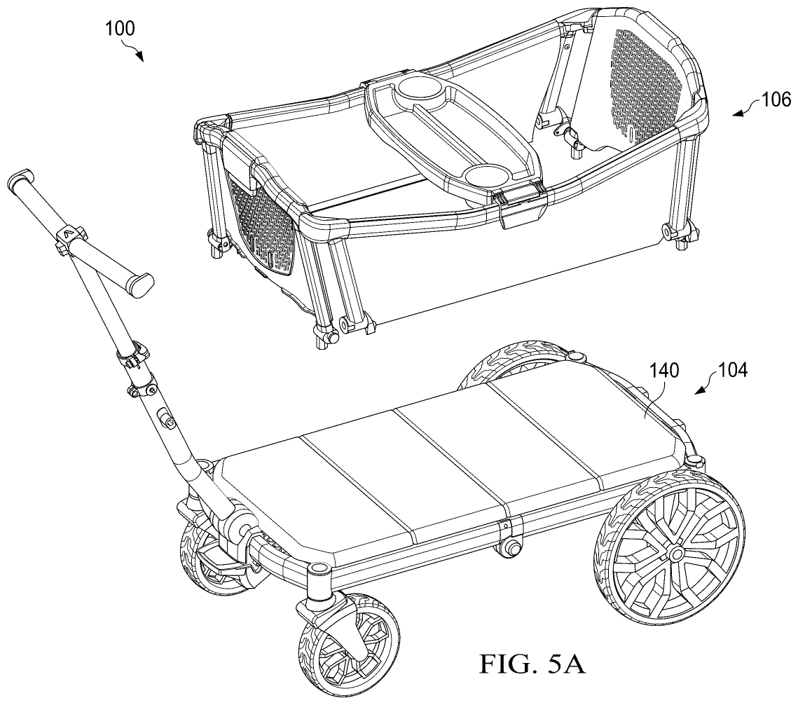

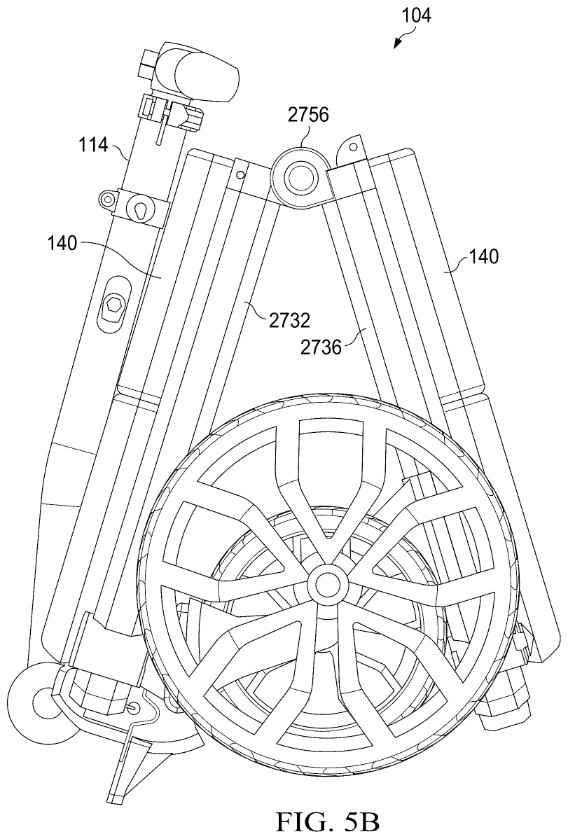

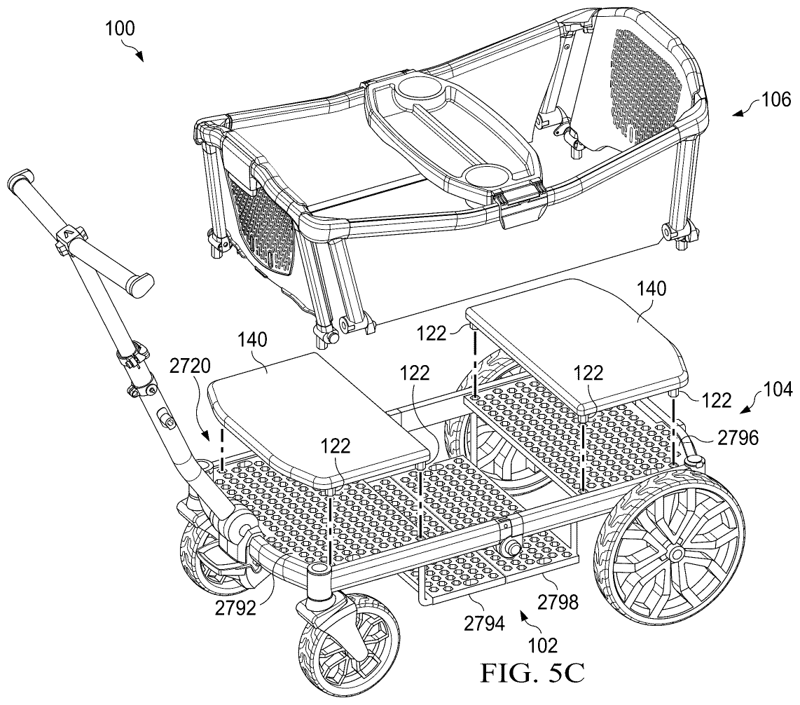

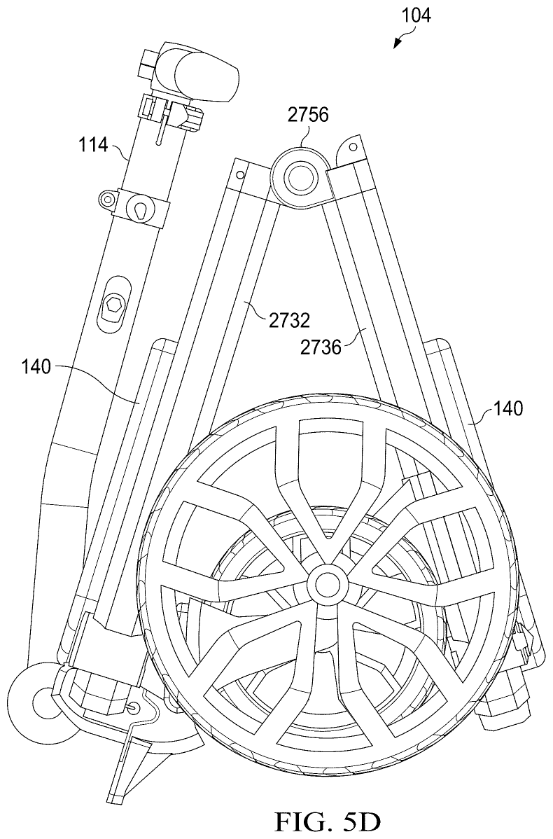

FIGS. 5A-5E illustrate embodiments of an optional accessory, the optional accessory being one or more removable pads 140 that may be used with the wagon chassis 104 and modular wagon bed 106. In these embodiment, the modular wagon bed 106 may be open along its bottom edge such that the deck 2720 forms the bottom of the wagon 100 when the modular wagon bed 106 is assembled to the wagon chassis 104. The removable pads 140 includes one or more pegs 122 that cooperate with the openings 2808 in the deck 2720, as described herein, to couple the removable pad 140 to the wagon chassis 104. As shown in FIGS. 5A and 5B, in some embodiments, the removable pad 140 may be segmented and may be able to fold into a smaller size and/or may be folded while still coupled to the wagon chassis 104 as shown in FIG. 5B. In some embodiments, the removable pad 140 as shown in FIG. 5A is coextensive with the deck 2720. In some embodiments, the removable pad 140 may be smaller than and cover less than the entire surface area of the top of the deck 2720. For example, FIGS. 5C-5E illustrate and embodiment that includes two smaller removable pads 140, each having one or more pegs 122. One of the removable pads 140 is configured to couple to the first deck panel 2792 and the other of the removable pads 140 is configured to couple to the second deck panel 2796. In this embodiment, there is a space between the two removable pads 140 to permit the feet of one or more persons riding in the wagon 100 to rest on the collapsible footwell 102 formed by the lowered third deck panel 2794 and fourth deck panel 2798. The removeable pads 140 shown in FIGS. 5A-5E are cushioned and may provide a comfortable seating surface for persons who may ride in the wagon 100. Also, as shown in FIGS. 5B and 5D, the removable pads 140 may remain coupled to the wagon chassis 104 when the wagon chassis 104 is folded.

### Bag

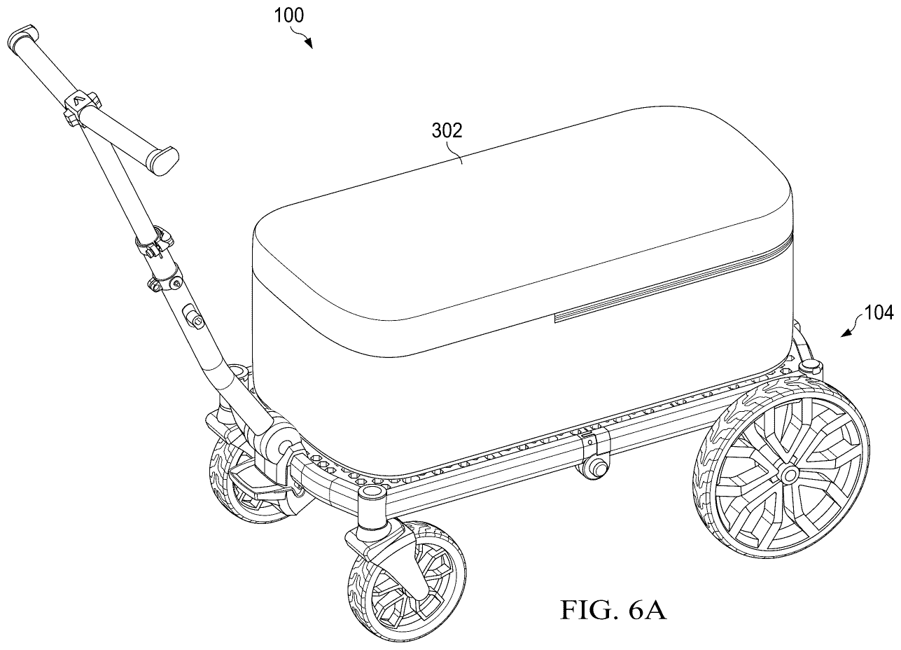

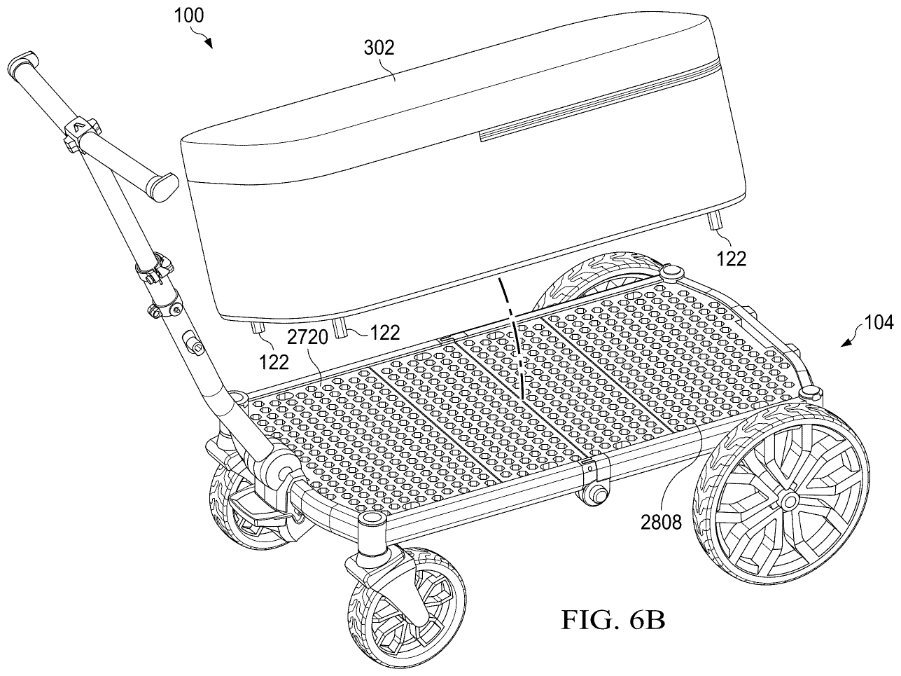

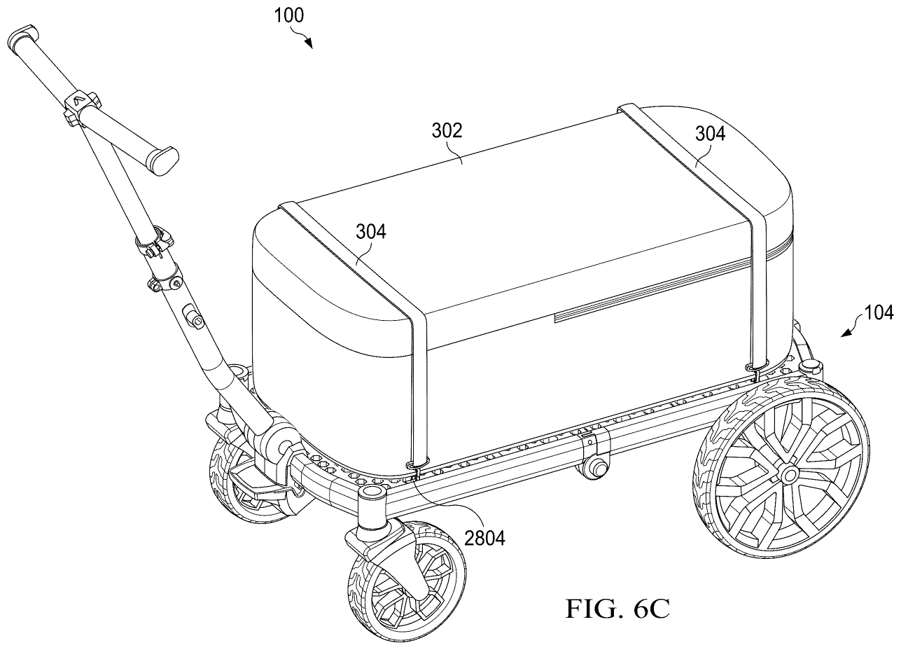

FIGS. 6A-6C show the wagon chassis 104 with an optional accessory, wherein the optional accessory is a bag 302. FIG. 6A shows an embodiment of the bag 302 on the wagon chassis 104 and FIG. 6B shows the bag 302 above the wagon chassis 104. As shown in FIG. 6B, embodiments of the bag 302 include pegs 122 to aid in securing the bag 302 to the wagon chassis 104. The pegs 122 on the bag are the same type of pegs 122 that are on the modular wagon bed 106. In some embodiments, the bag 302 has a rigid bottom and/or the pegs 122 are rigidly connected to one another. In these embodiments, and where the wagon chassis 104 is foldable, the rigid bottom of the bag 302 or the rigid connection between the pegs 122 can keep the wagon chassis 104 in the unfolded position even if the wagon chassis 104 lacks a lock mechanism or device to keep the wagon chassis 104 in the unfolded position. As such, in these embodiments, the wagon chassis 104 can be easily folded without unlocking a lock mechanism or device by removing the bag 302 from the wagon chassis 104 and simply folding the wagon chassis 104.

As shown in FIG. 6C, according to various embodiments, the wagon chassis 104 may include various removable or integrated securing elements 304 such as straps, bungees, buttons, clasps, ratchets, belts, or the like for securing an optional accessory, such as for example the bag 302, to the wagon chassis 104 during transportation or storage. For example, the securing elements 304 may have a clip that is configured to clip onto the tie downs 2804 in the deck 2720 of the wagon chassis 104 (see FIGS. 1A, 1B). In another example, a rectangular ring may be mounted to the wagon chassis for supporting a cooler or other smaller containers. In other embodiments, an adapter (not shown) may be removably coupled to the wagon chassis 104 that may be removably coupled to an optional accessory with similar securing elements 304. In other embodiments, any securing elements 304 or adapters may be snug fit to the optional accessory for securing the optional accessory to the wagon chassis 104 and vice versa.

### Child Seat Adapters

FIGS. 7A-7C illustrate exemplary optional additional components that may be used with the wagon chassis 104, including exemplary adapters 502 for use with the wagon chassis 104 to couple accessories 504 to the wagon chassis 104. FIG. 7A illustrates a wagon chassis 104 having a seat adapter 502 for removably coupling a child seat 504 to the wagon chassis 104. Various embodiments of a seat adapter 502 for a child seat 504 as discussed in U.S. Pat. No. 9,469,324 filed Jun. 25, 2015, U.S. Pat. No. 10,077,062 filed Oct. 3, 2016, U.S. Pat. No. 10,597,058 filed Sep. 17, 2018, U.S. Pat. No. 11,214,291 filed Feb. 19, 2020, and U.S. Pat. No. 11,787,460 filed Oct. 5, 2021, the entirety of which are hereby incorporated by reference.

One or more seat adapters 502 may be removably coupled to the wagon chassis 104 for coupling one or more corresponding child seats 504 as would be appreciated by one having ordinary skill in the art. As shown in FIGS. 7A and 7C, the seat adapters 502 include a bottom end having pegs 122 extending therefrom, that cooperate with the openings 2808 in the deck 2720, as described herein, to couple the seat adapters 502 to the wagon chassis 104. As shown in FIG. 7B, the seat adapters 502 do not include the pegs 122, but include two latch components 506 that removably mount the seat adapters 502 to the frame 2716 of the wagon chassis 2716. The latch components 506 shown in FIG. 7B may clamp to the frame 2716 of the wagon chassis 104.

The adapters 502 further include seat latch components 508 that removably attach the seat adapters 502 to corresponding latch components 510 of the child seat 504. The seat latch components 508 are manipulable between locked and unlocked positions, with the latches secured to the child seat 504 in the locked position (depicted) and released for detachment from the child seat 504 in the unlocked position. One or more actuators 512 are operable to manipulate the latch components 510 between the locked and unlocked positions. In the depicted embodiment, the child-seat latch components 510 are of a conventional design determined by the child seat manufacturer, and the seat-adapter latch components 508 are of a conventional design selected for mating with the child-seat latch components (and thus typically conform to the design of the mating latch of the product the child seat is designed to be mounted to and used with). In other embodiments, the latch components are reversed with the actuator on the child seat and the adapter/seat latch component being passive. Details of such child seat latch components (e.g., catch-pins), and designs of mating latch components (e.g., pivotable hooks) and their actuators (e.g., spring-biased pushbuttons), are well-known in the art and thus not repeated for brevity's sake.

As shown in FIG. 7B, the seat adapters 502 do not include the pegs 122, but include two latch components 506 that removably mount the seat adapters 502 to the frame 2716 of the wagon chassis 2716

In various embodiments, the seat adapters 502 may be coupled to the wagon chassis 104 such that the child seats 504 face each other as shown in FIG. 7C. In other embodiments, the adapters 502 may be coupled to the wagon chassis 104 such that the child seats 504 face the same way (e.g., toward the handle 114 or away from the handle 114 as shown in FIGS. 7A and 7B) or facing opposing directions as described by the user. Any space created between the one or more child seats 504 may be used for additional storage according to various embodiments. Again, as shown in FIG. 7C for example, any of the foregoing embodiments may be used with the collapsible footwell feature 102 in either the first position or the second position as previously described.

### Alternative Handles

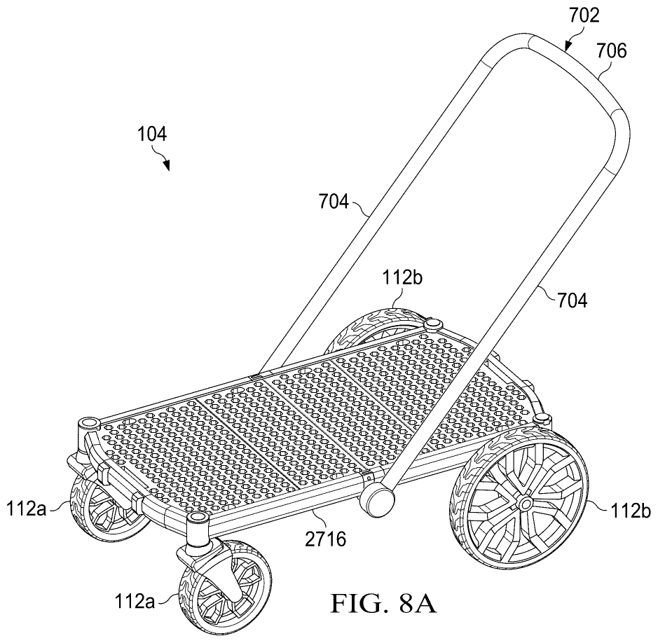

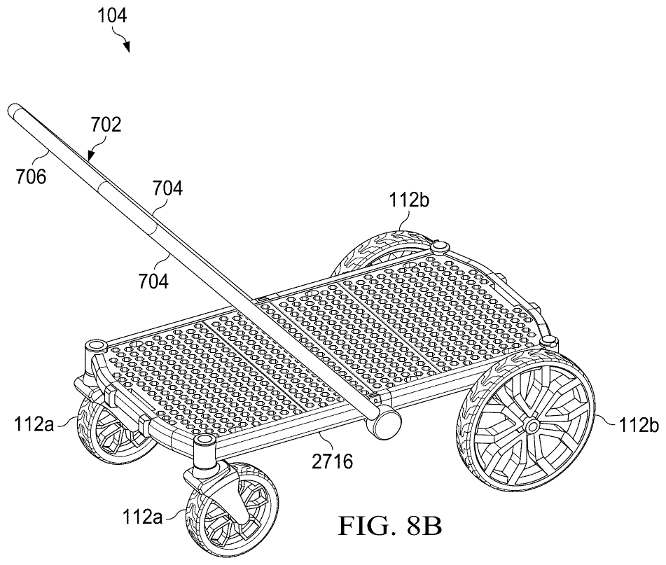

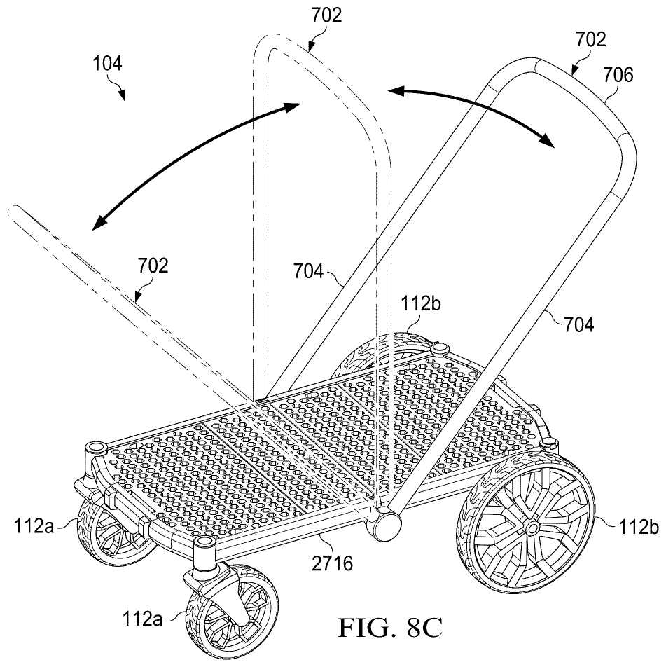

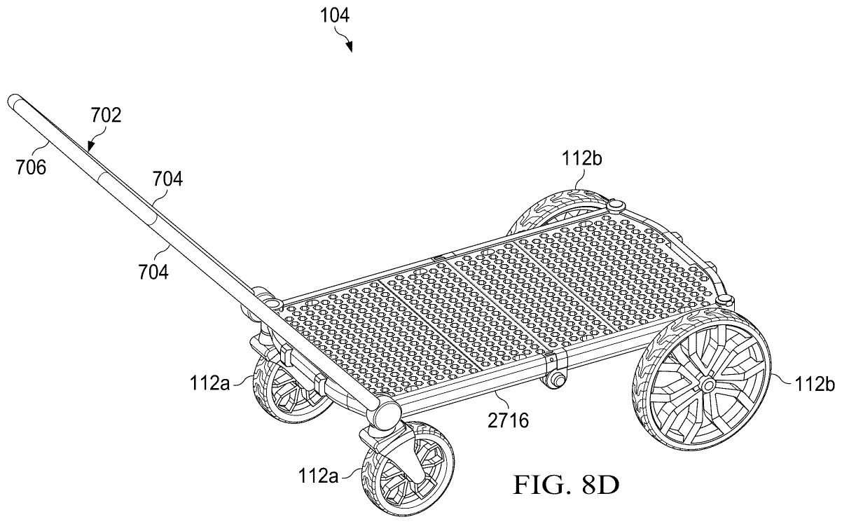

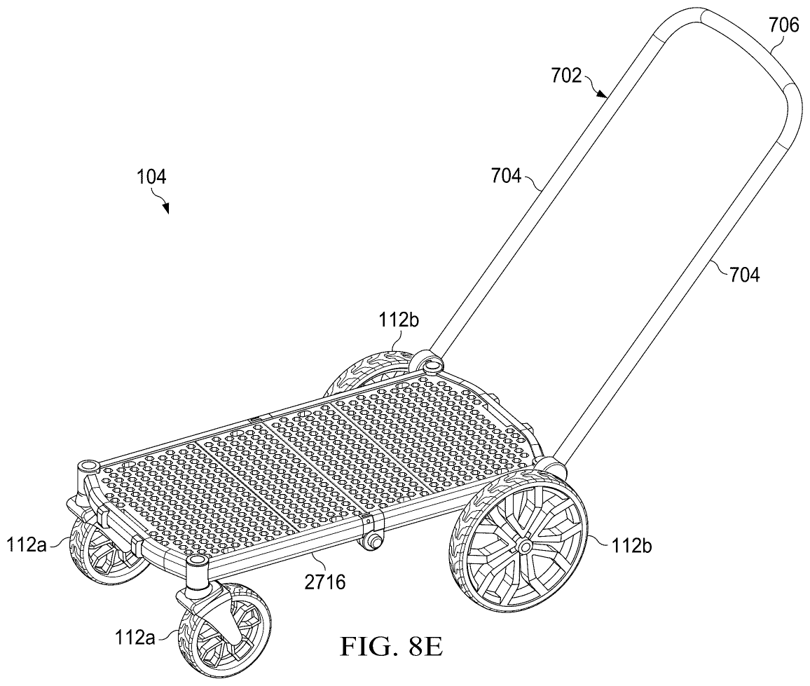

FIGS. 8A-8E show a wagon chassis 104 with an alternative couplable pivotable handle 702. According to other embodiments, the wagon chassis 104 may include a removably couplable pivotable handle 702. As shown in FIGS. 8A-8C, the handle 702 may be a substantially U-shaped handle 702 with two legs 704 connected by a crossbar 706 extending between the two legs 704. The two legs 704 are pivotably connected to the wagon chassis 104. The handle 702 may pivot from a first position at one end of the wagon chassis 104 (e.g., an end proximate to the relatively larger wheels 112b (as shown in FIG. 7A) for making it easier for a user to push the wagon chassis 104) to second position at the opposing end of the wagon chassis (e.g., at an end proximate to the relatively smaller wheels 112a (as shown in FIG. 7C) for making it easier for a user to pull the wagon chassis 104). The handle 702 may be pivoted to and retained in one or more intermediate positions as shown in FIG. 7B. The handle 702 may be removably couplable to the wagon chassis 104 and may be position-locking according to any of the embodiments as described herein.

Now with reference to FIGS. 8D-8E, the handle 702 may be pivotably and removably coupled to the wagon chassis 104 for placement at either end of the wagon chassis 104. For example, the handle 702 may be placed on an end proximate to relatively larger wheels 112b (as shown in FIG. 8E) for making it easier for a user to push the wagon chassis 104 or the handle 702 may be placed on an end proximate to relatively smaller wheels 112a (as shown in FIG. 8D) for making it easier for a user to pull the wagon chassis 104. The handle 702 may be a position-locking handle feature. On a typical wagon the handle is free to rotate about its axis until its movement is limited by the wagon geometry or the ground. But on the wagon chassis 104 of the present disclosure, the handle 702 locks in one or more positions. Locking handle design options include automatic lock or only when intentioned by the user. Additionally, in some embodiments, the handle 702 is sized and shaped such that the handle 702 can be folded flat for storage. In such embodiments, the legs 704 are of sufficient length and the crossbar 706 is of sufficient width to permit the handle 702 to encircle three sides of the frame 2716 of the wagon chassis 104 when the handle 702 is folded flat. Stated another way, when the handle 702 is coupled to an end of the wagon chassis 104, the handle 702 is sized to be around at least a portion of the perimeter of the frame 2716 of the wagon chassis 104 when the handle 702 is folded toward the frame 2716.

Wagon Chassis with Center Support

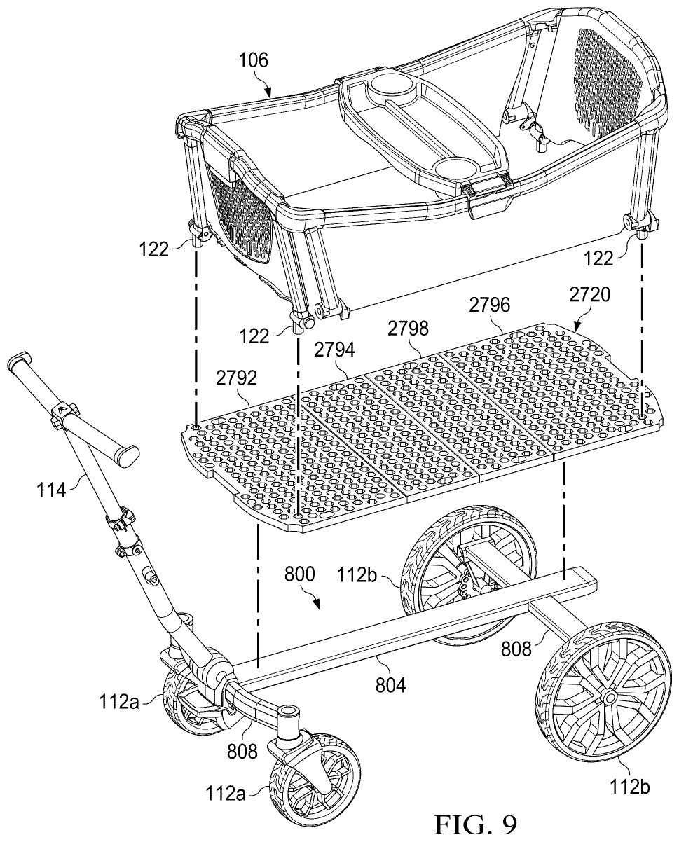

FIG. 9 shows another embodiment of a wagon chassis 800. According to this embodiment, the wagon chassis 800 includes a handle 114 coupled to a center support 804 supported by one a first pair of wheels 112a and a second pair of wheels 112b. The wheels 112a, 112b may each be coupled to frame cross members 808 extending from the center support 804. In some embodiments, the frame cross members 808 may include a spring or other dampening element to reduce any bounce experienced by optional accessories coupled to the center support 804 during transport. The wheels 112a, 112b may include any configuration (e.g., diameter, width, size, etc.) as described above with respect to other figures for traversing a variety of terrains. The wagon chassis 800 further includes the deck 2720, which may be coupled to the center support 804. In some embodiments, the deck 2720 is removably coupled to the center support 804. As described herein, the deck 2720 includes one or more of the first deck panel 2792, second deck panel 2796, third deck panel 2794, and fourth deck panel 2798. The modular wagon bed 106 may be coupled to the wagon chassis 800 by inserting the pegs 122 of the modular wagon bed 106 into the openings 2808 of the deck 2720.

### Retractable Cargo Deck

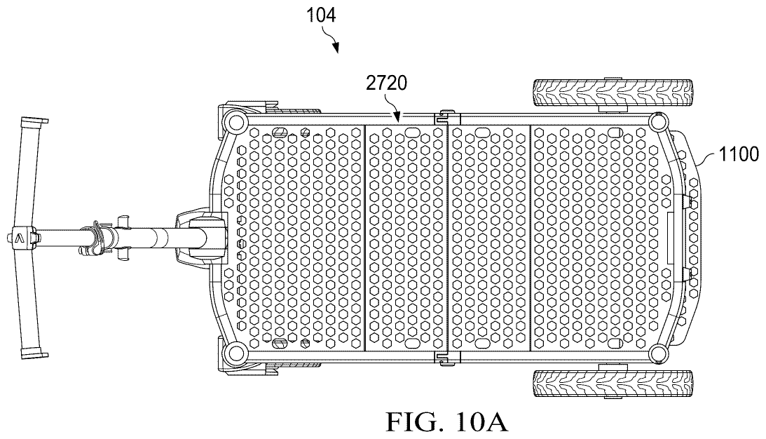

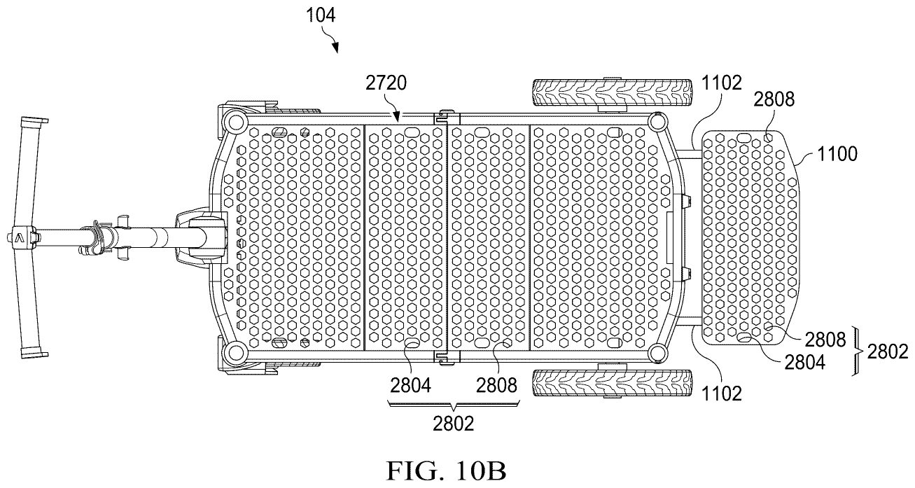

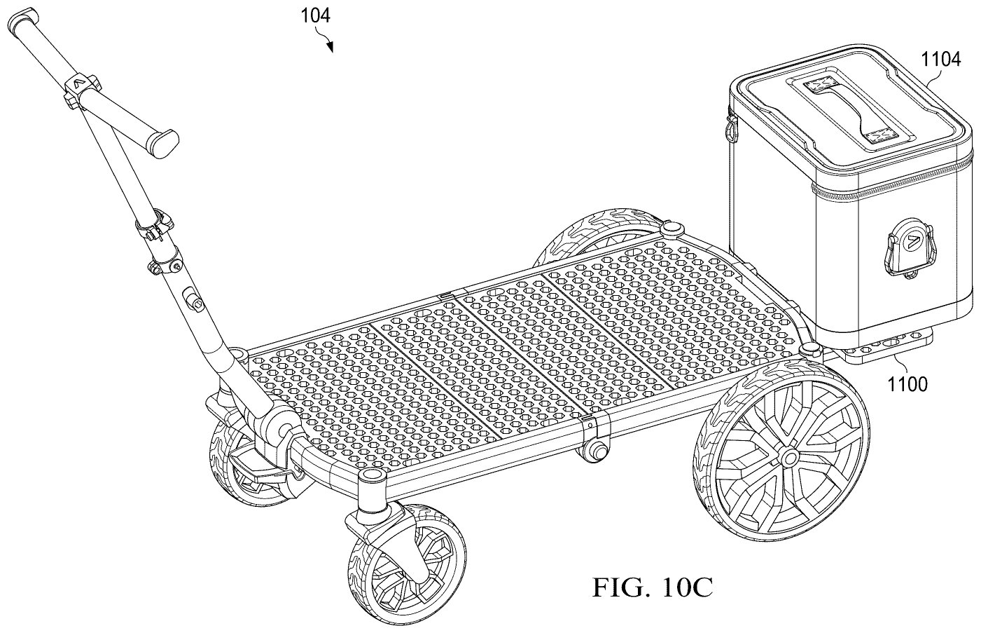

FIGS. 10A-10C illustrate an embodiment of the wagon chassis 104 that includes a retractable cargo deck 1100. The retractable cargo deck 1100 may transition between a first, storage position as shown in FIG. 10A and a second, extended position as shown in FIGS. 10B and 10C. In various embodiments, the retractable cargo deck 1100 may be slidable or foldable under the wagon chassis 104. For example, the retractable cargo deck 1100 may be connected to the wagon chassis 104 via slidable or telescoping rails 1102. In some embodiments, the retractable cargo deck 1100 also includes attachment features 2802, such as tie downs 2804 and openings 2808, as on deck 2720. In some embodiments, the retractable cargo deck 1110 does not include any attachment features 2802, such as tie downs 2804 and openings 2808. As shown in FIG. 10C, an optional accessory, such as for example a cooler 1104, may be placed on an carried by the retractable cargo deck 1100.

### Adapters

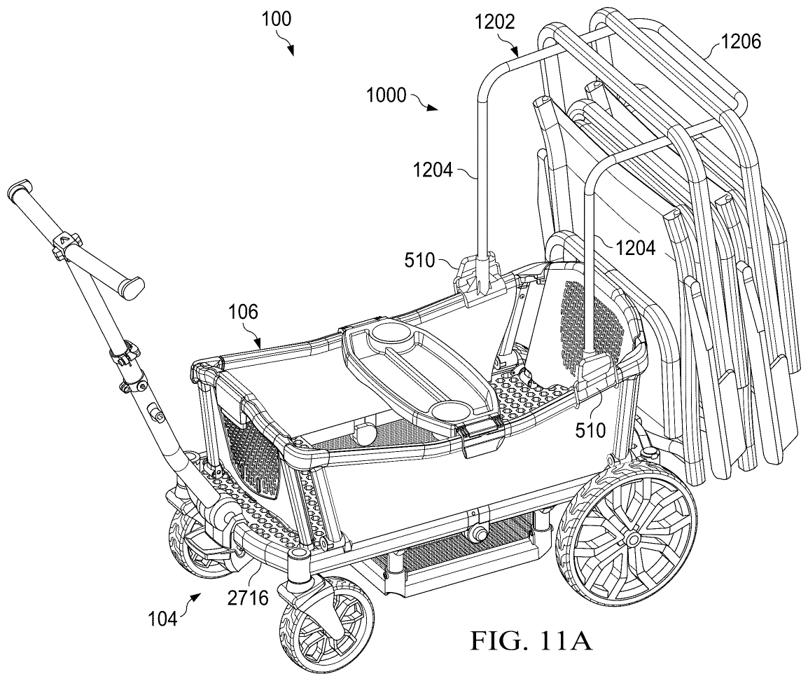

FIGS. 11A-11B illustrate an exemplary adapter. Exemplary adapter 1200 may be a rack for sliding an accessory or a portion of an accessory, such as folded beach chairs or the like, over. For example, an adapter 1200 incorporating a rack may be used to carry chairs, boogie boards, sports equipment, skateboards, or the like. The adapter 1200 shown in FIGS. 11A-11B, for example, is a rack 1202 that is U-shaped having a proximal end and a distal end, with the distal end angled at 90 degrees with respect to the proximal end. Namely, the rack 1202 includes a two legs 1204 connected by a crossbar 1206 extending between the two legs 1204. The two legs 1204 have a 90 degree bend in them to provide a portion of the legs 1204 that are substantially parallel or parallel to the frame 2716 of the wagon chassis 104. Additionally, as shown in FIGS. 11A-11B, each of the two legs 1204 includes a wagon latch component 510, as described with respect to FIG. 7B. Although FIGS. 11A-11B illustrate the adapter 1200 being coupled to the modular wagon bed 106, the adapter 1200 may be similarly removably coupled to the wagon chassis 104. Any adapter described herein may be removably coupled to any wall or end of the modular wagon bed 106 or the wagon chassis 104.

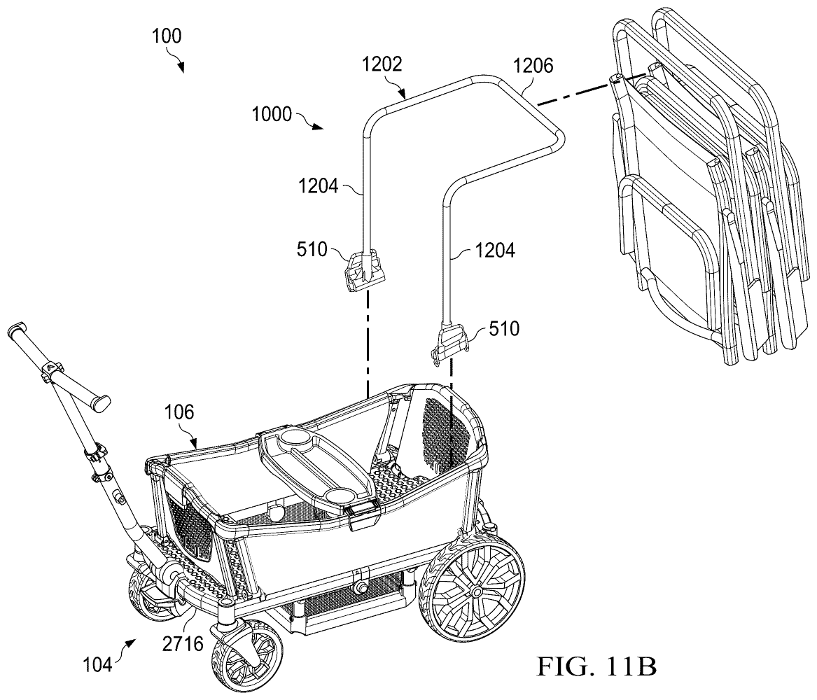

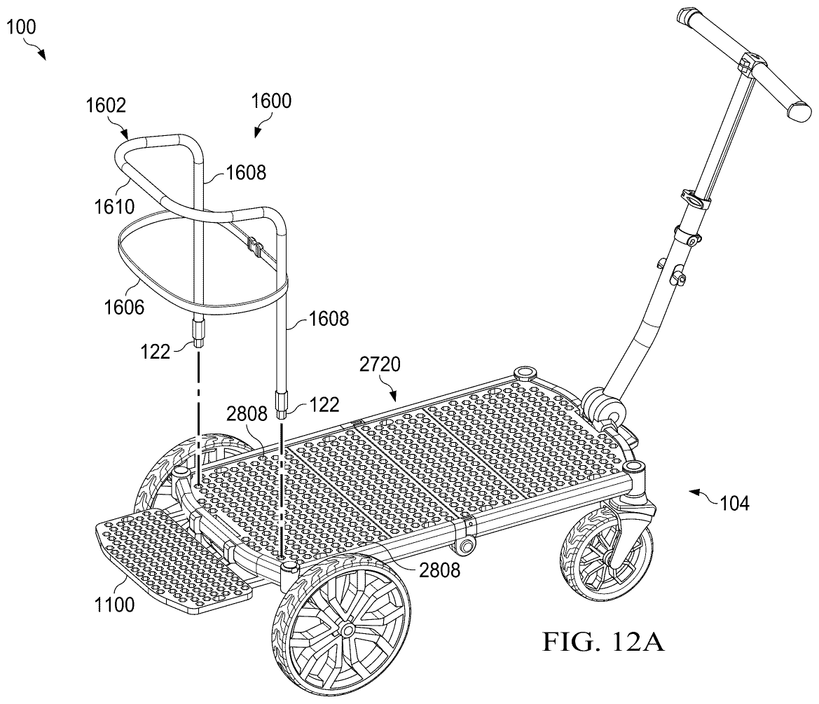

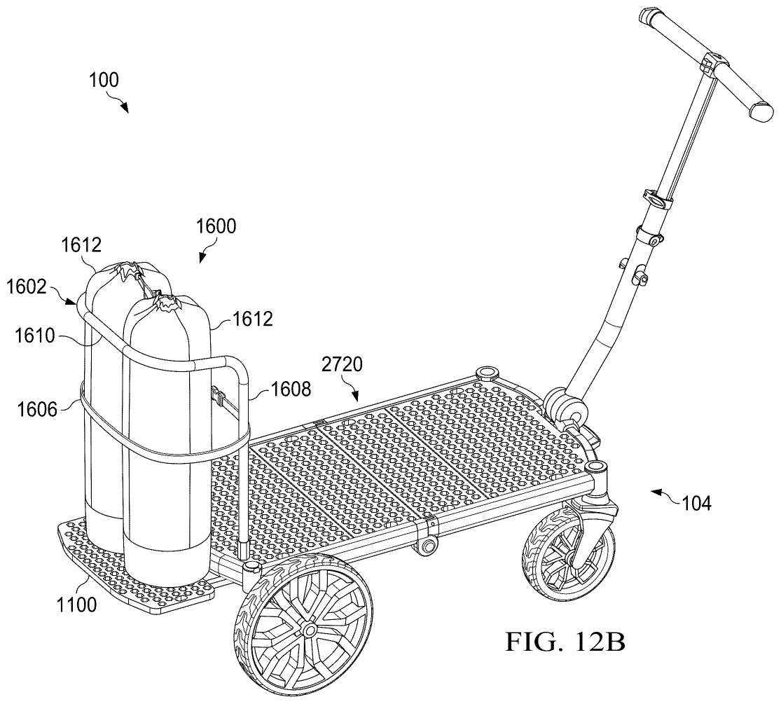

FIGS. 12A-12B illustrate another exemplary optional adapter 1600 that may be coupled to the wagon chassis 104. For example, the adapter 1600 shown in FIGS. 12A-12B includes a frame 1602 and one or more straps 1606. The frame 1602 is substantially U-shaped with two upright legs 1608 connected by a top bar 1610 extending between the two legs 1608. Each of the two upright legs 1608 includes a peg 122, which cooperate with the openings 2808 of the deck 2720 of the wagon chassis 104 to connect the adapter 1600 to the wagon chassis 104. Thus, the adapter 1600 may be coupled to the wagon chassis 104 by inserting the pegs 122 of the adapter 1600 into the openings 2808 of the deck 2720. The top bar 1610 may be at an angle with respect to the upright legs 1608. The top bar 1610 may be used as a handle in some configurations. As shown in FIG. 12B, the adapter 1600 is shown coupled to the wagon chassis 104 along with two optional accessories coupled to the adapter 1600. The optional accessories may be for example, foldable sports chairs, foldable tables, a tent in a bag, etc. The optional accessories are shown resting on the optional retractable cargo deck 1100 and may be secured to the frame 1602 by the one or more straps 1606.

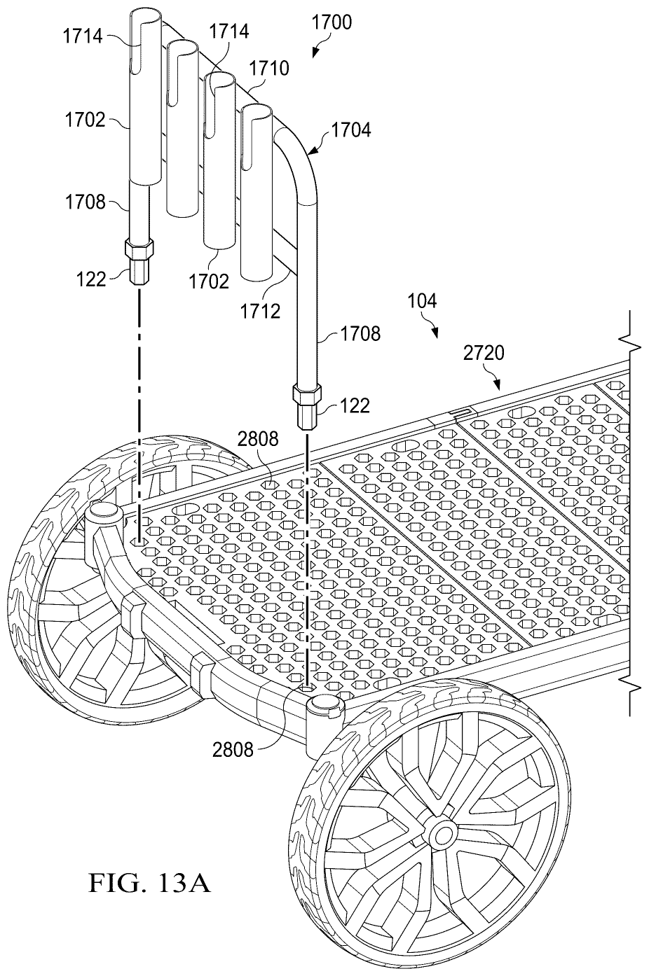

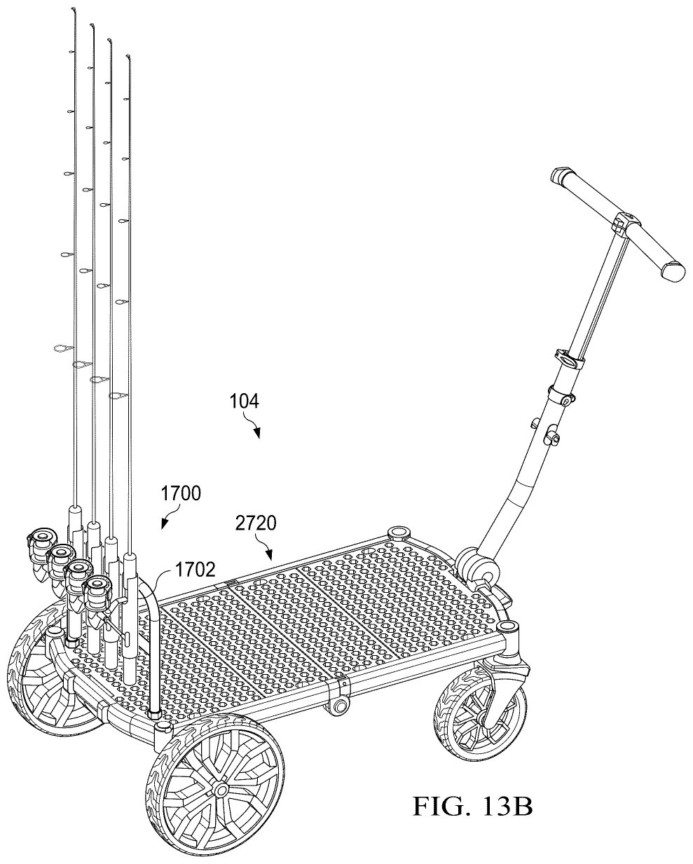

FIGS. 13A and 13B illustrate another exemplary adapter 1700 that may be coupled to the wagon chassis 104. For example, adapter 1700 is a fishing pole adapter. Adapter 1700 includes one or more tube members 1702 coupled to a frame 1704. The frame 1704 is substantially U-shaped with two upright legs 1708 connected by a first cross bar 1710 extending between the two legs 1708. The frame 1704 may also include a second cross bar 1712. Each of the two upright legs 1708 includes a peg 122, which cooperate with the openings 2808 of the deck 2720 of the wagon chassis 104 to connect the adapter 1700 to the wagon chassis 104. Thus, the adapter 1700 may be coupled to the wagon chassis 104 by inserting the pegs 122 of the adapter 1700 into the openings 2808 of the deck 2720. The tube members 1702 are coupled to first cross bar 1710 and the second cross bar 1712, where provided. The one or more tube members 1702 are configured to receive a fishing pole, a spear, a golf club, or any other long and narrow item. In other embodiments, the diameter of the tube member 1702 may be greater to accommodate thicker items such as baseball bats, tennis rackets, liquid containers, etc. In some embodiments, the tube members 1702 include slots 1714 that are sized and/or shaped to receive within the slots 1714, for example, the reel of a fishing rod. In at least some embodiments, the adapter 1700 may include a variety of sizes (e.g., diameter and/or length) of tube members 1702. In further embodiments, the tube members 1702 may be interchangeable such that a user may select the size of the tube member 1702 according to their intended use for the day (e.g., baseball practice versus a fishing day).

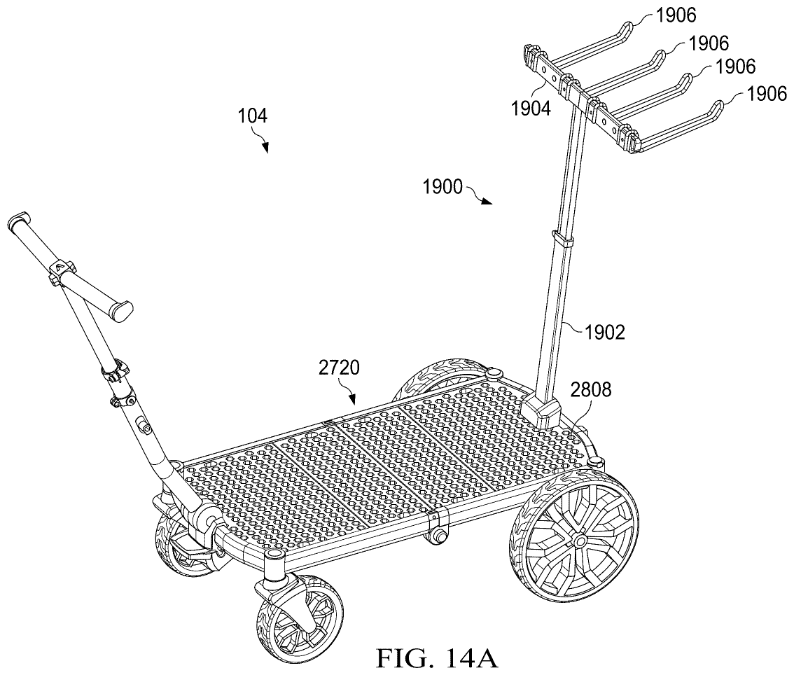

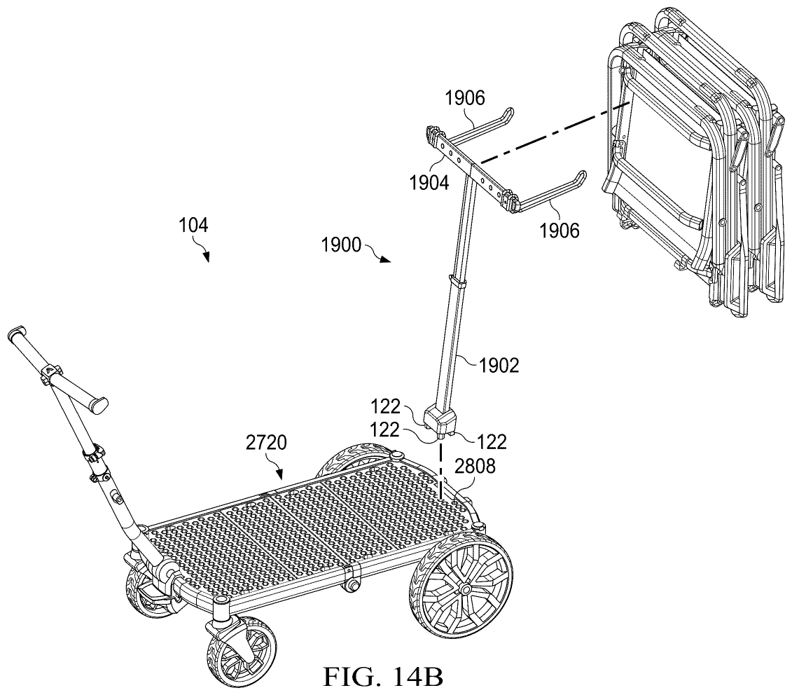

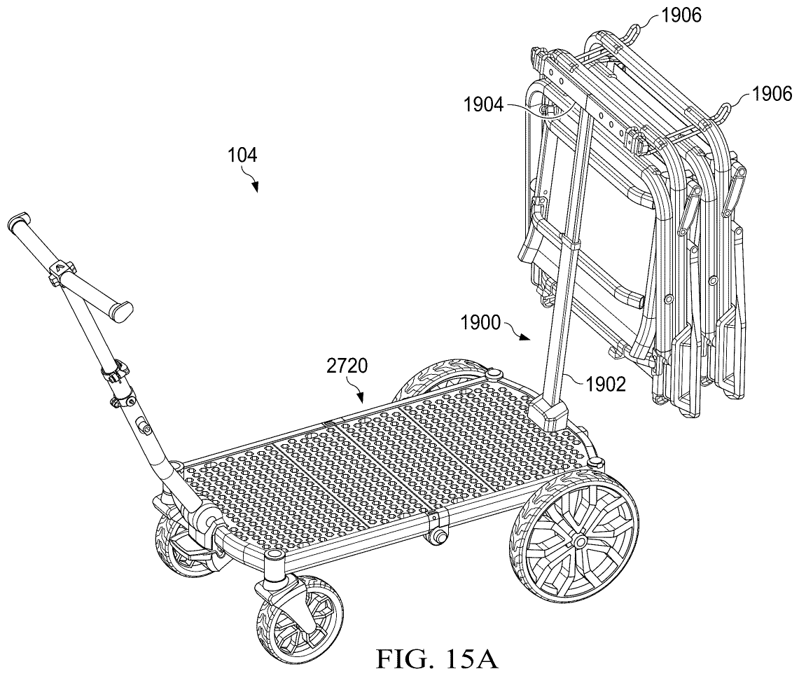

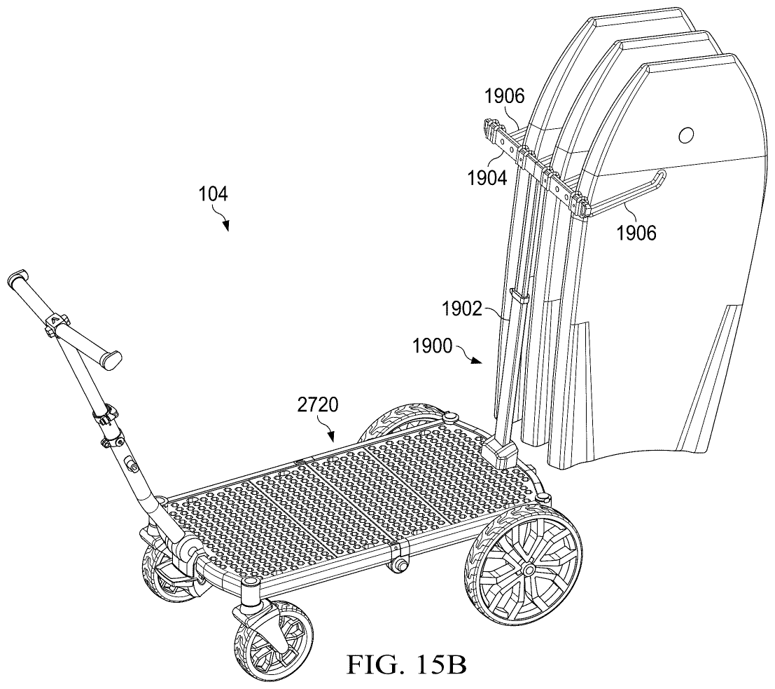

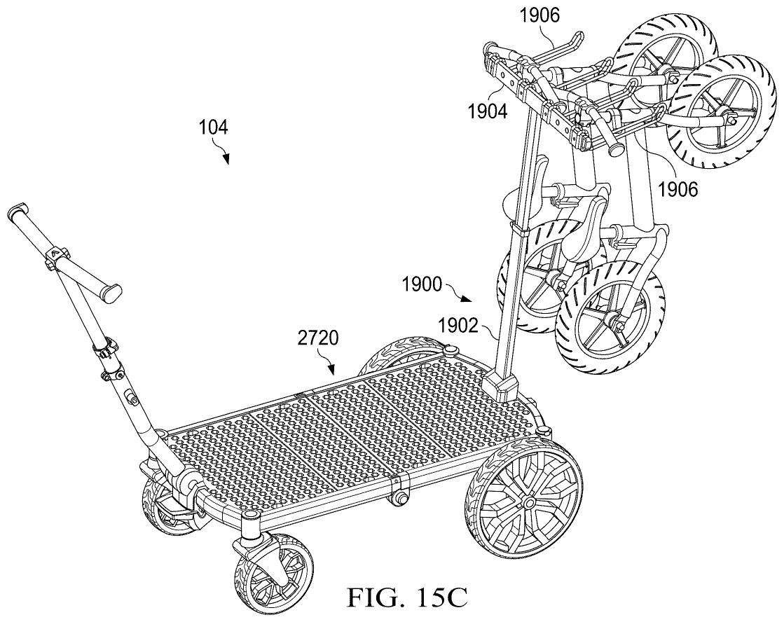

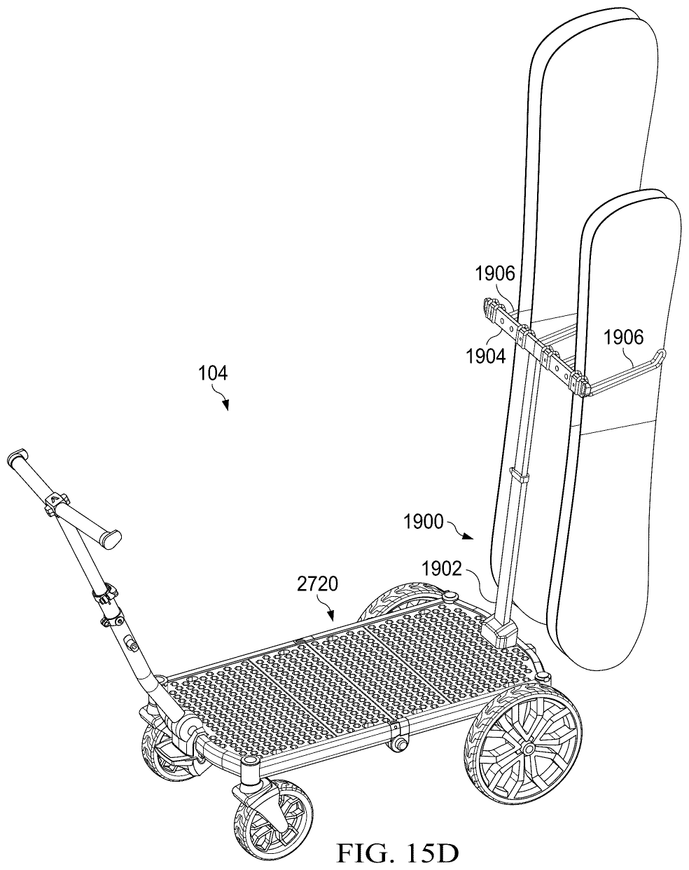

FIGS. 14A, 14B, and 15A-15D illustrate another exemplary adapter 1900 that may be coupled with the wagon chassis 104. For example, adapter 1900 may be another rack configuration suitable for transporting accessories such as chairs (such as shown in FIGS. 14B and 15A), bikes (such as shown in FIG. 15C), snowboards (such as shown in FIG. 15D), boogie boards (such as shown in FIG. 15B), etc. One or more accessories may be used with the adapter 1900 which may be the same type or a variety of accessories. The adapter 1900 includes a generally upright leg 1902, a cross bar 1904 coupled to the top of the leg 1902, and one or more arms 1906 extending from the cross bar 1904. The terminal ends of the arms 1906 may be bent slightly to aid in retaining any accessories that are used with the adapter 1900. The upright leg 1902 and the cross bar 1904 form a generally T-shaped frame. The adapter 1900 further includes pegs 122 (as shown in FIG. 14B), which cooperate with the openings 2808 of the deck 2720 of the wagon chassis 104 to connect the adapter 1900 to the wagon chassis 104. Thus, the adapter 1900 may be coupled to the wagon chassis 104 by inserting the pegs 122 of the adapter 1900 into the openings 2808 of the deck 2720. When the adapter 1900 is coupled to the wagon chassis 104, the arms 1906 may be generally parallel to the deck 2720 of the wagon chassis 104. In some embodiments, the leg 1902 is a telescopic leg that can be extended or retracted, which may aid in carrying accessories of different lengths and/or aids in storing the adapter 1900 when not in use.

The arms 1906 may be removable from the adapter 1900 and the number of arms 1906 coupled to the cross bar 1904 can be increased or decreased depending on the accessories 1000 that a user desires to carry. Additionally, the spacing between each of the arms 1906 may be increased or decreased depending on the accessories 1000 that a user desires to carry. For example, FIG. 14B illustrates the adapter 1900 with two arms 1906 and FIGS. 14A and 15A-15D illustrate the adapter 1900 with four arms 1906.

### Removable and Relocatable Wheels

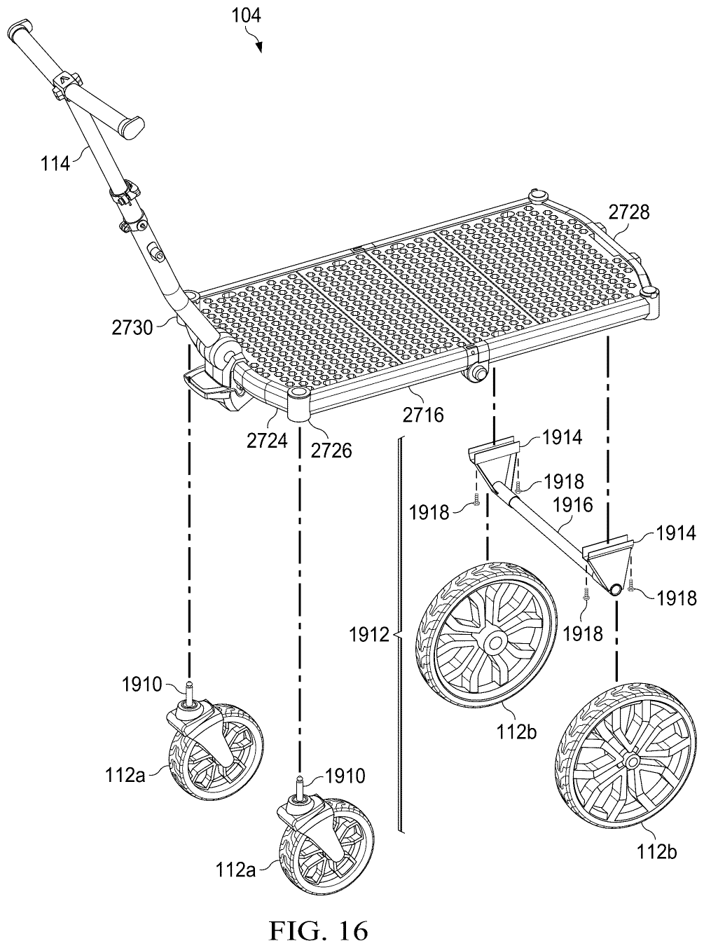

Referring again to FIG. 1A and FIGS. 16, 17A, and 17B, in some embodiments, the location of the wheels 112a and 112b on the wagon chassis 104 can be changed. In FIG. 1A, the swivel wheels 112a are shown coupled to the first swivel wheel housing 2726 and the second swivel wheel housing 2730 proximate to the handle 114 and the wheels 112b are shown coupled to the frame 2716 proximate to the second frame member 2728. In this configuration, the swivel wheels 112a may be considered at the front of the wagon chassis 104 and the wheels 112b may be considered at the rear of the wagon chassis 104. Additionally, in this configuration, the wagon chassis 104 may be pulled like a traditional wagon.

As shown in FIG. 16, the swivel wheels 112a include stems 1910. The stems 1910 of the swivel wheels 112a may be removed from the sockets of the first swivel wheel housing 2726 and the second swivel wheel housing 2730 and the wheels 112b may be removed from the frame 2716. In some embodiments, the wheels 112b are a part of a wheel assembly 1912 that includes a pair of wheel mounts 1914 and an axle 1916 coupled to and extending between the wheel mounts 1914. The wheels 112b are rotatably coupled to the axle 1916, which is fixedly coupled to the wheel mounts 1914. In some embodiments, the wheels 112b are fixedly coupled to the axle 1916 and the axle 1916 is rotatably coupled to the wheel mounts 1914. The wheel assembly 1912 is coupled to the frame 2716 of the wagon chassis 104, for example, by two threaded fasteners 1918 extending through each of the wheel mounts 1914 and into corresponding threaded holes in the frame 2716.

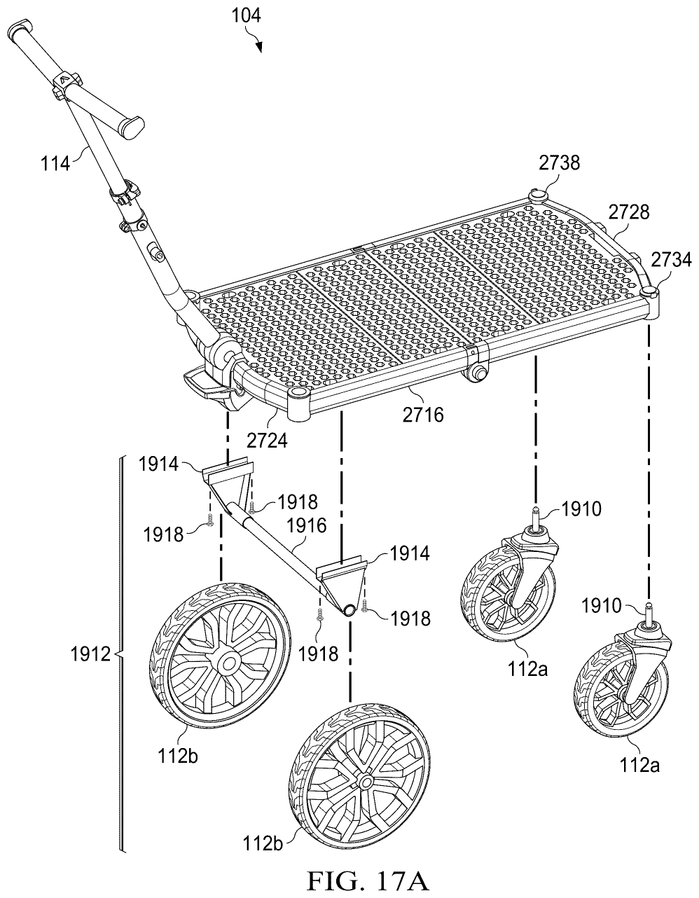

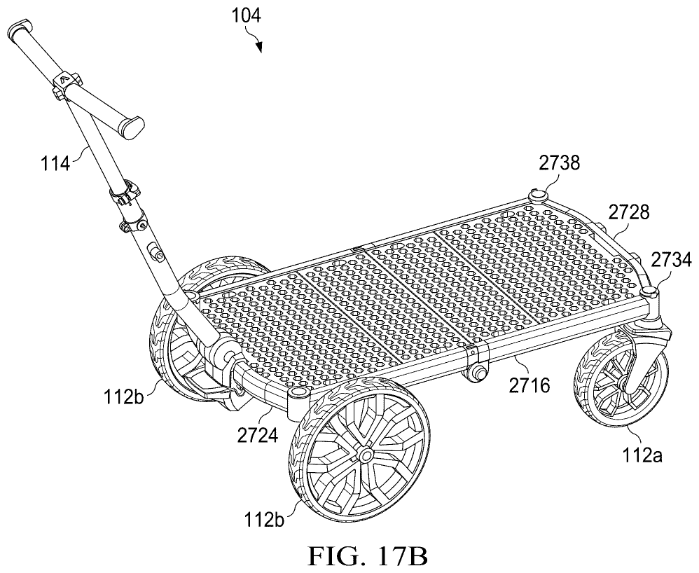

As shown in FIGS. 17A and 17B, the location of the wheels 112a and the wheels 112b is swapped with respect to the location shown in FIGS. 1A and 16. In FIG. 17A, the wheels 112b are shown coupled to the frame proximate to the handle 114 and the swivel wheels 112a are shown coupled to the third swivel wheel housing 2734 and the fourth swivel wheel housing 2738 proximate to the second frame member 2728. For example, the stems 1910 of the swivel wheels 112a are in the sockets of the third swivel wheel housing 2734 and the fourth swivel wheel housing 2738 and the wheel assembly 1912 is coupled to the frame 2716 of the wagon chassis 104, for example, by two threaded fasteners 1918 extending through each of the wheel mounts 1914 and into corresponding threaded holes in the frame 2716 proximate to the first frame member 2724. In this configuration, the wagon chassis 104 may be pushed, for example, like a stroller.

### Additional Embodiment of Wagon Chassis

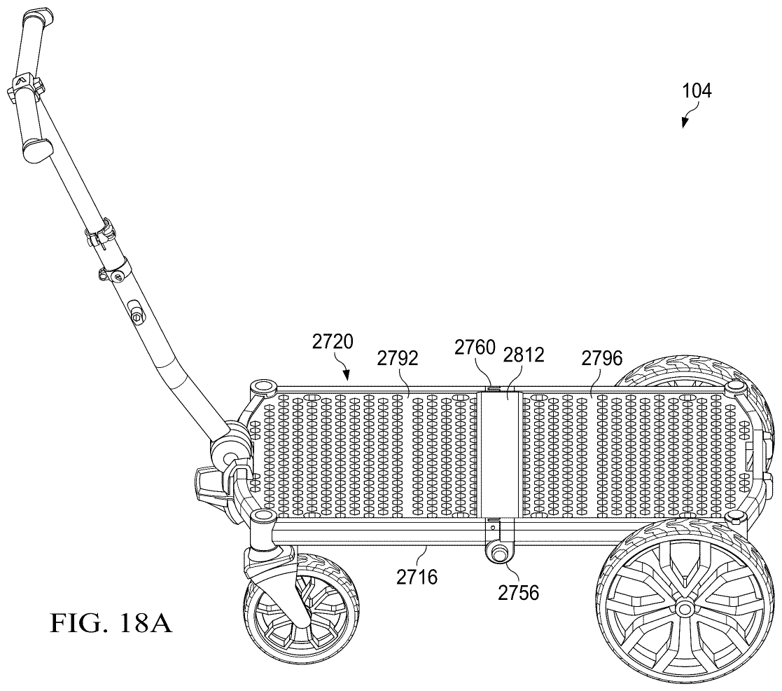

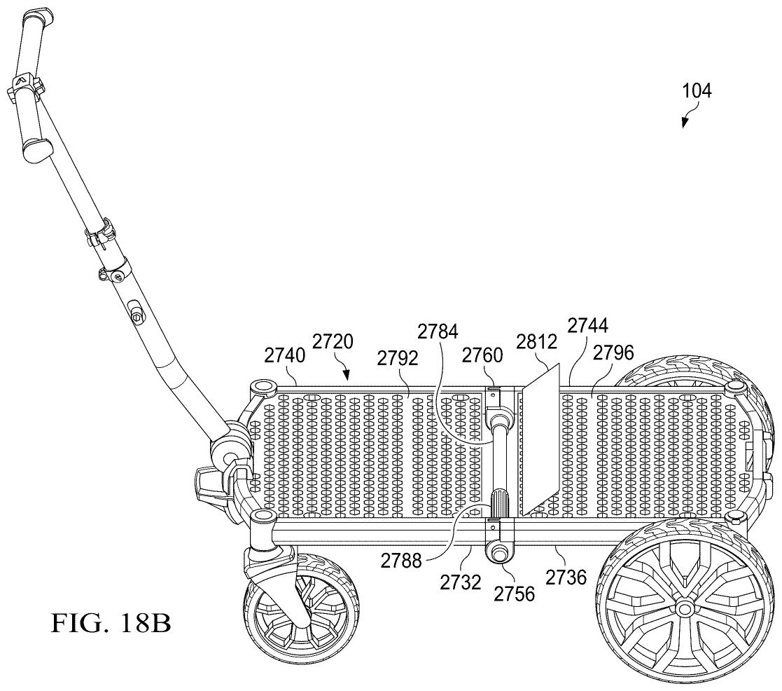

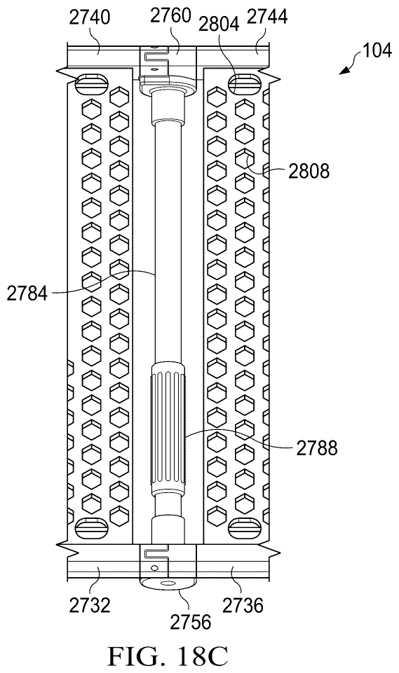

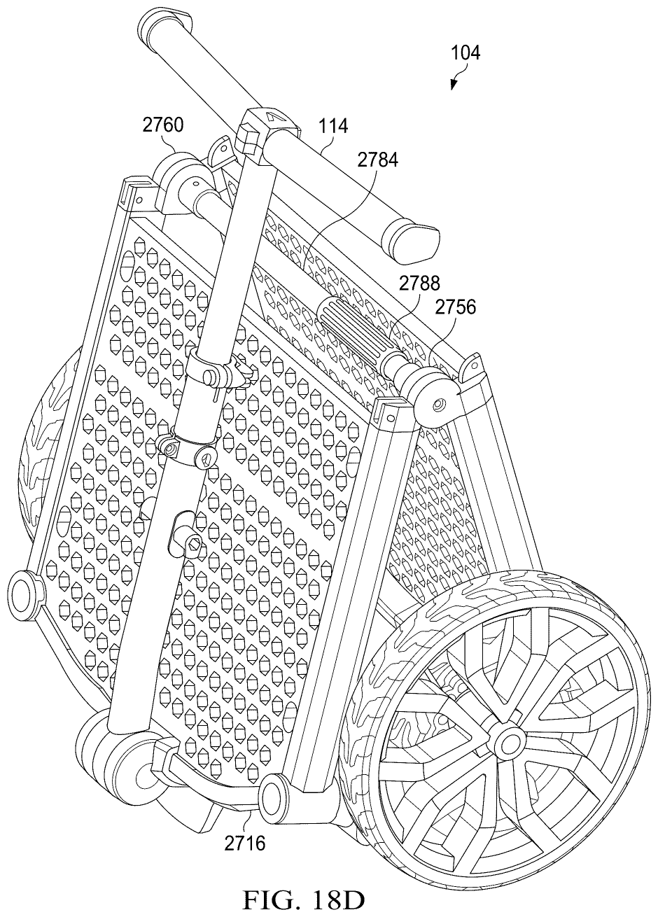

Referring now to FIGS. 18A-18D, another exemplary embodiment of the wagon chassis 104 is shown. As shown in FIGS. 18B-18C, in some embodiments, the frame 2716 of the wagon chassis 104 further includes a cross member 2784 that is coupled to and extends from the first hinge 2756 to the second hinge 2760. The cross member 2784 provides structural strength and/or rigidity to the wagon chassis 104. In some embodiments, the wagon chassis 104 additionally or alternatively includes a cross member extending between the third frame member 2732 and the fifth frame member 2740 and/or a cross member extending between the fourth frame member 2736 and the sixth frame member 2744.

With reference continued to FIGS. 18B-18C, in some embodiments, the wagon chassis 104 further includes a fold actuator 2788 that is configured to be actuated to unlock the first hinge 2756 and/or the second hinge 2760 to permit folding of the wagon chassis 104. For example, the fold actuator 2788 is a slide actuator or a rotatable actuator that pulls on cables (not shown) that pull pins in each of the first hinge 2756 and the second hinge 2760 that hold the first hinge 2756 and the second hinge 2760 in the first, unfolded, or use position. As shown, the fold actuator 2788 is located on the cross member 2784. However, in other embodiments, one or more fold actuators 2788 may be located on other portions of the wagon chassis 104 such as, for example without limitation, on one or more of the first, second, third, fourth, fifth, and/or sixth frame members 2724, 2728, 2732, 2736, 2740, 2744.

Now with reference to FIGS. 18A and 18B, in some embodiments, the deck 2720 of the wagon chassis 104 further includes an optional fold plate 2812 connected to the second deck panel 2796. The fold plate 2812 may be connected to the second deck panel 2796 by one or more hinges (not shown) and may be spring loaded to keep the fold plate 2812 flat against the first deck panel 2792 and the second deck panel 2796. It will be understood that in some embodiments, the fold plate 2812 may be connected to the first deck panel 2792 without departing from the scope of the disclosure.

When a user desires to fold up the wagon chassis 104, the user can flip up the fold plate 2812, revealing an opening between the first deck panel 2792 and the second deck panel 2796. The user may then be able access the fold actuator 2788 to fold the wagon chassis 104.

### Storage Devices

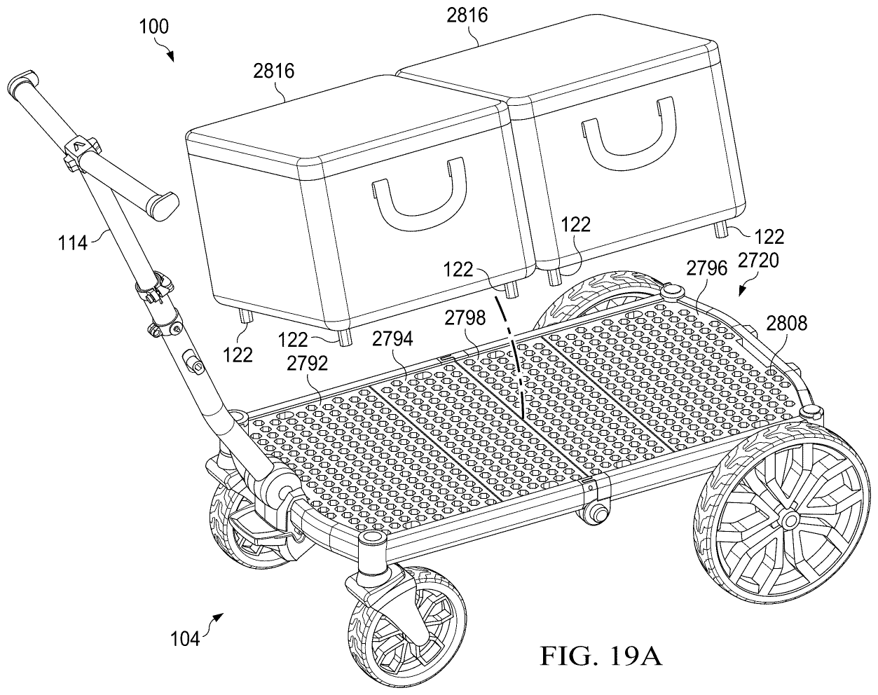

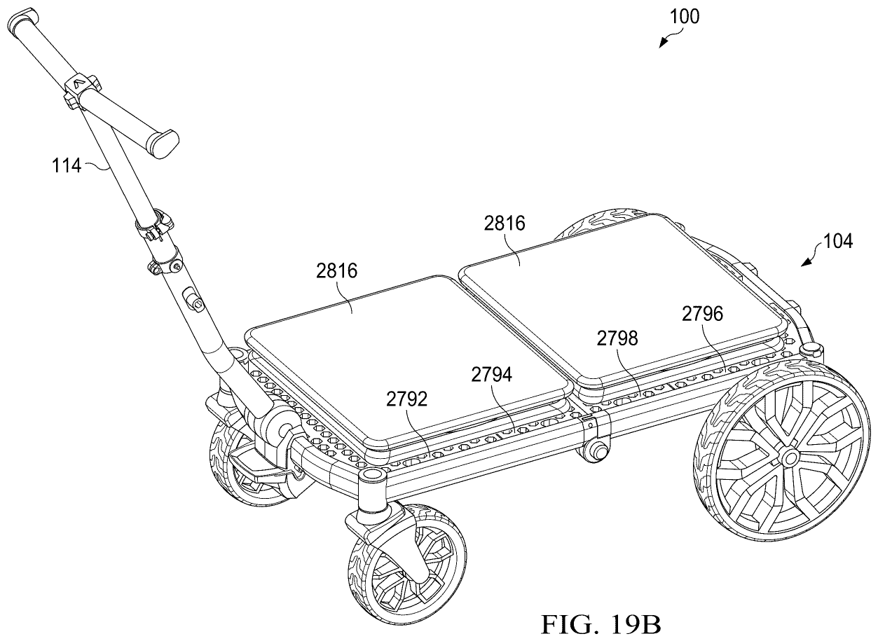

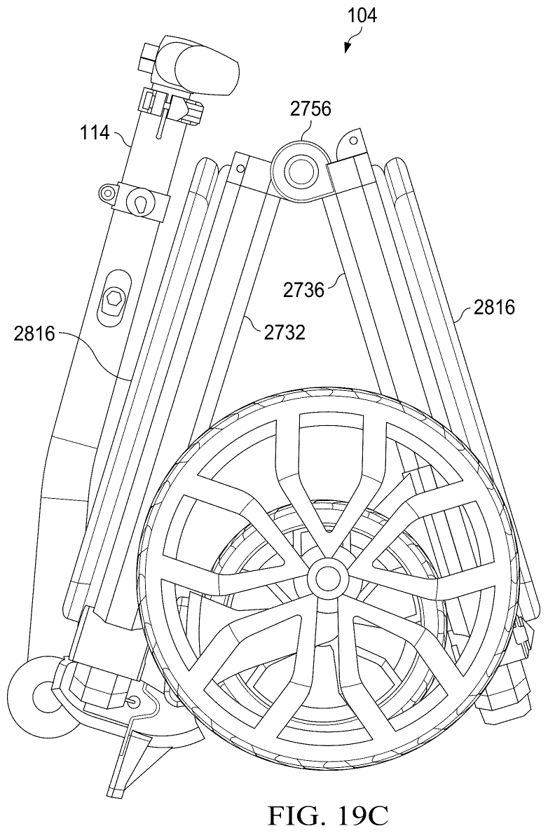

Now with reference to FIGS. 19A-19C, the foldable modular wagon 100 includes the wagon chassis 104. As shown in FIGS. 19A-19C, in some embodiments, the modular wagon bed 106 includes an optional accessory, the optional accessory being one or more storage devices, such as for example only, two bags 2816 coupled to the wagon chassis 104. As shown in FIG. 19A, embodiments of the bags 2816 include pegs 122 to aid in securing the bags 2816 to the wagon chassis 104. The pegs 122 on the bags 2816 are the same type of pegs 122 that are on the modular wagon bed 106. For example, a first of the two bags 2816 is coupled to the first deck panel 2792 and the third deck panel 2794 and a second of the two bags 2816 is coupled to the second deck panel 2796 and the fourth deck panel 2798. The two bags 2816 may themselves be collapsible or foldable bags and are shown in their first, uncollapsed, or use position in FIG. 19A and in their second, collapsed, or storage position in FIGS. 19B and 19C. As shown in FIG. 19C, the wagon chassis 104 is shown in its second, folded, or storage position and the bags 2816 can remain coupled to the wagon chassis 104 when it is in second, folded, or storage position. Additionally, the handle 114 can be folded down toward the first deck panel 2792 to sandwich the storage device (e.g., one of the bags 2816) against the first deck panel 2792 and the third deck panel 2794.

### Additional Embodiments of Deck

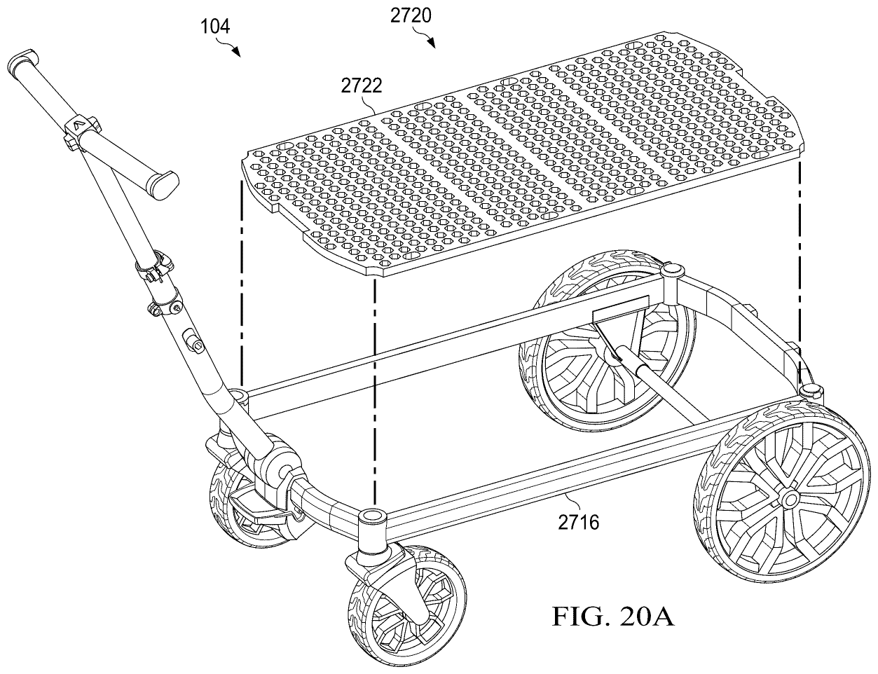

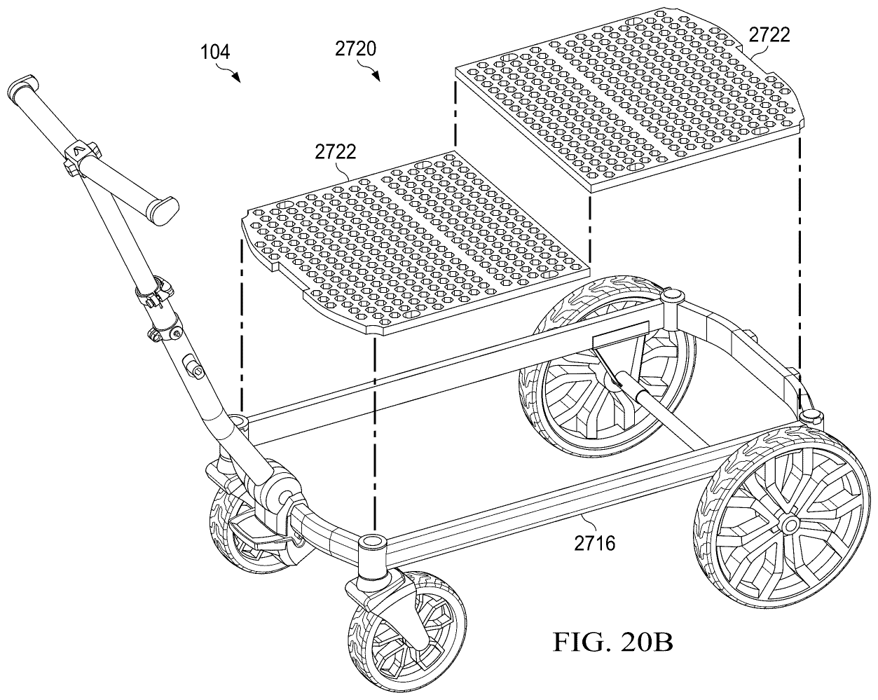

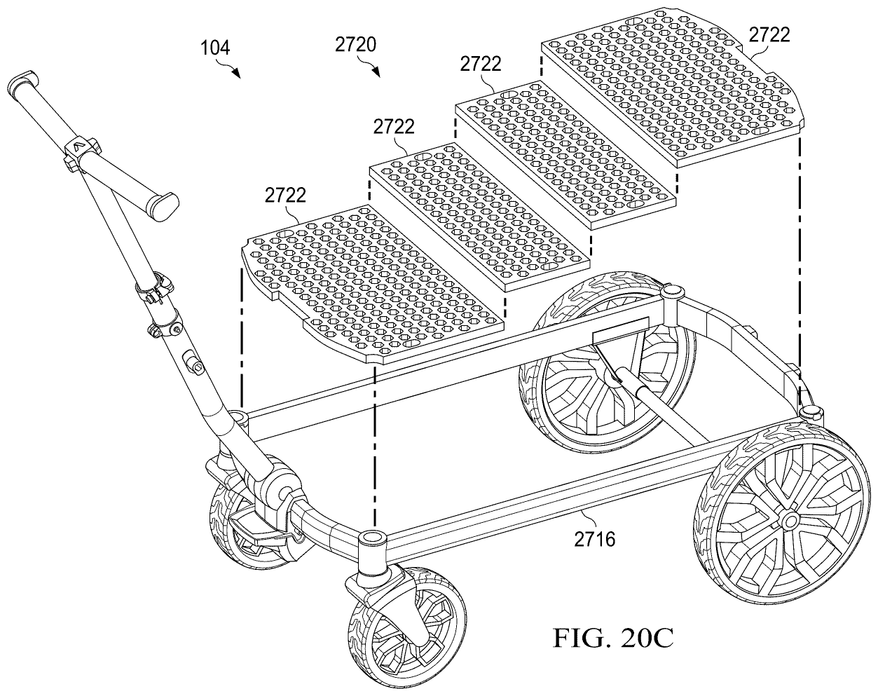

Now with reference to FIGS. 20A-20C, embodiments of the deck 2720 are shown. As shown in FIG. 20A, the deck 2720 comprises a single deck panel 2722. As shown in FIG. 20B, the deck 2716 comprises two deck panels 2722. As shown in FIG. 20C, the deck 2716 comprises four deck panels 2722. Additionally, as shown in FIGS. 20A-20C, the deck panels 2722 may be removable from the wagon chassis 104. Additionally, as shown in FIGS. 20A-20C, in some embodiments, the wagon chassis 104 is not foldable.

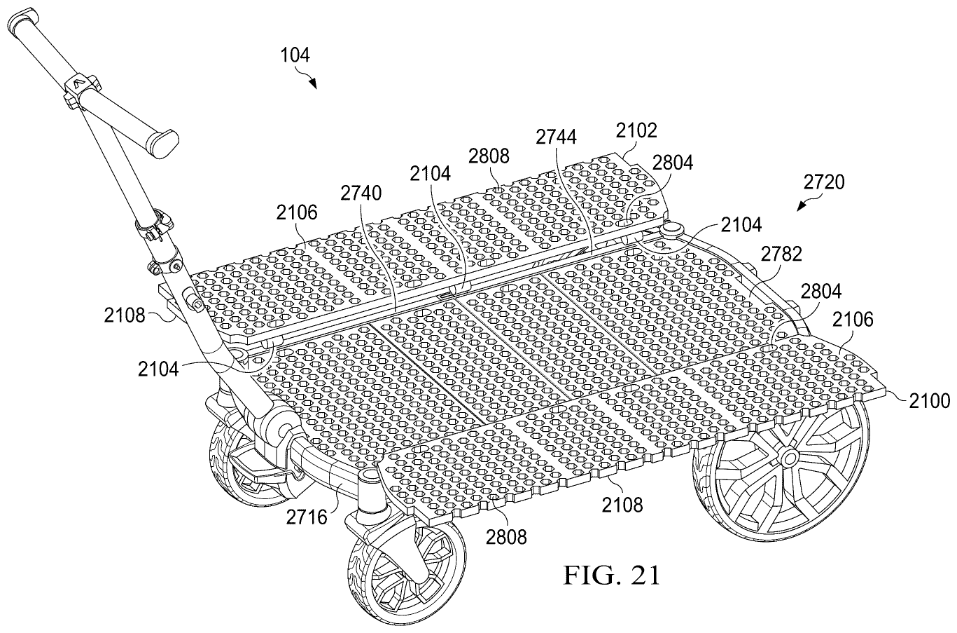

Another embodiment of the wagon chassis 104 is shown in FIG. 21. In some embodiments, the wagon chassis 104 includes fold out deck panels that increase the surface area of the deck 2720 of the wagon chassis 104. The increased surface area of the deck 2720 may permit carrying more and/or larger items on the wagon chassis 104. For example, the wagon chassis 104 includes a first folding deck panel 2100 and a second folding deck panel 2102, wherein each of the first folding deck panel 2100 and the second folding deck panel 2102 is rotatably coupled to the wagon chassis 104 by one or more hinges 2104. The hinges 2104 are located on the left side and right side of the wagon chassis 104. For example, one or more hinges 2104 are coupled to the third frame member 2732 (not visible in FIG. 21) and the fourth frame member 2736 (not visible in FIG. 21) on the left side of the wagon chassis 104 and one or more hinges 2104 are coupled to the fifth frame member 2740 and the sixth frame member 2744 on the right side of the wagon chassis 104. Each of the first folding deck panel 2100 and the second folding deck panel 2102 may be selectively, and independently of one another, positioned in a first, folded position and a second, unfolded position. Each of the first folding deck panel 2100 and the second folding deck panel 2102 have a first surface 2106 and a second surface 2108, opposite the first surface 2106.

In the first, folded position, the first folding deck panel 2100 and the second folding deck panel 2102 are located on top of the deck 2720 such that the first surface 2106 of each of the first folding deck panel 2100 and the second folding deck panel 2102 face the top surface 2782 of the deck 2720 and are proximate to and substantially parallel or parallel to the top surface 2782 of the deck 2720. Additionally, in the first, folded position, the second surface 2108 of each of the first folding deck panel 2100 and the second folding deck panel 2102 face upward and form a top surface upon which items may be placed. In the second, unfolded position, the first folding deck panel 2100 and the second folding deck panel 2102 are folded 180 degrees from the first, folded position outward on the left side and the right side, respectively, of the wagon chassis 104, and are cantilevered and extend outward. Additionally, in the second, unfolded position, the first surface 2106 of each of the first folding deck panel 2100 and the second folding deck panel 2102 face upward and form a top surface upon which items may be placed, and the second surface 2108 of each of the first folding deck panel 2100 and the second folding deck panel 2102 face downward.

As shown in FIG. 21, one or both of the first folding deck panel 2100 and the second folding deck panel 2102 include attachment features 2802, such as tie downs 2804 and openings 2808, as on deck 2720. In some embodiments, one or of the first folding deck panel 2100 and the second folding deck panel 2102 do not include any attachment features 2802, such as tie downs 2804 and openings 2808. In some embodiments, one or both of the first folding deck panel 2100 and the second folding deck panel 2102 are removable from the wagon chassis 104.

### Telescoping Wagon Chassis

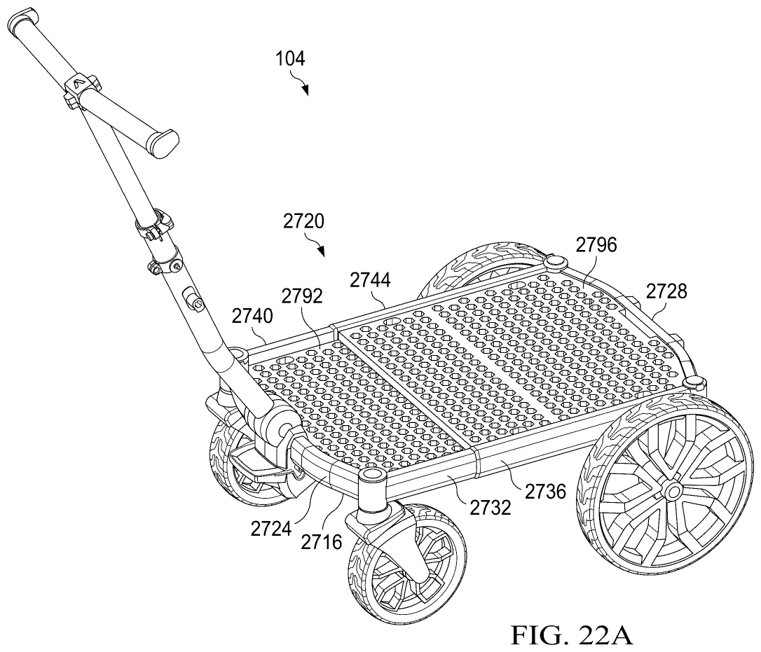

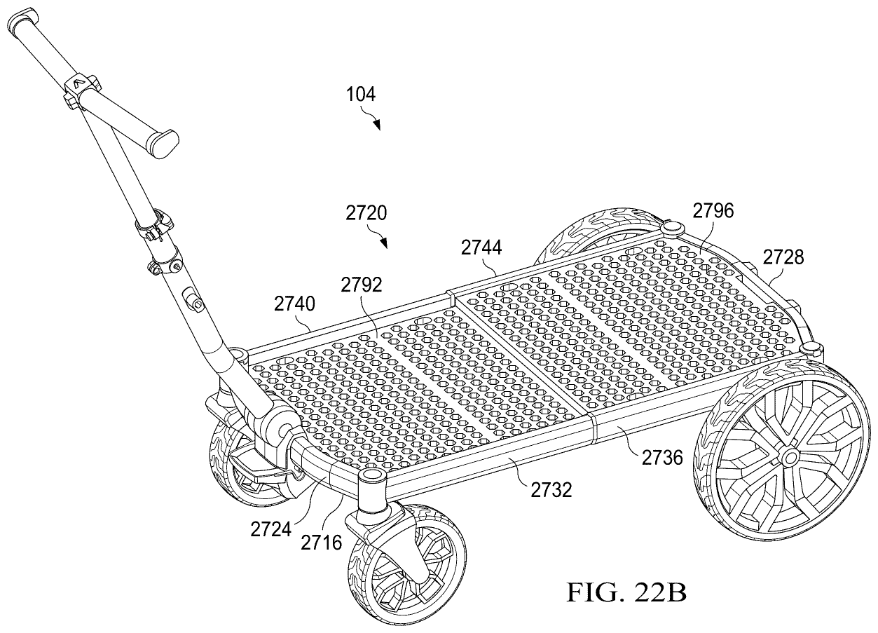

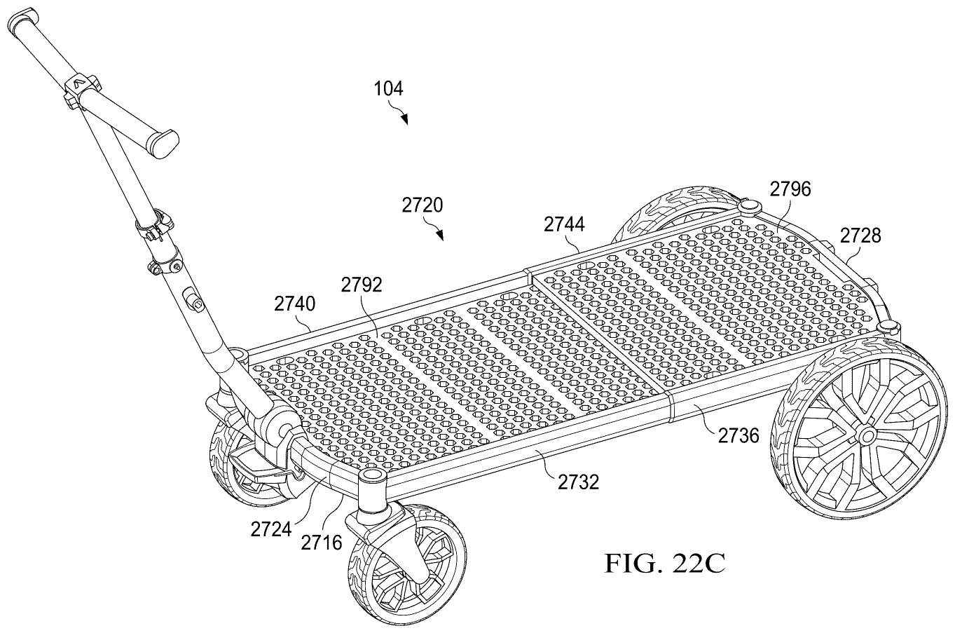

In some embodiments, as shown in FIGS. 22A-22C, the wagon chassis 104 may be adjustable in length to shorten or lengthen the wagon chassis 104. For example, the wagon chassis 104 may be lengthened to carry longer items on the wagon chassis 104 or it may be shortened to carry shorter items on the wagon chassis 104, or for storage of the wagon chassis 104.

As shown in FIGS. 22A-22C, the frame 2716 of the wagon chassis 104 is telescopic. For example, the third frame member 2732 and the fifth frame member 2740 are configured to be received in the fourth frame member 2736 and the sixth frame member 2744, respectively, and the third frame member 2732 and the fifth frame member 2740 are configured to slide at least partially into and out of the fourth frame member 2736 and the sixth frame member 2744, respectively. The third frame member 2732 and the fifth frame member 2740 may be sized and/or shaped to fit within in the fourth frame member 2736 and the sixth frame member 2744, respectively. Additionally, as shown in FIGS. 22A-22C, the deck 2720 is telescopic. For example, the deck 2720 may include the first deck panel 2792 and the second deck panel 2796, wherein the second deck panel 2796 is mounted higher on the frame than the first deck panel 2792 so that the second deck panel 2796 can overlap at least a portion of the first deck panel 2792 and slide with respect to the first deck panel 2792.

Thus to shorten the wagon chassis 104, for example, the first frame member 2724 and the second frame member 2728 of the may be brought to toward one another, with the third frame member 2732 and the fifth frame member 2740 telescoping within at least a portion of the fourth frame member 2736 and the sixth frame member 2744, respectively, and the second deck panel 2796 sliding over at least a portion of the first deck panel 2792. To lengthen the wagon chassis 104, this process is reversed. In some embodiments, the wagon chassis 104 may be locked its short length (see, e.g., FIG. 22A), in its standard length (see, e.g., FIG. 22B), its long length (see, e.g., FIG. 22C), or any intermediate length between these lengths using lock devices, such as for example, quick-release clamps, ratchet systems, screws, a series of spring-loaded pins, etc.

In some embodiments, for example, the above exemplary arrangement is reversed, wherein the fourth frame member 2736 and the sixth frame member 2744 are configured to be received in the third frame member 2732 and the fifth frame member 2740, respectively, and the fourth frame member 2736 and the sixth frame member 2744 are configured to slide at least partially into and out of the third frame member 2732 and the fifth frame member 2740, respectively. In this configuration, the first deck panel 2792 is mounted higher on the frame than the second deck panel 2796 so that the first deck panel 2792 can overlap at least a portion of the second deck panel 2796 and slide with respect to the second deck panel 2796.

### Corner Block Adapters

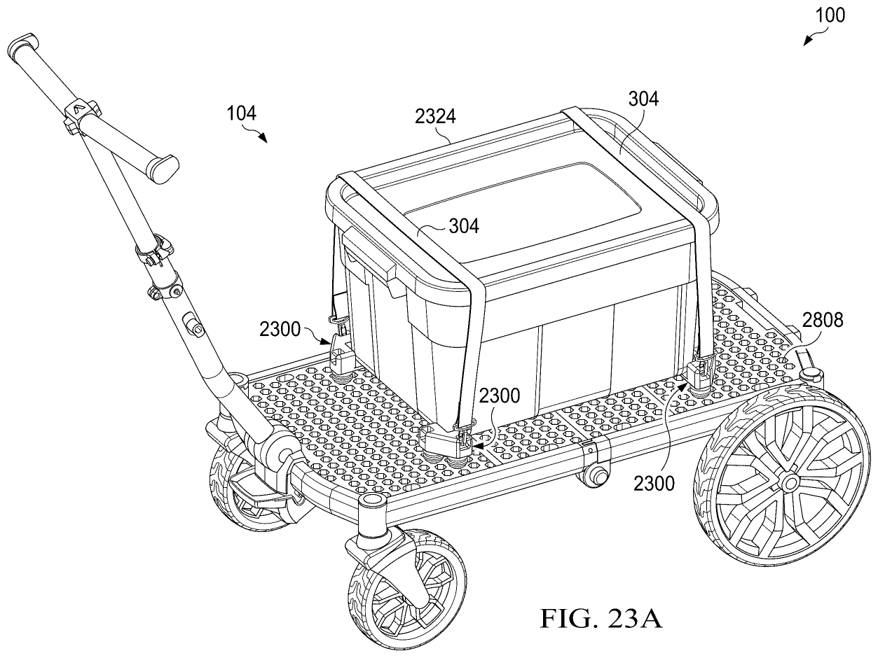

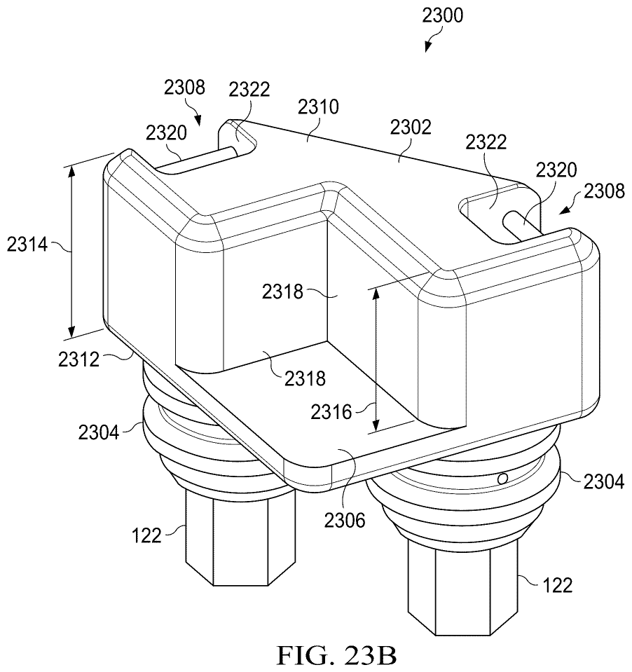

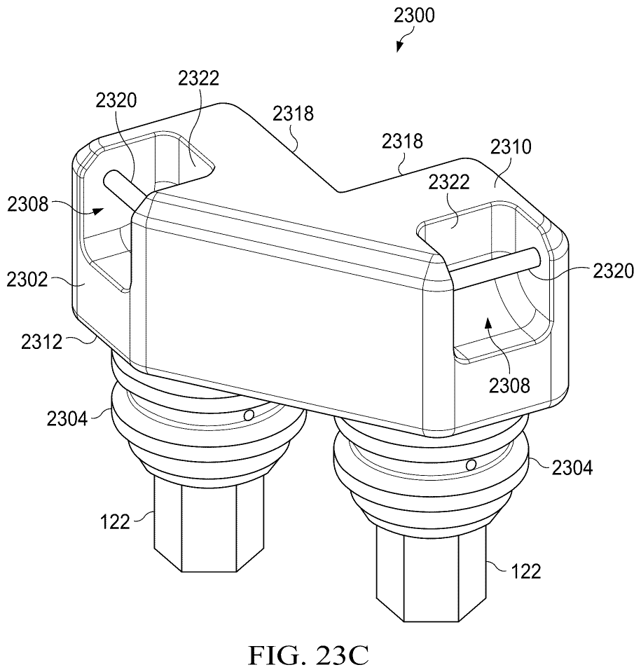

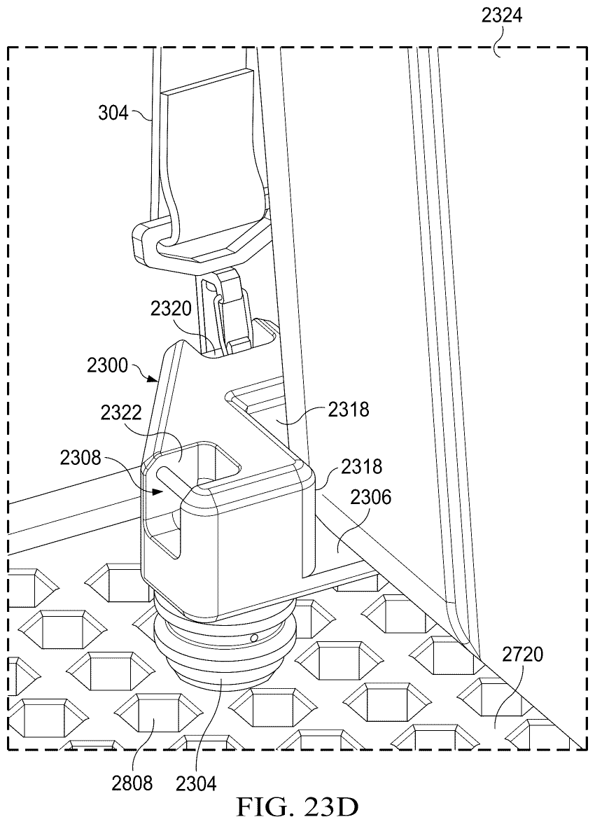

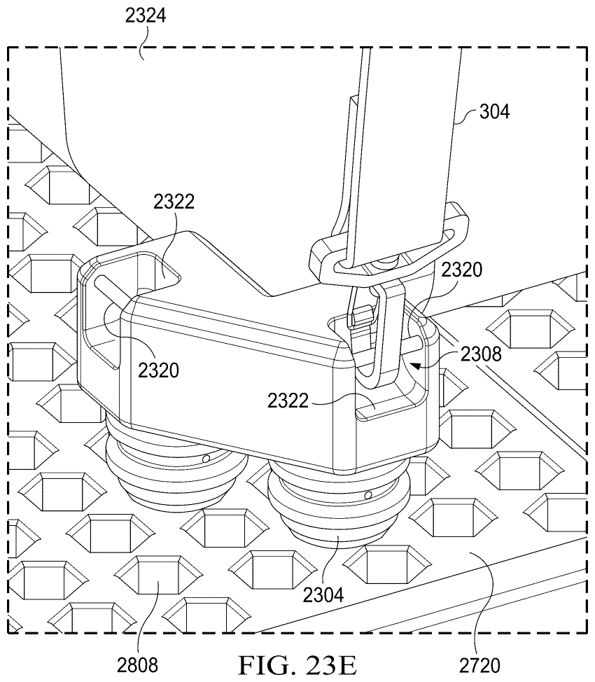

FIGS. 23A-23E illustrate another exemplary adapter. In FIGS. 23A-23E, the adapter comprises one or more corner blocks 2300 that may be coupled to the deck 2720 of the wagon chassis 104 to carry items of different and/or irregular sizes. The corner blocks 2300 can be mounted anywhere on the deck 2720 as needed or desired to carry an item.

Referring now to FIGS. 23B and 23C, an exemplary corner block 2300 is shown. The corner block 2300 includes a body 2302, one or more resilient members 2304, one or more pegs 122, a support surface 2306, and one or more tie downs 2308.

The body 2302 has a top side 2310, a bottom side 2312, and a height 2314 between the top side 2310 and the bottom side 2312. Coupled to and extending from the bottom side 2312, and away from the top side 2310 are the one or more resilient members 2304 and the one or more pegs 122, with a first end of the resilient member 2304 coupled to the bottom side 2312 and a second end of the resilient member 2304 connected to the peg 122. As such, the resilient member 2304 is located between the body 2302 and the peg 122.

The one or more resilient members 2304 may include, but are not limited to, an elastomeric rubber, a coil spring, a fluid-filled damper, etc. For example, the elastomeric rubber may be overmolded onto and between the peg 122 and the body 2302 to elastically couple the body 2302 and the peg 122. As another example, a coil spring may be coupled to the body 2302 and the peg 122 and a hollow bellows cover may be provided around the coil spring.

The support surface 2306 is located between the top side 2310 and the bottom side 2312 of the body 2302 and at a depth 2316 from the top side 2310. The support surface 2306 is square shaped, although other shapes may be provided without departing from the scope of the disclosure. The body 2302 further includes two sidewalls 2318, with each sidewall 2318 extending upward from the support surface 2306 toward the top side 2310 and oriented perpendicular to the support surface 2306, the top side 2310, and the other sidewall 2318. The support surface 2306 and the two sidewalls 2318 cooperate to form a cube-shaped recess in the body 2302.

The tie downs 2308 are located on the periphery of the body 2302 opposite the support surface 2306, with a sidewalls 2318 of the respective sidewalls 2318 between the support surface 2306 and a tie down 2308 of the respective tie downs 2308. Each tie down 2308 includes a bar 2320 located in a recess 2322 in the body 2302. However, it should be understood that in some embodiments, for example only, the tie downs 2308 may lack the recess and the bars may be U-shaped bar extending upward from the top side 2310 of the body 2302. As shown in FIGS. 23B and 23C, the bars 2320 are parallel to the top side 2310 of the body 2302, and each bar 2320 is perpendicular to one the other bar 2320.

Referring again to FIG. 23A and to FIGS. 23D and 23E, the corner blocks 2300 are shown coupled to the wagon chassis 104 along with a cargo bin 2324 supported by the corner blocks 2300. The pegs 122 of each corner block 2300 are inserted into respective openings 2808 in the smart grid on the deck 2720 of the wagon chassis 104. The resilient member 2304 is thus located between the deck 2720 and the support surface 2306 to provide a level of vibration and movement isolation between the wagon chassis 104 and the cargo bin 2324. As such, the resilient member 2304 acts like a suspension system to reduce or eliminate damage to fragile items that may be carried on the wagon chassis 104, such as items within the cargo bin 2324. Additionally, the corners of the cargo bin 2324 are received in the cube-shaped recess formed by the support surface 2306 and the sidewalls 2318 in the body 2302. The bottom of the cargo bin 2324 is supported by the support surface 2306 of the corner block 2300. The support surfaces 2306 and the sidewalls 2318 of the corner blocks 2300 can thus retain an item, such as the cargo bin 2324, on the wagon chassis 104. Additionally, as shown in FIGS. 23A, 23D, and 23E, one or more securing elements 304 such as bungee cords, ropes, ratchet straps, or the like may be clipped or tied to the tie downs 2308 to secure the item, such as the cargo bin 2324, on the wagon chassis 104.

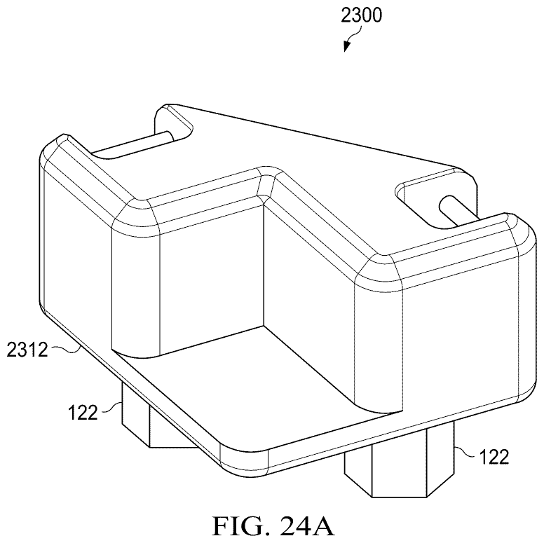

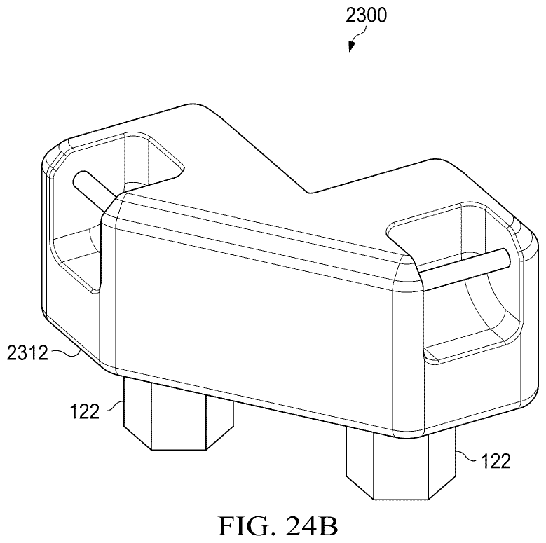

Referring now to FIGS. 24A and 24B, an alternative embodiment of the corner block 2300 is shown that does not include the resilient members 2304. In the embodiment of corner block 2300 shown in FIGS. 24A and 24B, the one or more pegs 122 are coupled directly to the bottom side 2312 of the body 2302 of the corner block 2300.

### Tie Down Blocks

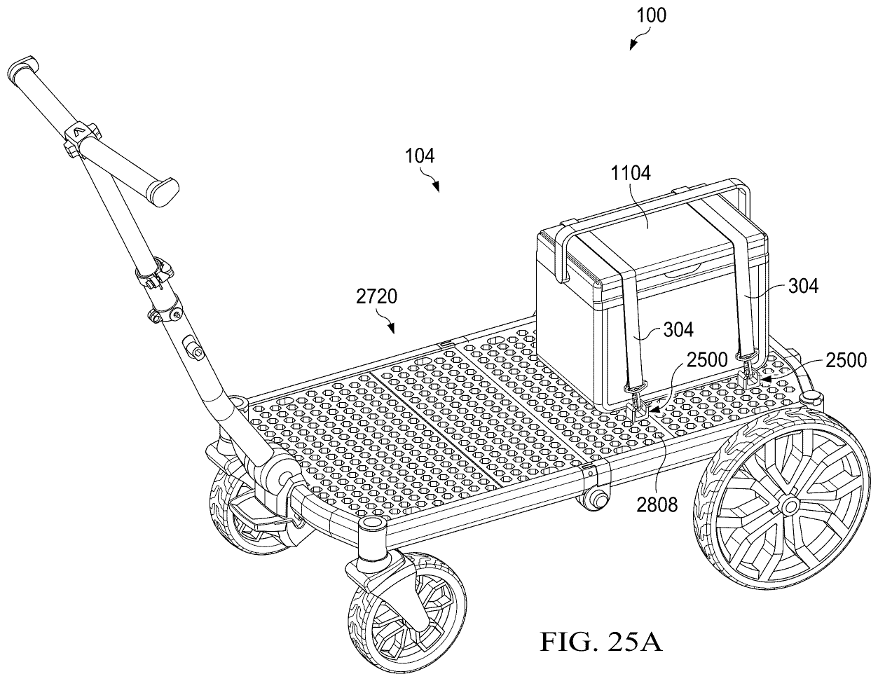

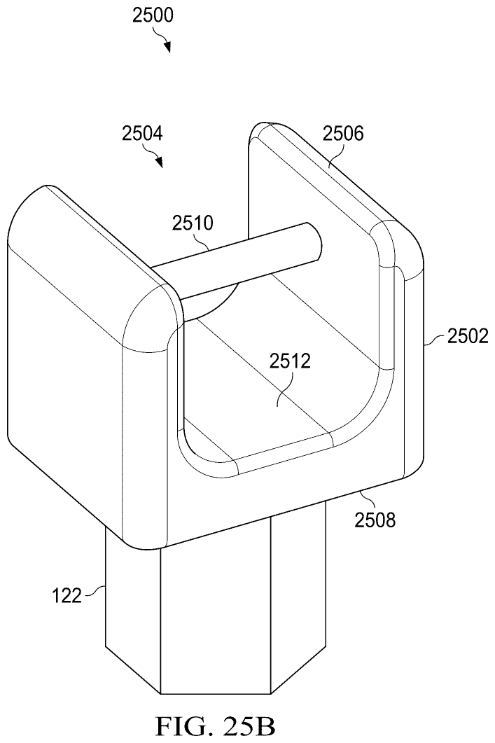

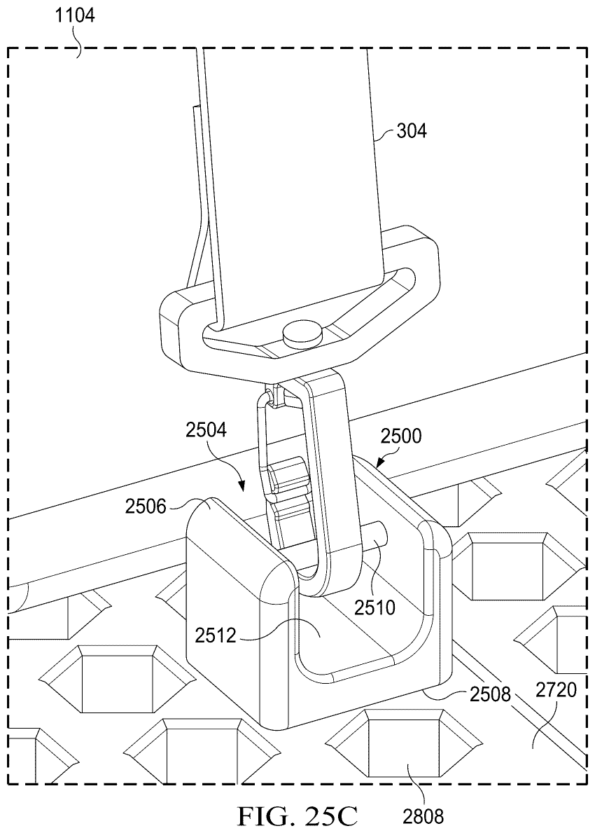

FIGS. 25A-25D illustrate another exemplary adapter. In FIGS. 25A-25D, the adapter comprises one or more tie down blocks 2500 that may be coupled to the deck 2720 of the wagon chassis 104 to carry items of different and/or irregular sizes. The tie down blocks 2500 can be mounted anywhere on the deck 2720 as needed or desired to carry an item.

Referring now to FIG. 25B, an exemplary tie down block 2500 is shown. The tie down block 2500 includes a body 2502, one or more pegs 122, and one or more tie downs 2504. The body 2502 has a top side 2506 and a bottom side 2508. Coupled to and extending from the bottom side 2508, and away from the top side 2506 is a peg 122. The tie down 2504 includes a bar 2510 located in a recess 2512 in the body 2502. However, it should be understood that in some embodiments, for example only, the tie downs 2504 may lack the recess and the bars may be U-shaped bar extending upward from the top side 2506 of the body 2502.

Referring again to FIGS. 25A and 25D, the tie down blocks 2500 are shown coupled to the wagon chassis 104 along with, for example, a cooler 1104. The pegs 122 of each tie down block 2500 are inserted into respective openings 2808 in the smart grid on the deck 2720 of the wagon chassis 104. Additionally, as shown in FIGS. 25A and 25D, one or more securing elements 304 such as bungee cords, ropes, ratchet straps, or the like may be clipped or tied to the tie downs 2504 to secure the item, such as the cooler 1104, on the wagon chassis 104.

### Adjustable Mounting Rails

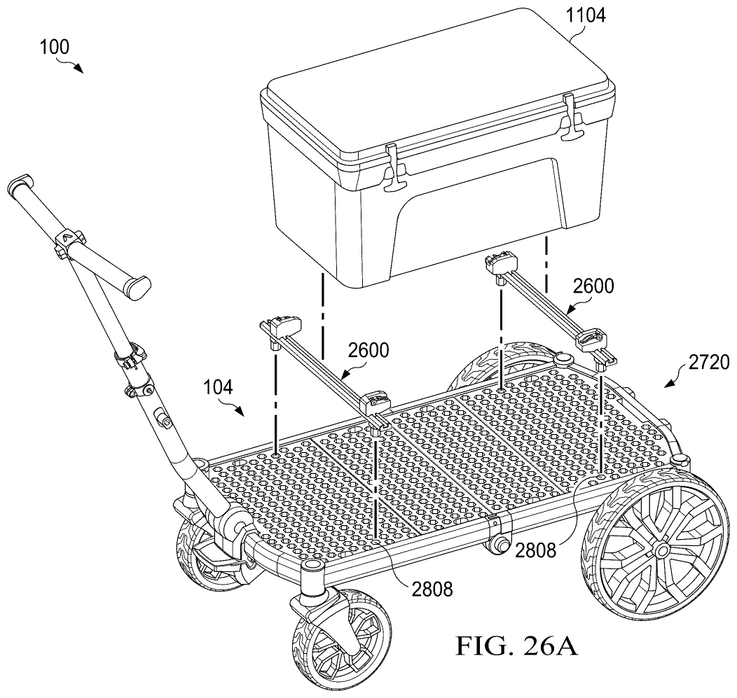

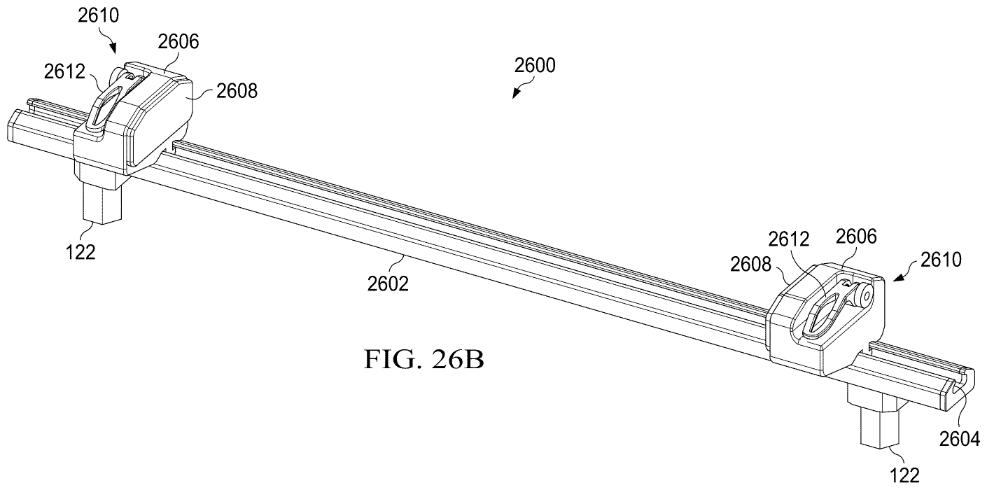

FIGS. 26A and 26B illustrate another exemplary adapter. In FIGS. 26A and 26B, the adapter comprises one or more mounting rails 2600 that may be coupled to the deck 2720 of the wagon chassis 104 to carry items of different and/or irregular sizes. The mounting rails 2600 can be mounted anywhere on the deck 2720 as needed or desired to carry an item.

The mounting rails 2600 include a rail 2602, two or more adjustable blocks 2606, and two or more pegs 122. The rail 2602 includes a channel 2604 on its top side in which the adjustable blocks 2606 are retained and are able to slide along the length of the rail 2602. The two or more pegs 122 are coupled to and extend from the bottom side of the rail 2602. The two or more pegs 122 are proximate to the terminal ends of the rail 2602. Each adjustable block 2606 includes a clamping surface 2608, which in some embodiments, is a rubber material. The clamping surface 2608 is substantially flat and is oriented perpendicular to the length of the rail 2602 when the adjustable block 2606 is mounted to the rail 2602. Each adjustable block 2606 further includes a releasable lock 2610 to permit locking the adjustable block 2606 in a location along the length of the rail 2602. In some embodiments, for example, the releasable lock 2610 is similar to a quick release lock, and includes a lever 2612 that is raised to release the releasable lock 2610 and lowered to lock the releasable lock 2610. As shown in FIGS. 26A and 26B, the adjustable blocks 2606 are mounted to the rail 2602 such that the clamping surfaces 2608 of the adjustable blocks 2606 face one another. This permits clamping an item between the clamping surfaces 2608 of the adjustable blocks 2606.

To use the mounting rails 2600, a user can couple the mounting rails 2600 to desired locations on the deck 2720 of the wagon chassis 104 by inserting the pegs 122 of each mounting rail 2600 into respective openings 2808 in the smart grid on the deck 2720 of the wagon chassis 104. As shown in FIG. 26A, the user can orient the mounting rails 2600 so that they are oriented transversely on the deck 2720 (e.g., wherein the rails 2602 extend left and right on the deck 2720 and are perpendicular to the left side and the right side of the wagon chassis 104). Additionally, the user can space the mounting rails 2600 longitudinally (e.g., fore and aft) on the deck 2720 such that the item that the user desires to carry on the wagon chassis 104 is supported by the rails 2602 of the mounting rails 2600. For example, as shown in FIG. 26A, where the item is a cooler 1104, the user can space the mounting rails 2600 apart a distance that is less than the length of the cooler 1104 so that the bottom of the cooler 1104 rests on the rails 2602 of the mounting rails 2602. The user can then unlock or release the releasable locks 2610 of the adjustable blocks 2606, move the adjustable blocks 2606 so that the clamping surfaces 2608 contact the item that the user desires to securely hold on the wagon chassis 104, and can then lock the releasable locks 2610 of the adjustable blocks 2606 to secure the adjustable blocks 2606 in place. The user can compress the clamping surfaces 2608 of the adjustable blocks 2606 against the item, such as for example, the cooler 1104 or other items, such as for example, a boogie board, to secure the items to the wagon chassis 104.

Although the mounting rails 2600 are shown oriented transversely on the deck 2720 in FIG. 26A, it should be understood that the mounting rails 2600 may be oriented longitudinally on the deck 2720 as shown in FIG. 26C (e.g., wherein the rails 2602 extend fore and aft on the deck 2720 and are parallel to the left side and the right side of the wagon chassis 104).

### Pegs on the Additional Components

As shown throughout the figures, in some embodiments, the pegs 122 described herein have a hexagonal shape. Now with reference to FIGS. 27A-27D, various embodiments of pegs 122 are shown having alternative shapes and/or features. In FIG. 27A, for example, the peg 122 includes threads 2614 and is configured to be screwed into a corresponding threaded opening 2808 in the deck 2720 of the wagon chassis 104. In FIG. 27B, for example, the peg 122 includes one or more ball locks 2616 that are configured to be received in one or more corresponding detents in openings 2808 in the deck 2720 of the wagon chassis 104. Additionally, the tie down block 2500 includes a sprung push button 2618 can may be depressed to release the ball locks 2616 and permit removal of the peg 122 from the openings 2808 in the deck 2720. In FIG. 27C, for example, the peg 122 includes a pair of flex fingers 2620, each having a retention flange 2622 at the distal end of the peg 122. The pair of flex fingers 2620 are configured to flex toward one another to aid in inserting the peg 122 into the openings 2808 in the deck 2720. In FIG. 27D, the peg 122 includes a spring button clip fastener 2626 that is configured to be received in one or more corresponding detents in openings 2808 in the deck 2720 of the wagon chassis 104. In some embodiments, the pegs 122 may also include one or magnets and may be retained magnetically in the openings 2808 in the deck 2720. For example, the deck 2720 may include or be made of a magnetic material (e.g., ferrous metal, a plastic magnet) to which the one or more magnets in the pegs 122 are attracted to aid in retaining the pegs 122 in the openings 2808 in the deck 2720. In some embodiments, at least the internal surface(s) of the openings 2808 in the deck 2720 may be rubberized and the pegs 122 may be retained in the openings 2808 by a friction fit. Although FIGS. 27A-27D show these pegs 122 in conjunction with a tie down block 2500, it should be understood that the pegs 122 shown in FIGS. 27A-27D can be used with any embodiment of the additional components (e.g., the accessories and adapters) described herein as including a peg 122 without departing from the scope of the disclosure.

### Open Top Bin

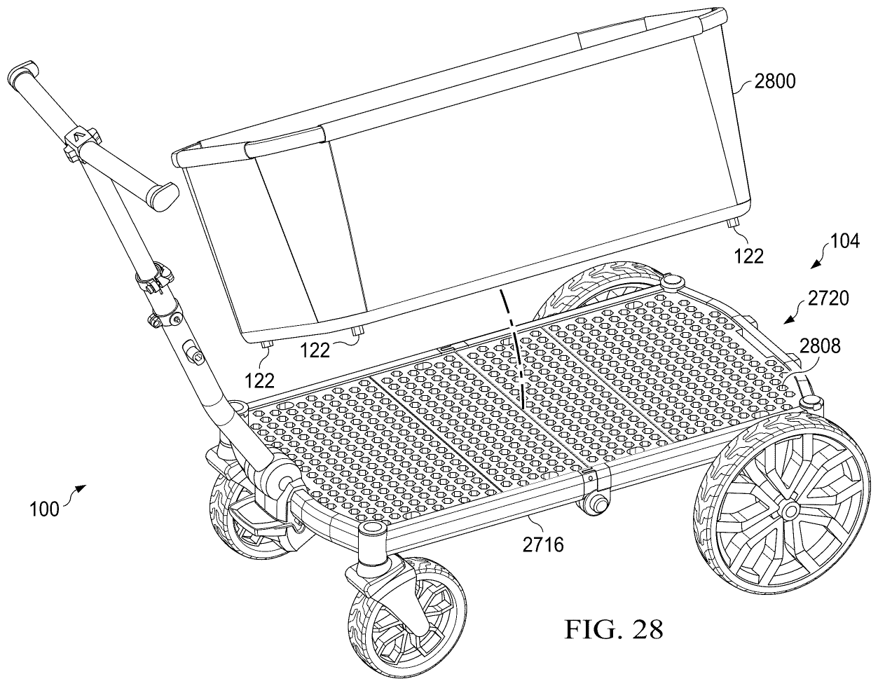

FIG. 28 shows the wagon chassis 104 with an optional accessory, wherein the optional accessory is an open top bin 2800. As shown in FIG. 28, embodiments of the open top bin 2800 include pegs 122 to aid in securing the open top bin 2800 to the wagon chassis 104. The pegs 122 on the open top bin 2800 are the same type of pegs 122 that are on the modular wagon bed 106. Like the bag 302 described with respect to FIGS. 6A-6C, in some embodiments, the open top bin 2800 has a rigid bottom and/or the pegs 122 are rigidly connected to one another. In these embodiments, and where the wagon chassis 104 is foldable, the rigid bottom of the open top bin 2800 or the rigid connection between the pegs 122 can keep the wagon chassis 104 in the unfolded position even if the wagon chassis 104 lacks a lock mechanism or device to keep the wagon chassis 104 in the unfolded position. As such, in these embodiments, the wagon chassis 104 can be easily folded without unlocking a lock mechanism or device by removing the open top bin 2800 from the wagon chassis 104 and simply folding the wagon chassis 104.

### Trailer Configurations

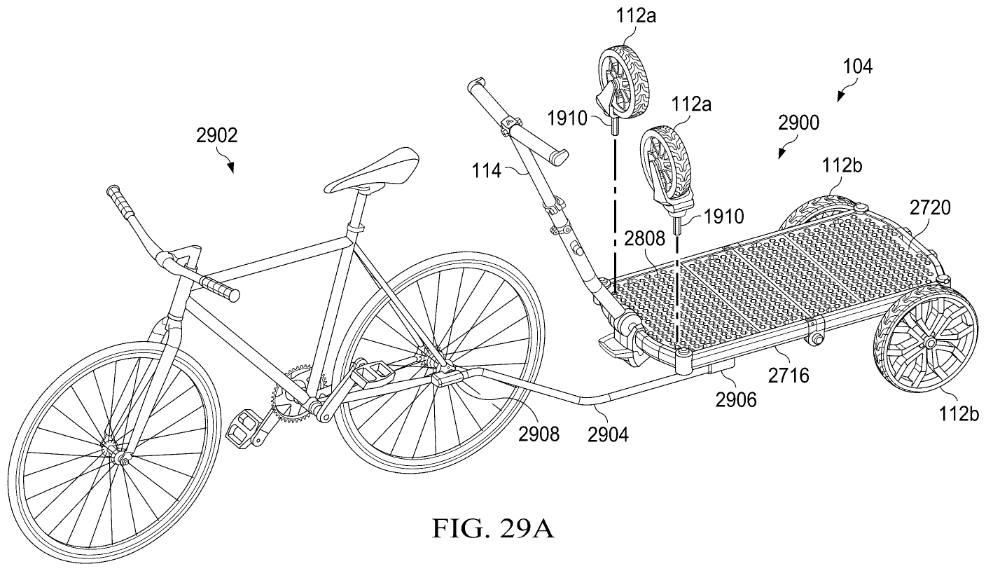

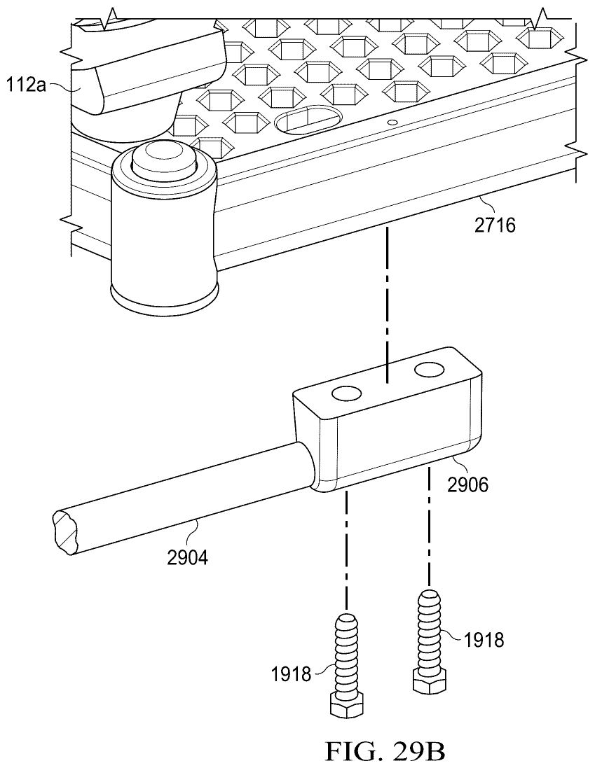

Now with reference to FIGS. 29A, 29B, 30A, 30B, 31, 32A, and 32B, in some embodiments, the wagon chassis 104 may be configured as a trailer 2900. When configured as a trailer, the swivel wheels 112a are removed from the wagon chassis 104 and can be stored on the deck 2720, for example, by inserting the stems 1910 of the swivel wheels 112a into the openings 2808 in the deck 2720. Additionally, a tow bar 2904 is coupled to the wagon chassis 104 and the tow bar 2904 may be coupled to a vehicle, such as for example only, a bicycle 2902.

As shown in FIGS. 29A and 29B, the tow bar 2904 includes a first end 2906 configured to be coupled to the wagon chassis 104 and a second end 2908 configured to be coupled to the bicycle 2902. For example, the first end 2906 of the tow bar 2904 is coupled to the frame 2716 of the wagon chassis 104 by two threaded fasteners 1918 and the second end 2908 of the tow bar 2904 couples to, for example, the chain stay of the bicycle 2902 as is known in the art.

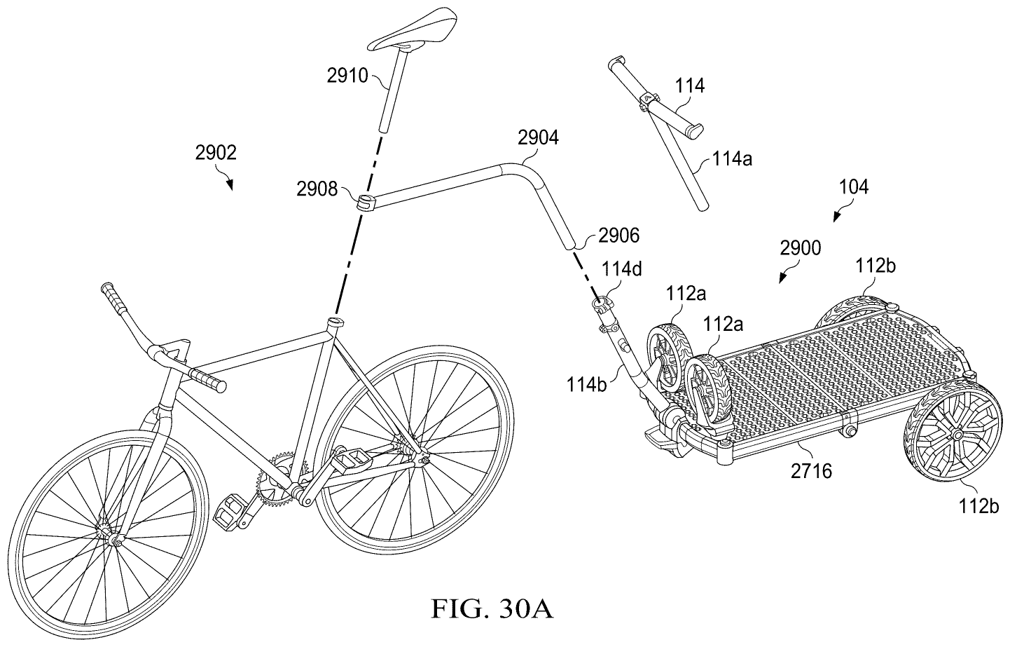

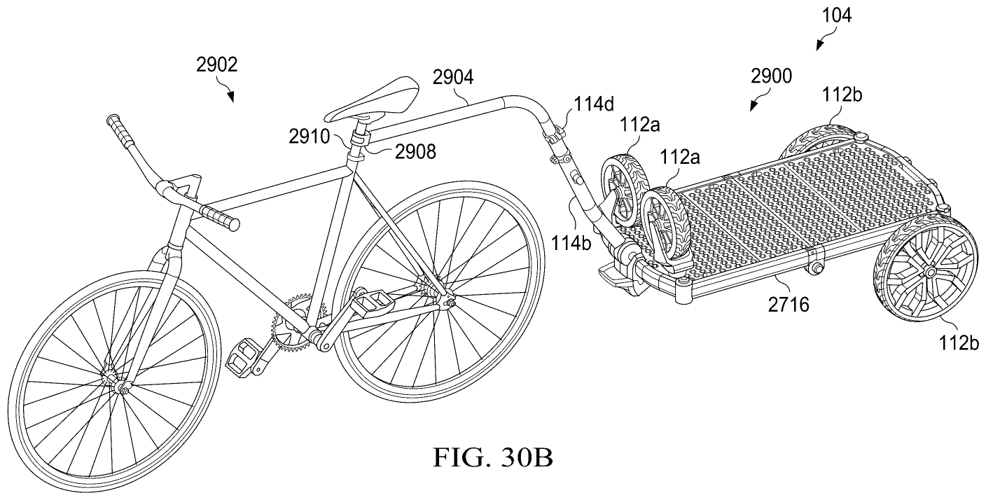

In FIGS. 30A and 30B, another embodiment of the wagon chassis 104 configured as a trailer 2900 is shown. The tow bar 2904 cooperates with the second handle portion 114b to form a goose-neck style tow bar. As shown in FIG. 30A, the first handle portion 114a can be removed from the wagon chassis 104. As shown in FIG. 30B, the first end 2906 of the tow bar 2904 can be inserted into the second handle portion 114b. The quick release clamp 114d on the second handle portion 114b is then clamped to secure the tow bar 2904 to the second handle portion 114b. The second end 2908 of the tow bar 2904 is then clamped onto the seat tube 2910 of the bicycle 2902.

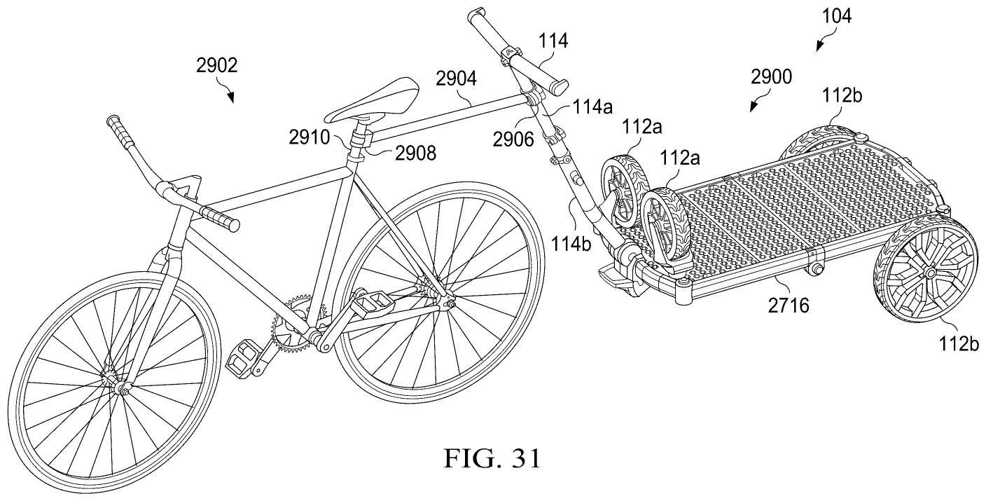

In FIG. 31, another embodiment of the wagon chassis 104 configured as a trailer 2900 is shown. In this embodiment, the tow bar 2904 couples to the first handle portion 114a of the wagon chassis 104 and the seat tube 2910 of the bicycle 2902. Namely, the first end 2906 of the tow bar 2904 is clamped to the first handle portion 114a of the wagon chassis 104 and the second end 2908 of the tow bar 2904 is clamed to the seat tube 2910 of the bicycle 2902.

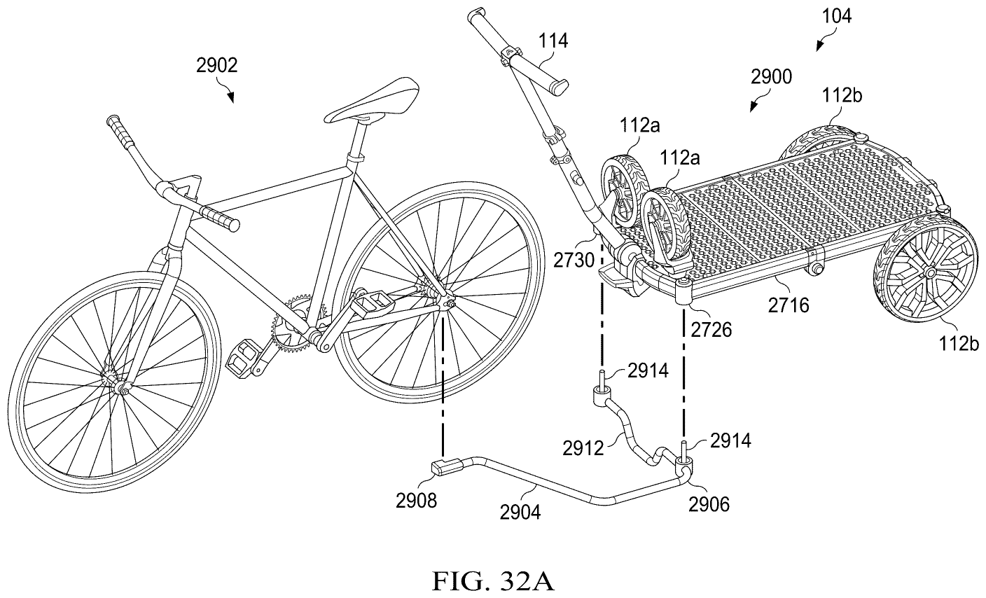

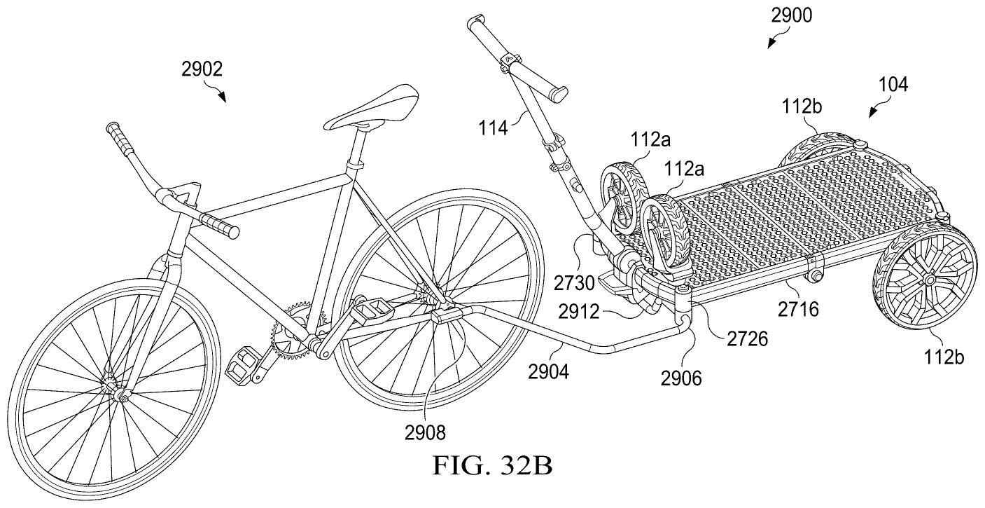

In FIGS. 32A and 32B, another embodiment of the wagon chassis 104 configured as a trailer 2900 is shown. In this embodiment, the tow bar 2904 includes a cross bar 2912 at the first end 2906 of the tow bar 2904. The cross bar 2912 includes a pair of stems 2914 extending upwardly from the cross bar 2912. The stems 2914 are spaced apart a distance equal to the distance between the first swivel wheel housing 2726 and the second swivel wheel housing 2730 (and the distance between the third swivel wheel housing 2734 and the fourth swivel wheel housing 2738). As shown in FIG. 32B, the first end 2906 of the tow bar 2904 is coupled to the frame 2716 of the wagon chassis 104 by inserting the two stems 2914 into the sockets of the first swivel wheel housing 2726 and the second swivel wheel housing 2730 and the second end 2908 of the tow bar 2904 couples to, for example, the chain stay of the bicycle 2902 as is known in the art. As shown in FIGS. 32A and 32B, in some embodiments, the cross bar 2912 includes a downwardly extending portion to provide clearance between the cross bar 2912 and a portion of the handle 114 at the location where the handle 114 is coupled to the frame 2716 of the wagon chassis 104.

Although in FIGS. 29A, 29B, 30A, 30B, 31, 32A, and 32B the wagon chassis 104 is shown as being used in a trailer configuration and coupled to a bicycle 2902, it should be understood that the wagon chassis 104 in the trailer configuration may be coupled to any type of vehicle, such as for example and without limitation, a motorcycle, an all-terrain vehicle (ATV), a side-by-side, a snowmobile, a car, a truck, a child's ride on toy vehicle (e.g., a pedal car, a battery-powered ride on vehicle (such as those sold under the Power Wheels™ brand), a go kart, etc.), a tricycle, etc. without departing from the scope of the disclosure.

### Embodiments of Hinges

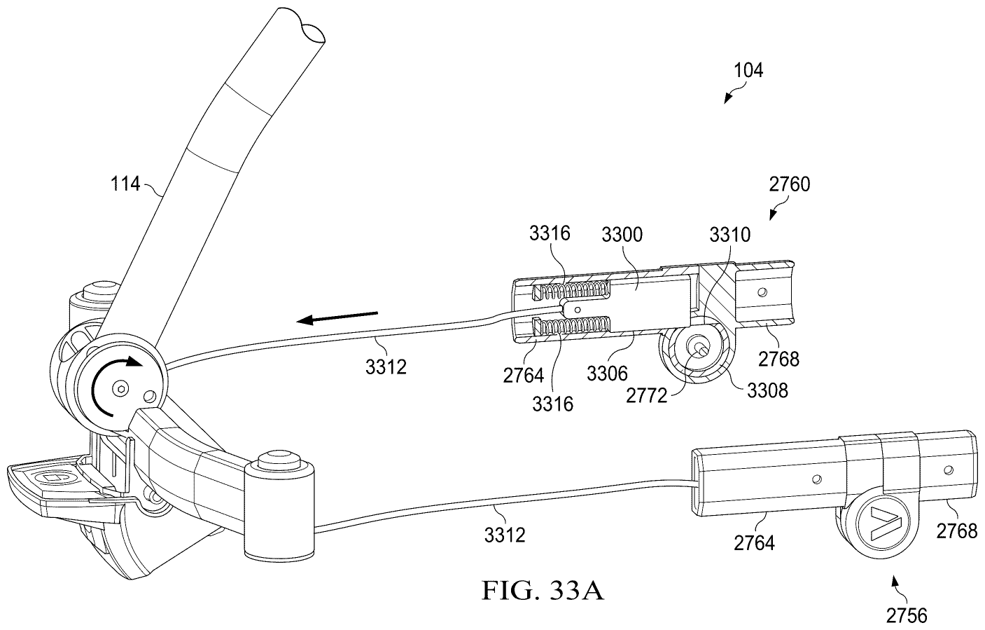

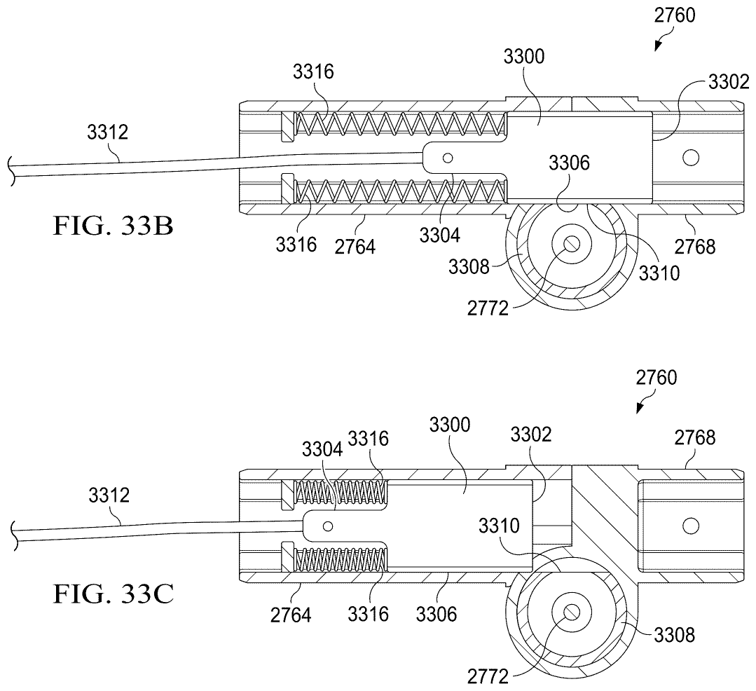

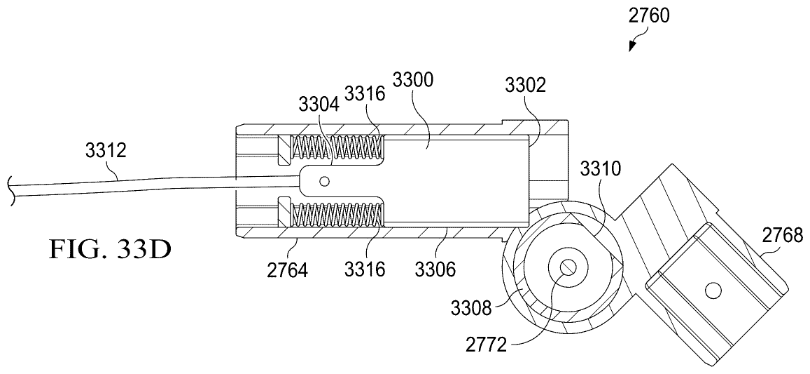

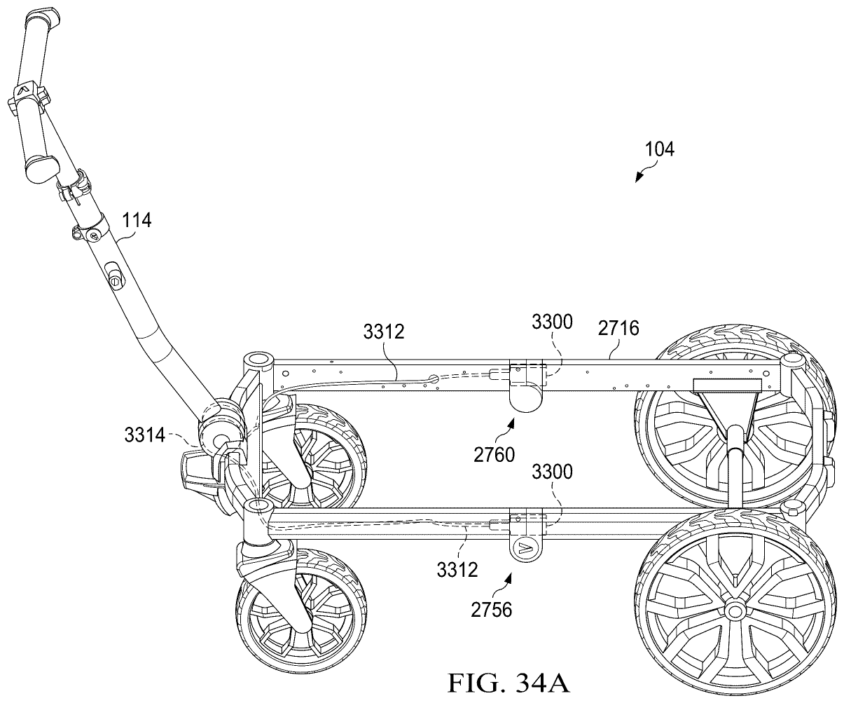

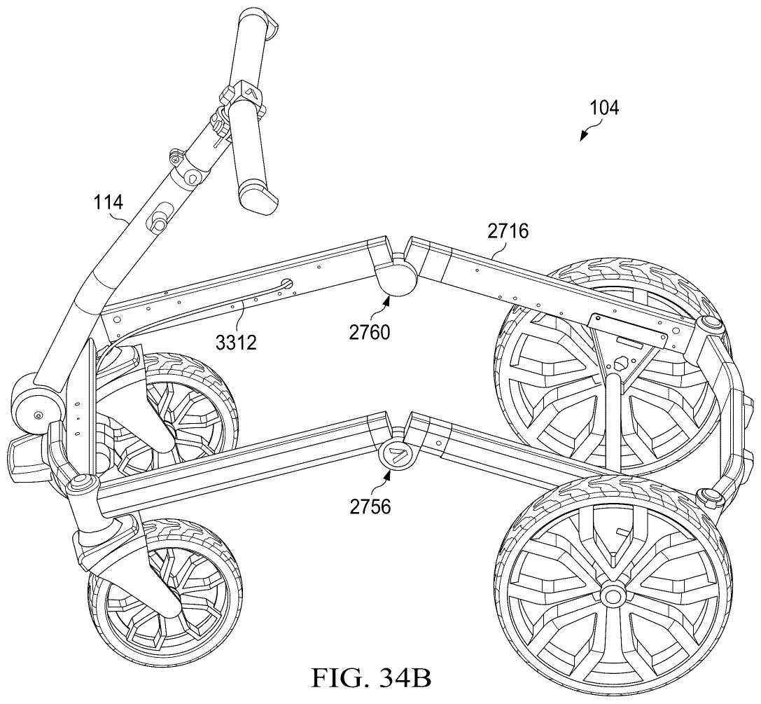

Referring now to FIGS. 33A-33D, 34A, and 34B, an embodiment of locking hinges 2756, 2760 of the wagon chassis 104 are shown. In FIGS. 33A-33D, only the second hinge 2760 is shown; however, the first hinge 2756 is identical to or a mirror of the second hinge 2760, and therefore the description with respect to the second hinge 2760 applies to the first hinge 2756.

As shown in FIGS. 33A-33D, the first hinge element 2764 and the second hinge element 2768 that are pivotably coupled to one another by a hinge pin 2772. The first hinge element 2764 includes a pawl 3300 that is slidably connected to the first hinge element 2764. The pawl 3300 includes a first side 3302, a second side 3304 opposite the first side 3302, and a first locking surface 3306 extending at least partially from the first side 3302 toward the second side 3304.

The second hinge element 2768 includes a hub 3308 that is fixed on position on the second hinge element 2764. The hub 3308 includes a second locking surface 3310 that can cooperate with the first locking surface 3306 of the pawl 3300 to prevent relative rotational motion between the first hinge element 2764 and the second hinge element 2768 to thereby lock the first hinge 2756 in the first, unfolded, or use position. In some embodiments, for example, as shown in FIGS. 33A-33D, the first locking surface 3306 and the second locking surface 3310 are flat surfaces that contact one another to prevent relative rotational motion between the first hinge element 2764 and the second hinge element 2768.

In some embodiments, the pawl 3300 is moved by a cable 3312. For example, as shown in FIGS. 33A-33D and 34A, a first end of the cable 3312 is connected to the pawl 3300 on the second side 3304 of the pawl 3300. As shown in FIG. 34A, for example, the second end of the cable 3312 is connected to a pulley 3314 that is coupled to the handle 114. The pulley 3314 is configured to rotate when the handle 114 is folded down toward the frame 2716 of the wagon chassis 104. In some embodiments, the pulley 3314 rotationally fixed to the handle 114 such that the pulley 3314 does not rotate independently of the handle 114.

The pawl 3300 is configured to be located in a first, locked position (see FIGS. 33B and 34A) and a second, unlocked position (see FIGS. 33D and 34B). When the pawl 3300 is in the first, locked position, the first hinge element 2764 and the second hinge element 2768 are unable to pivot with respect to one another. the first hinge 2756 is unable to pivot. When the pawl 3300 is in the second, unlocked position, first hinge 2760 is able to pivot.

Thus, in some embodiments, to fold the wagon chassis 104, the handle 114 is rotated toward the frame 2716 of the wagon chassis 104. Rotation of the handle 114 toward the frame 2716 rotates the pulley 3314, which in turn pulls on the second end of the cable 3312 connected thereto, wrapping a portion of the cable 3312 around the pulley 3314. This in turn pulls on the first end of the cable 3312, which is connected to the pawl 3300. This pulls the pawl 3300 from its first, locked position (see FIGS. 33B and 34A) to its second, unlocked position (see FIGS. 33C, 33D, and 34B). Pulling the pawl 3300 from the first, locked position to the second, unlocked position moves the first locking surface 3306 of the pawl 3300 away from and out of contact with the second locking surface 3310 of the hub 3308. The hub 3308 and the second hinge element 2768 are then able to rotate with respect to the first hinge element 2764, allowing the wagon chassis 104 to fold (see FIG. 34B).

In some embodiments, the pawl 3300 may be biased toward the first, locked position. For example, with reference again to FIGS. 33B-33D, the first hinge element 2764 may include one or more biasing elements, such as for example, coil springs 3316 located on the second side 3304 of the pawl 3300 that are configured to exert a force against the pawl 3300 to push the pawl 3300 toward the second hinge element 2768 and into the first, locked position. For example, to unfold the wagon chassis 104, the handle 114 is rotated away from the frame 2716 of the wagon chassis 104. Rotation of the handle 114 away the frame 2716 rotates the pulley 3314, which in turn lets out slack on the second end of the cable 3312 connected thereto, unwrapping a portion of the cable 3312 from around the pulley 3314. This in turn lets out slack on the first end of the cable 3312, which is connected to the pawl 3300. The hub 3308 and the second hinge element 2768 are then rotated with respect to the first hinge element 2764, allowing the wagon chassis 104 to unfold (see FIG. 34A). With the slack in the cable, the coil springs 3316 push the pawl 3300 from its second, unlocked position (see FIGS. 33C, 33D, and 34B) to its first, locked position (see FIGS. 33B and 34A). Pushing the pawl 3300 from the second, unlocked position to the first, locked position moves the first locking surface 3306 of the pawl 3300 toward and into contact with the second locking surface 3310 of the hub 3308. The wagon chassis 104 is then locked in the unfolded position.

Although this embodiment is described as including a cable 3312 connected to the pawl 3300 and the pulley 3314, it will be understood that in some embodiments, for example, the pawl 3300 may be moved from its first, locked position to its second, unlocked position and/or from its second, unlocked position to its first, locked position without a cable 3312 and pulley 3314. For example only, one or more finger pulls may be provided on the frame 2716 of the wagon chassis 104 that a user may be able to manipulate to move the pawl 3300 from its first, locked position to its second, unlocked position and/or from its second, unlocked position to its first, locked position.

Additionally, although FIGS. 33A and 34A show the wagon chassis 104 as including two pawls 3300, it will be understood that in some embodiments, the wagon chassis 104 may be provided with a single pawl 3300 without departing from the scope of the disclosure.

Referring now to FIGS. 35A-35E, another embodiment of locking hinges 2756, 2760 of the wagon chassis 104 are shown. In FIGS. 35A-35E, only the second hinge 2760 is shown; however, the first hinge 2756 is identical to or a mirror of the second hinge 2760, and therefore the description with respect to the second hinge 2760 applies to the first hinge 2756.

As shown in FIGS. 35A-35E, the first hinge element 2764 and the second hinge element 2768 that are pivotably coupled to one another by a hinge pin 2772. As shown in FIGS. 35C and 35D, the first hinge element 2764 includes a first plate 3500 and at least one second plate 3502, the second plate 3502 configured to linearly slide with respect to the first plate 3500. The second plate 3502 includes two pins, a first pin 3504 and a second pin 3506. The first hinge element 2764 further includes one or more biasing elements, such as for example, coil spring 3316.

The second hinge element 2768 includes at least one hub plate 3508. In some embodiments, as shown in FIGS. 35C and 35D, the second hinge element 2768 includes two hub plates 3508 that are separated a distance to provide a space in which a portion of the first plate 3500 and the second plate 3502 of the first hinge element 2764 are located. That is, a part of the first plate 3500 and the second plate 3502 of the first hinge element 2764 are located between the two hub plates 3508 of the second hinge element 2768. The hub plates 3508 of the second hinge element 2768 and the first plate 3500 of the first hinge element 2764 are pivotably coupled to one another by the hinge pin 2772.

At least one of the hub plates 3508, and in some embodiments, both hub plates 3508, includes a first slot 3510 and a second slot 3512. The second slot 3512 includes a first slot portion 3514 and a second slot portion 3516 connected to the first slot portion 3514. For example, the first slot portion 3514 is straight and the second slot portion 3516 is arc-shaped having a center that is concentric with the center of the hinge pin 2772. In some embodiments, the first slot 3510 and the first slot portion 3514 of the second slot 3512 are linearly aligned.

As shown in FIG. 35B, when the first hinge 2756 is in the first, unfolded position, the first hinge 2756 may be locked in the first, unfolded position. For example, the first pin 3504 and the second pin 3506 of the second plate 3502 are configured to be located in a first, locked position. In the first, locked position, the first pin 3504 of the second plate 3502 is located in the first slot 3510 of the hub plate 3508 and the second pin 3506 of the second plate 3502 is located in the first slot portion 3514 of the second slot 3512 of the hub plate 3508. When the first pin 3504 and the second pin 3506 of the second plate 3502 are located in the first slot 3510 and the first slot portion 3514 of the hub plate 3508, respectively, the first pin 3504 and the second pin 3506 contact the first slot 3510 and the first slot portion 3514 so that the first hinge element 2764 and the second hinge element 2768 are unable to pivot with respect to one another. Stated another way, the cooperation between the first pin 3504 and the second pin 3506 prevent rotation of the first hinge element 2764 with respect to the second hinge element 2768.

To fold the first hinge 2756 and the wagon chassis 104, the second plate 3502 is moved linearly away from the hub plate 3508 such that the first pin 3504 and the second pin 3506 of the second plate 3502 are moved out of the first slot 3510 and the first slot portion 3514 of the hub plate 3508, respectively. This second, unlocked position is shown in FIG. 35C. When the second plate 3502 (and the first pin 3504 and the second pin 3506) is in the second, unlocked position, first hinge 2760 is able to pivot. Stated another way, when the first pin 3504 and the second pin 3506 are no longer received in the first slot 3510 and the first slot portion 3514 of the hub plate 3508, respectively, the first hinge element 2764 is able to rotate with respect to the second hinge element 2768. The wagon chassis 104 may then be folded from the first, use position, as shown FIG. 35A to the folded, storage position, as shown in FIG. 35E.

As described above with respect to FIGS. 33A-33D, 34A, and 34B, the coil spring 3316 located on the second plate 3502 are configured to exert a force against the second plate 3502 to push the first pin 3504 and the second pin 3506 toward and into the first slot 3510 and the first slot portion 3514 of the hub plate 3508, respectively.

Although not shown in FIGS. 35A-35E, the first hinge 2756 and the second hinge 2760 of shown therein may be cable-operated via the handle 114 and/or may be operated, for example only, by one or more finger pulls as described with respect to FIGS. 33A-33D, 34A, and 34B.

As described herein, in some embodiments, one or more of the first hinge 2756 and the second hinge 2760 are configured to be in a locked position and an unlocked position, wherein in the locked position, one or more of the first hinge 2756 and the second hinge 2760 are configured to retain the wagon chassis 104 in a unfolded configuration, and wherein in the unlocked position, one or more of the first hinge 2756 and the second hinge 2760 are configured to permit the wagon chassis 104 to fold from the unfolded configuration to a folded configuration, and wherein rotating the handle 114 toward the deck 2720 is configured to place one or more of the first hinge 2756 and the second hinge 2760 in the unlocked position.

Frame with T-Slot and Adjustable Ports

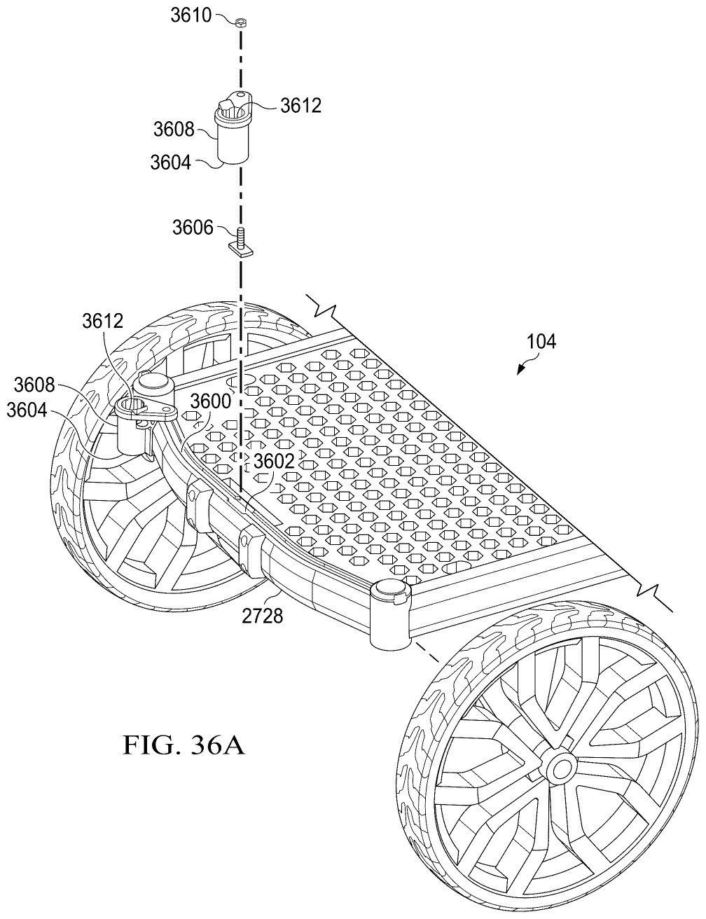

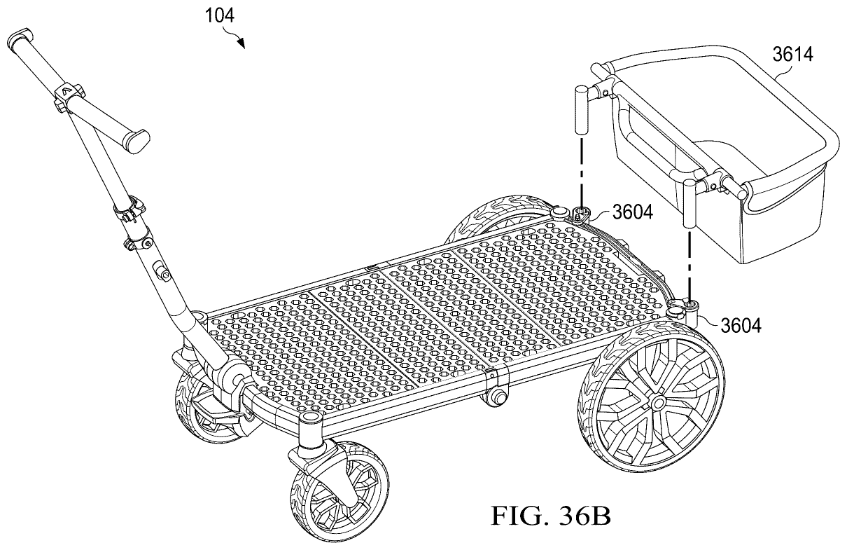

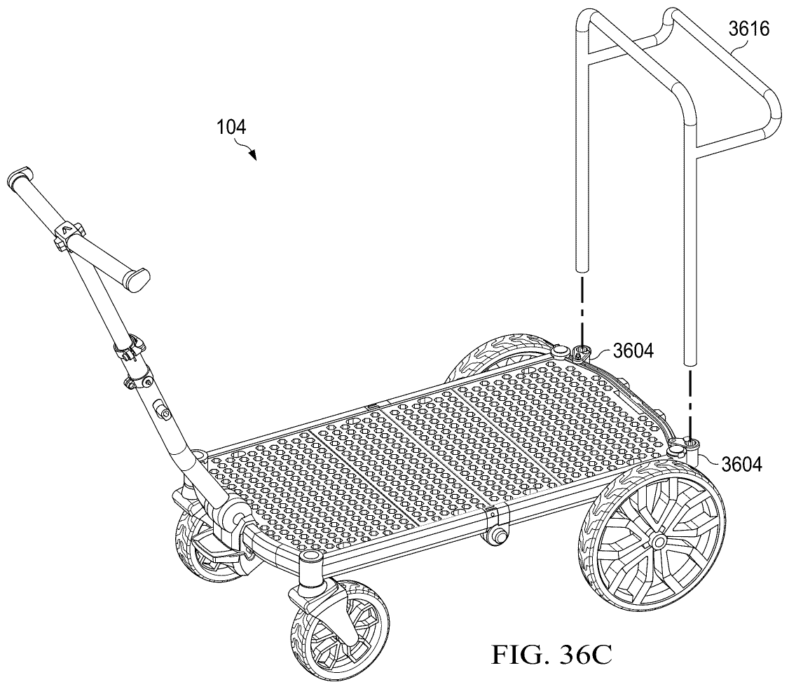

Referring now to FIGS. 36A-36C, another embodiment of the wagon chassis 104 is shown. In some embodiments, the second frame member 2728 of the frame 2716, which may in some embodiments be referred to as the rear frame member, includes a T-slot 3600 extending the length of the second frame member 2728. The T-slot 3600 may extend substantially the width of the wagon chassis 104. The second frame member 2728 further includes an opening 3602 in the T-slot 3600. The wagon chassis 104 may be provided with one or more adjustable ports 3604 that can be inserted into the T-slot 3600 through the opening 3602 and can be slid to any desired position along the length of the second frame member 2728 in the T-slot 3600. As shown in FIGS. 36A-36C, the adjustable ports 3604 may hang off of the second frame member 2728 toward what may in some embodiments be referred to as the rear of the wagon chassis 104. For example, each adjustable port 3604 includes a T-slot stud 3606 that may be retained in the T-slot 3600 and an adjustable port body 3608 coupled to the T-slot stud 3606. In some embodiments, the adjustable port 3604 may include a nut 3610 that may be tightened on the T-slot stud 3606 to secure the adjustable port 3604 in place along the T-slot 3600. The adjustable port body 3608 includes a socket 3612 that are configured to receive, for example, the pegs 122 of any of the accessories described herein. As shown in FIG. 37B, a basket 3614 with pegs 122 may be coupled to the wagon chassis 104 by inserting the pegs 122 into the sockets 3612 of the adjustable ports 3604. As shown in FIG. 37C, a U-shaped accessory rack 3616 with pegs 122 may be coupled to the wagon chassis 104 by inserting the pegs 122 into the sockets 3612 of the adjustable ports 3604. The U-shaped accessory rack 3616 may be used to carry various items and/or may be used as a handle to push or pull the wagon chassis 104.

Although FIGS. 36A-36C show the T-slot 3600, the opening 3602, and adjustable ports 3604 in and connected to the second frame member 2728 at the rear of the wagon chassis 104, it will be understood that the T-slot 3600, the opening 3602, and adjustable ports 3604 may be provided in and connected to any of the frame members of the frame 2716, in some of the frame members of the frame 2716, or all of the frame members of the frame 2716 without departing from the scope of the disclosure.

The subject matter of embodiments of this patent is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Different arrangements of the components depicted in the drawings or described above, as well as components and steps not shown or described, are possible. Similarly, some features and subcombinations are useful and may be employed without reference to other features and subcombinations. Embodiments of the disclosure have been described for illustrative and not restrictive purposes, and alternative embodiments will become apparent to readers of this patent. Accordingly, the present disclosure is not limited to the embodiments described above or depicted in the drawings, and various embodiments and modifications can be made without departing from the scope of the claims below.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A wagon assembly, comprising:
a modular wagon bed comprising:
at least one sidewall positionable in a use position and a stored position; and
a footwell feature positionable in an extended position and a storage position; and
a wagon chassis comprising:
a pivotable handle;
a plurality of wheels; and
a deck, wherein the modular wagon is removably coupled to the wagon chassis.

2. The wagon assembly of claim 1, wherein the deck comprises a movable surface for accommodating the footwell feature of the modular wagon when the modular wagon bed is coupled to the wagon chassis.

3. The wagon assembly of claim 1, further comprising one or more adapters configured to removably couple to one or more of the wagon chassis and the modular wagon bed and configured to removably couple to an accessory.

4. The wagon assembly of claim 1, wherein the deck includes a population of openings arranged in a plurality of rows and columns.

5. The wagon assembly of claim 4, wherein at least one opening of the population of openings is configured to receive a peg of an additional component to couple the additional component to the wagon chassis.

6. The wagon assembly of claim 1, wherein the handle is configured to transition from a first position and a second position, and wherein the handle includes a pivotable coupling for pivoting the handle between the first position and the second position.

7. The wagon assembly of claim 6, wherein the handle is positionable in a third position via the pivotable coupling for pivoting the handle between the first position and the second position.

8. A foldable wagon assembly, comprising:
a wagon chassis comprising:
a first chassis portion, comprising a first frame portion and a first deck panel;
a handle coupled to the first chassis portion;
a first pair of wheels coupled to the first chassis portion;
a second chassis portion, comprising a second frame portion and a second deck panel, the second chassis portion connected to the first chassis portion by a first hinge and a second hinge, the first hinge and the second hinge configured to permit the first chassis portion and the second chassis portion to rotate with respect to one another between a first position and a second position; and
a second pair of wheels coupled to the second chassis portion.

9. The foldable wagon assembly of claim 8, wherein at least one of the first deck panel and the second deck panel include a population of openings.

10. The foldable wagon assembly of claim 9, wherein at least one opening of the population of openings is configured to receive a peg of an additional component to couple the additional component to the wagon chassis.

11. The foldable wagon assembly of claim 8, wherein the wagon chassis further includes a third deck panel and a fourth deck panel, the third deck panel and the fourth deck panel configured to be in a first position and a second position, wherein in the first position, the third deck panel and the fourth deck panel are flush with the first deck panel and the second deck panel.

12. The foldable wagon assembly of claim 11, wherein in the second position, the third deck panel and the fourth deck panel are spaced a distance away from the first deck panel and the second deck panel to form a footwell.

13. The foldable wagon assembly of claim 11, wherein in the second position, the third deck panel and the fourth deck panel are removed from the wagon chassis.

14. A wagon assembly, comprising:
a wagon chassis, comprising:
a frame having a first end, a second end opposite the first end, a left side, and a right side;
a handle coupled to the frame;
a deck coupled to the frame, the deck having a population of openings; and
a first pair of wheels coupled to the frame.

15. The wagon assembly of claim 14, wherein at least one opening of the population of openings is configured to receive a peg of an additional component to couple the additional component to the wagon chassis.

16. The wagon assembly of claim 14, wherein the wagon chassis includes a first chassis portion and a second chassis portion, the first chassis portion and the second chassis portion rotatably connected to one another, wherein the wagon chassis is configured to fold and unfold along a fold axis extending from the left side to the right side of the wagon chassis.

17. The wagon assembly of claim 14, further comprising a second pair of wheels coupled to the frame, wherein the second pair of wheels is coupled proximate to the second end of the frame and the second pair of wheels is coupled proximate to the first end of the frame.

18. The wagon assembly of claim 14, further comprising one or more hinges coupled to the frame, the one or more hinges configured to be in a locked position and an unlocked position, wherein in the locked position, the one or more hinges are configured to retain the wagon chassis in a unfolded configuration, and wherein in the unlocked position, the hinges are configured to permit the wagon chassis to fold from the unfolded configuration to a folded configuration, and wherein rotating the handle toward the deck is configured to place the one or more hinges in the unlocked position.

19. The wagon assembly of claim 14, further comprising a second pair of wheels coupled to the frame, wherein the first pair of wheels and the second pair of wheels are removably coupled to the frame, and wherein in a first configuration the first pair of wheels are coupled to the first end of the frame and the second pair of wheels are coupled to the second end of the frame, and wherein in a second configuration the first pair of wheels are coupled to the second end of the frame and the second pair of wheels are coupled to the first end of the frame.

20. The wagon assembly of claim 19, wherein the wheels of the first pair of wheels are configured to swivel with respect to the frame.
